(19) United States
(12) Patent Application Publication
(10) Pub. No.: US 2013/0024226 A1
(43) Pub. Date: Jan. 24, 2013

(54) ENTERPRISE PLANNING TOOL

(71) Applicant: Cyril James Bourke, Clonmel (IE)

(72) Inventor: Cyril James Bourke, Clonmel (IE)

(73) Assignee: SETANTA BUSINESS SYSTEMS LTD., Clonmel (IE)

(21) Appl. No.: 13/518,330

(22) PCT Filed: Dec. 22, 2009
(86) PCT No.: PCT/EP09/67797

§ 371 Date: Oct. 2, 2012

(30) Foreign Application Priority Data
Dec. 21, 2009 (IE) 2009/0958

(51) Int. Cl. G06Q 10/06

(52) U.S. Cl. 705/7.12

(57) ABSTRACT

This invention relates to an enterprise planning tool. Enterprise planning tools are used to manage the operations of an entity and are becoming increasingly popular as companies migrate from spreadsheet based planning. The present invention provides an enterprise planning tool that comprises a plurality of interconnected objects, each object comprising at least one attribute and each object having a time dimension. Each of the objects has a relationship with one or more other objects thereby connecting the objects together. The relationship consists of at least one common attribute and at least a partial time dimension common to both objects. The object relationships are arranged so that each of the objects in the enterprise planning tool is connected to each of the remaining objects in the enterprise planning tool either directly or indirectly through one or more connected objects. By having such a tool, it is possible to provide more accurate information in a quick and efficient manner.

This invention relates to an enterprise planning tool.

Enterprise planning tools are used to manage the operations of an entity and are becoming increasingly popular as companies migrate from spreadsheet based planning. Enterprise planning tools allow managers to identify the profitable areas of their business and the loss making areas of their business and make business decisions based on the information collated by the enterprise planning tool. However, there are numerous problems with the enterprise planning tools currently available on the market. Heretofore, the enterprise planning tools have been based on conventional accounting and costing techniques such as Activity Based Costing (ABC) which has changed very little since its inception over 20 years ago. Activity based costing as it is currently configured and applied to existing enterprise planning tools does not provide the level of accuracy and precision required for management decision making. Activity based costing as applied to enterprise planning tools lacks the flexibility and scalability that is required to provide the insight required for management decision making and continuous process improvement.

Furthermore, the data sources for activity based costing are derived from accounting techniques that are designed primarily for external reporting and are structured to report at an organisational level. This data source is decomposed and reconstructed into a format that is applied to activity based costing, namely cost pools. The decomposition of organisational cost reports, namely cost centres from which cost pools are constructed involves compromising the data quality and accuracy which is subsequently incorporated into the information used by management for decision making. The requirements of external and internal reporting techniques are different and in order to make accurate management decisions from an enterprise planning tool, it would be highly advantageous to have data configured using internal reporting techniques that is detailed, accurate and useful to the user.

Another problem with the known enterprise planning tools is that they do not allow the finance personnel in an organisation to control the rules that apply to accounting policies and expense recognition. In this way, the management do not know whether new data added to the information that they base managerial decisions on is prepared in a standard and consistent way which is undesirable.

In addition to the above, and as a result of the fact that the known accounting techniques are designed primarily for external reporting and are structured to report at an organisational level, the known accounting systems are not designed to measure and report at a highly detailed level and they are not designed to comprehensively monitor the effectiveness of a business strategy implemented in an organisation. The requirements of external and internal reporting techniques are different and in order to make accurate management decisions from an enterprise planning tool, it would be highly advantageous to have data gathered using internal reporting techniques that is detailed, accurate and useful to the user.

Other accounting techniques and traditional costing methodologies such as marginal costing assign too much relevance to direct cost which prevents accurate costing of intermediate activities. The total cost absorption method pushes cost down to end products and services and the cause/effect relationship is not considered. Furthermore, capital investment and cost of capital is excluded from consideration. Conventional costing techniques such as ABC are adapted for organisational based cost structures and the cause/effect relationships are also compromised. By and large, the known techniques and enterprise planning tools do not support lean manufacturing, six sigma, theory of constraints and data quality that can be applied to linear programming for profit optimisation.

Generally speaking, the majority of solutions currently available are based on activity based costing, the scope of which is narrower than the methodology applied in the application in suit. Although some attempts have been made to address the problems with the known solutions, all of the known solutions attempt to provide a single data source data solution from which plans may be prepared based on activity based costing. These solutions are inflexible and insufficiently accurate.

The known solutions do not allow a user to tunnel down through the various costings in the operations of an entity and determine what the actual cost of a particular good or service is, but rather the known solutions only provide a best estimate of the actual cost. This is undesirable for planning purposes as the more accurate information that may be provided, the better. However, there is a problem with providing more information as the more information provided, the larger the data storage requirement is, the more unwieldy the system becomes and the more difficult it becomes to search.

It is an object of the present invention to provide an enterprise planning tool that overcomes at least some of these difficulties with the known solutions that is easier to search and provides accurate detailed information relating to the true cost of the activities of an enterprise.

### STATEMENTS OF INVENTION

According to the invention there is provided an enterprise planning tool comprising: a plurality of interconnected objects, each object comprising at least one attribute and each object having a time dimension associated therewith, each of the objects having a relationship with at least one other object thereby connecting the objects together, the relationship consisting of at least one attribute common to both objects and at least part of their time dimensions common to both objects, the object relationships being such so that each of the objects in the enterprise planning tool is connected to each of the remaining objects in the enterprise planning tool either directly or indirectly through one or more connected objects.

In one embodiment of the invention the objects are arranged in an object hierarchy.

In another embodiment of the invention the objects comprise one of an expense, a resource, a business process, a product and a service.

In a further embodiment of the invention the object hierarchy comprises a plurality of levels including an expense, a resource, an internal resource expense, a resource object business process, a raw material object business process, a raw material object conversion process, a cost object business process, a product based cost object conversion process and a service based cost object conversion process.

In one embodiment of the invention each object is provided with a calendar.

In another embodiment of the invention the calendar is one of a company calendar, a customised calendar, a price change calendar, a pay rate change calendar, a volume calendar, a load factors calendar, an overtime hours calendar, an overtime premium calendar, a floating holidays calendar, a cost driver assignment calendar and a labour pool assignments calendar.

In a further embodiment of the invention one of the objects in each relationship represents the demand source of the relationship and the other object in that relationship represents the supply source of the relationship.

In one embodiment of the invention one of the attributes is a discrete attribute.

In another embodiment of the invention one of the attributes is a configured attribute.

In a further embodiment of the invention the configured attribute is derived from discrete and configured attributes.

In one embodiment of the invention objects are derived from discrete and configured attributes.

In another embodiment of the invention the attributes are arranged in an attribute hierarchy.

In a further embodiment of the invention the most fundamental attribute is a process type which comprises a system type and a system process.

In one embodiment of the invention the system process comprises one of an infrastructure, a business process type and a conversion process type.

In another embodiment of the invention the conversion process type comprise one of a product and a service.

In a further embodiment of the invention the system type comprises one of a resource object, a raw material object, and a cost object.

In one embodiment of the invention there is provided at least one resource cell, the resource cell comprising one or more resource objects.

In another embodiment of the invention the resource object is a discrete object whose purpose is to fulfil the needs of another object as represented by a process type.

In a further embodiment of the invention there are provided a plurality of resource object groups.

In one embodiment of the invention the resource object groups comprise a land group, a building group, an equipment group, a labour grade based group, a labour employee based group and a process group.

In another embodiment of the invention there is provided at least one work cell.

In a further embodiment of the invention the work cell groups one or more resource cells or part thereof.

In one embodiment of the invention the tool comprises a bill of resources which in turn comprises a plurality of work cells and a plurality of cost drivers.

In another embodiment of the invention the cost drivers comprise one of activities and tasks driven by process objects that link resources to process objects.

In a further embodiment of the invention the work cells are arranged in the sequence in which resources are consumed.

In one embodiment of the invention the cost drivers comprise process type, batch type, sample size and pack configuration.

In another embodiment of the invention the cost driver pack configuration comprise unit quantity, pack quantity, bulk pack quantity, line item count and lot size.

In a further embodiment of the invention the cost drivers when assigned to a routing step are sequenced in the order in which activities or tasks are performed.

In one embodiment of the invention the process objects comprise bill of materials which comprise a raw material object and a work cell.

In another embodiment of the invention the bill of material work cell and raw material object requirements are arranged in the sequence in which resources are consumed.

In a further embodiment of the invention each raw material object comprises one conversion and one or more business process objects.

In one embodiment of the invention the tool comprises an internal resource expense which in turn comprises a discrete resource cell.

In another embodiment of the invention there are provided a plurality of resources arranged in a resource hierarchy.

In a further embodiment of the invention the resource hierarchy comprises a plurality of levels including an Infrastructure level, a Service level, a Support level and an Activity level.

In one embodiment of the invention the resource hierarchy represents the general order in which resource and process object costs are configured.

In another embodiment of the invention the objects belonging to the object hierarchy are arranged in a value chain within the resource hierarchy.

In a further embodiment of the invention the object relationship is based on the object attribute and time dimension.

In one embodiment of the invention the tool comprises a relationship validation module that checks the attribute and time domain common to both parties.

In another embodiment of the invention each object relationship is provided with a unique identifier code.

In a further embodiment of the invention the object relationships are stored in an object relationship link table.

In one embodiment of the invention the object relationship link table contains the code for a demand side and a supply side of the relationship.

In another embodiment of the invention the object relationship link table comprises one or more of expense to object, object to object and object to Hub location relationships.

In a further embodiment of the invention all object relationships for a value chain are connected either directly or indirectly by means of the codes contained in the object relationship link tables.

In one embodiment of the invention object relationships within the same value chain share in common the same time dimension.

In another embodiment of the invention the tool implements a pull based resource demand methodology.

In a further embodiment of the invention the pull based resource demand is dependent on object relationships.

In one embodiment of the invention the pull resource demand execution is based on a sequence number provided for each object relationship.

In another embodiment of the invention the pull resource demand sequence comprises user assigned numbers for resource object relationship which are controlled within a range set by the system relative to the level and transaction type.

In a further embodiment of the invention the transaction type comprises Internal Resource Expenses and Resource Object Business processes.

In one embodiment of the invention the pull resource demand sequence also comprises system assigned sequence numbers that are automatically applied to process objects and are specific to their level within the resource hierarchy.

In another embodiment of the invention the pull based resource demand is executed for resource object relationships and then for process object relationships.

In a further embodiment of the invention the pull resource demand is sequenced in two stages, firstly driven by resource objects, secondly by process objects.

In one embodiment of the invention the pull resource demand drives resource fulfilment from within a resource hierarchy for each value chain.

In another embodiment of the invention the resource requirement for an object relationship is represented by resource utilization and the basis by which the cost of such resources are passed from the supply to the demand side of the object relationship.

In a further embodiment of the invention the cost of capital comprises object credit terms that drive vendor and customer credit driven cost of capital.

In one embodiment of the invention the cost of capital comprises process object cycle times linked through object relationship cost drivers from which the total process cycle time and associated cost of capital is derived.

In another embodiment of the invention the cost of capital comprises the idle time associated with obsolete and under utilized resources.

In a further embodiment of the invention the tool comprises a cloning module from which a new object and object relationships as represented by new master and link records may be added automatically based on the configuration of the selected host object.

In one embodiment of the invention the object is assigned a terms of trade.

In another embodiment of the invention one of a raw material object and a product conversion process object is assigned a terms of trade.

In a further embodiment of the invention a work cell, cost driver and activity based expense associated with the terms of trade assigned to an object are automatically replicated and assigned to a bill of resources for the object to which the terms were assigned.

In one embodiment of the invention there is provided a resource cell with a resource cell calendar, and in which the resource cell calendar are customisable.

In another embodiment of the invention there is provided a resource cell and the resource cell comprises a shift structure.

In a further embodiment of the invention there is provided a resource object and the resource object's capacity is determined by the shift or shifts of the parent resource cell to which it is assigned.

In one embodiment of the invention the tool recognizes multi-dimensional aspects of cost including price change, currency change and cost of capital which are derived from object relationships and calendars.

In another embodiment of the invention the capacity constraints are dependent on object relationships and pull resource demand.

In a further embodiment of the invention, expense object recognition is dependent on one or more expense attributes and an object relationship.

In one embodiment of the invention a resource demand, driven from one of a resource and a process object, can cause capacity constraints for one or more resource cells along the value chain for an object.

In another embodiment of the invention a resource cost assignment is based on resource utilization applied to the resource cost.

In a further embodiment of the invention the configured attribute comprises a system type.

In one embodiment of the invention the configured attribute comprises a system process.

In another embodiment of the invention the link table record is grouped into one of a resource object expense group, labour pool cost assignment group, cost object expense assignment group, work cell assignment group, cost driver assignment group, resource object business process assignment group, raw material object business process assignment group, raw material object conversion process assignment group, bill of materials assignment group, cost object business process group, passenger based business process object assignment group, cost object hub location assignment group.

In a further embodiment of the invention the tool comprises means to generate a record for each object relationship.

In one embodiment of the invention the time dimension comprises a start date and an end date.

According to the invention there is provided a computer program product having computer readable instructions embodying the enterprise planning tool of any preceding claim.

In one embodiment of the invention the tool comprises a module that converts the output for a conversion process object to the input and output quantity for each routing step based on the routing sequence and the output yield applicable to each step.

In another embodiment of the invention the tool comprises a module that converts the input and output for each routing step associated with a conversion process object to the other objects, according to the object hierarchy. In turn, the input and output requirements for each of the objects driven by the conversion process object is repeated for those objects, according to the object hierarchy that are connected either directly or indirectly to the conversion process object that initiated this process.

In a further embodiment of the invention the object hierarchy further comprises a passenger based business process.

### DETAILED DESCRIPTION OF THE INVENTION

The invention will now be more clearly understood from the following description of some embodiments thereof, given by way of example only in which:

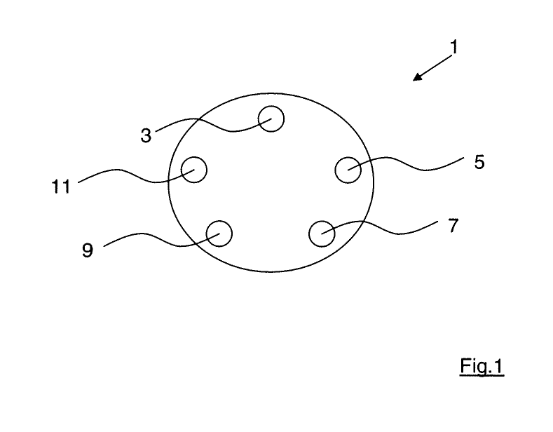

FIG. 1 is a diagrammatic representation of an object forming part of the enterprise planning tool according to the present invention;

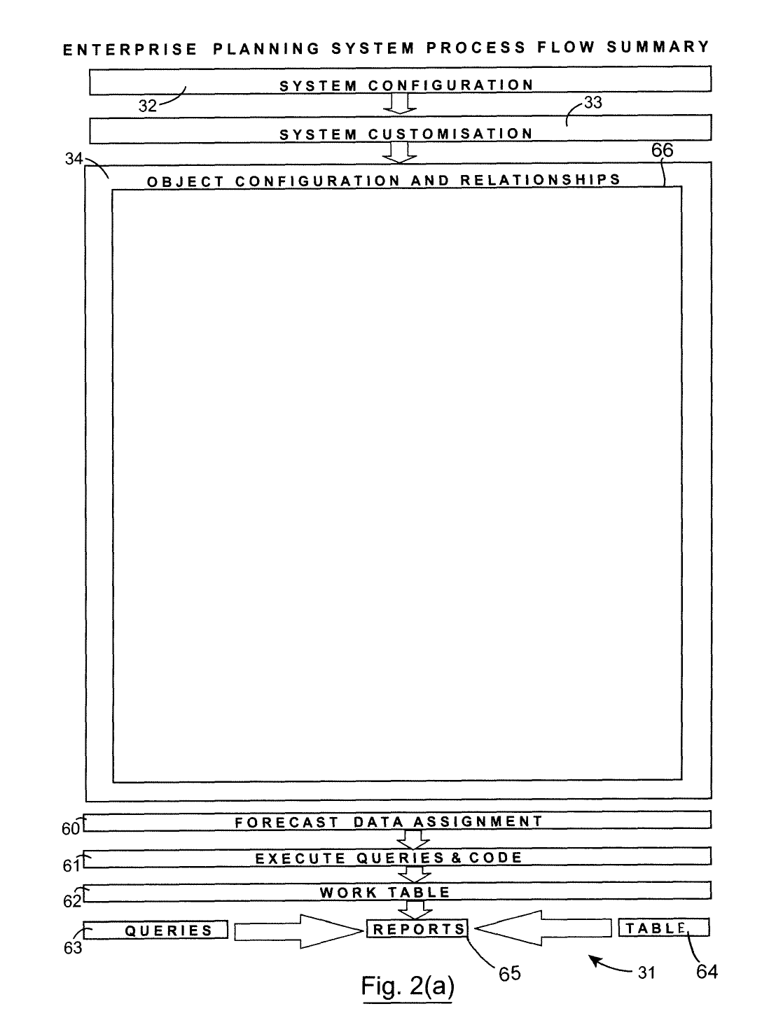

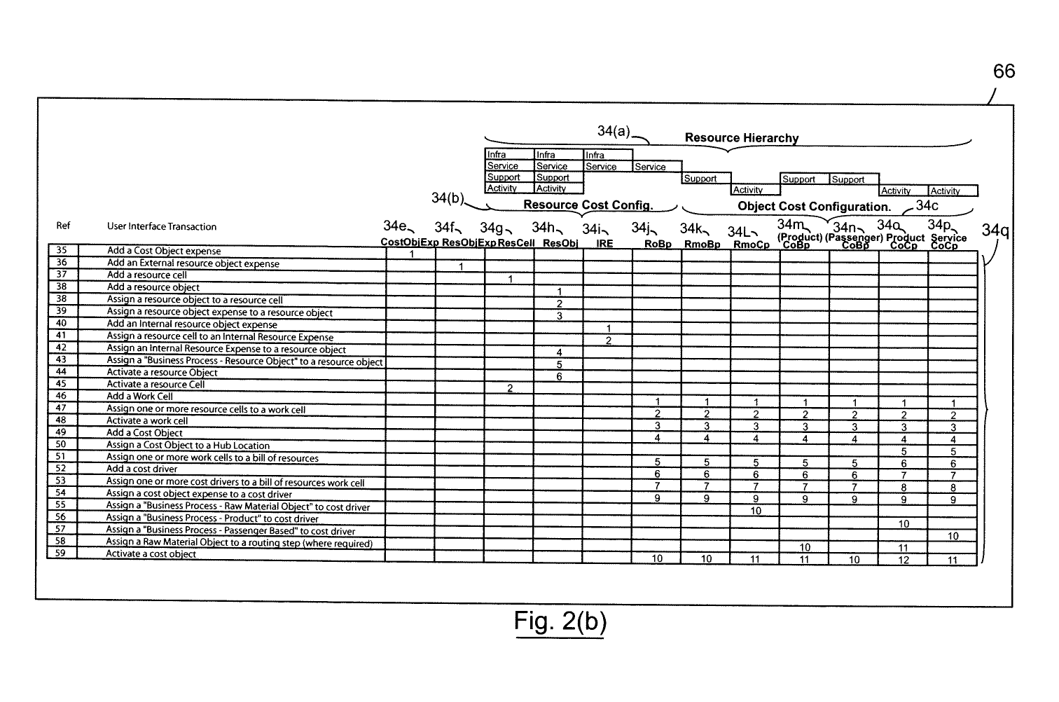

FIGS. 2(a) and 2(b) are a flow diagram of the operation of the enterprise planning tool;

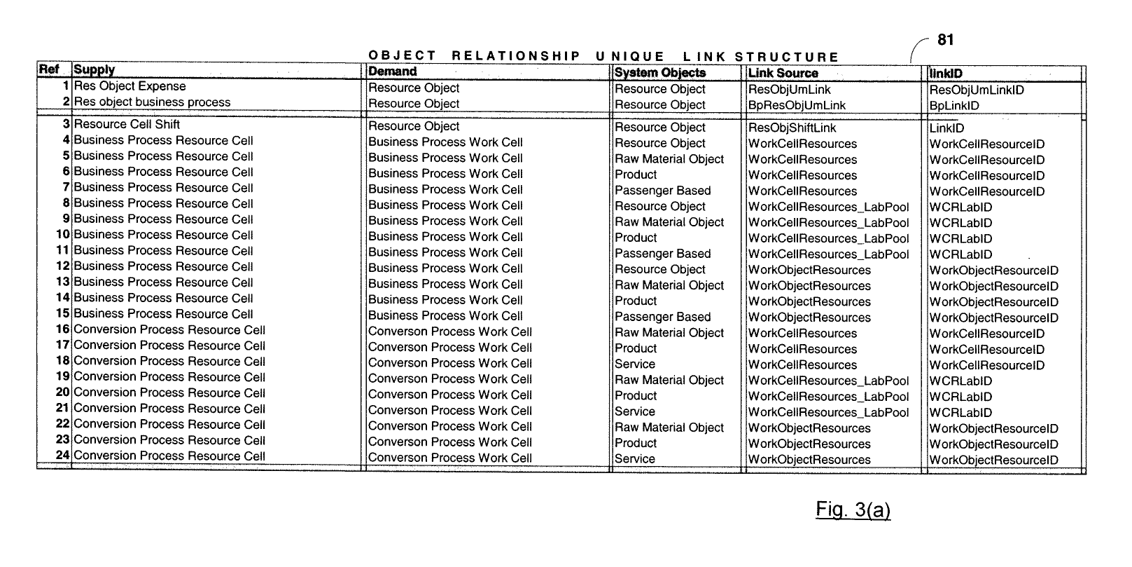

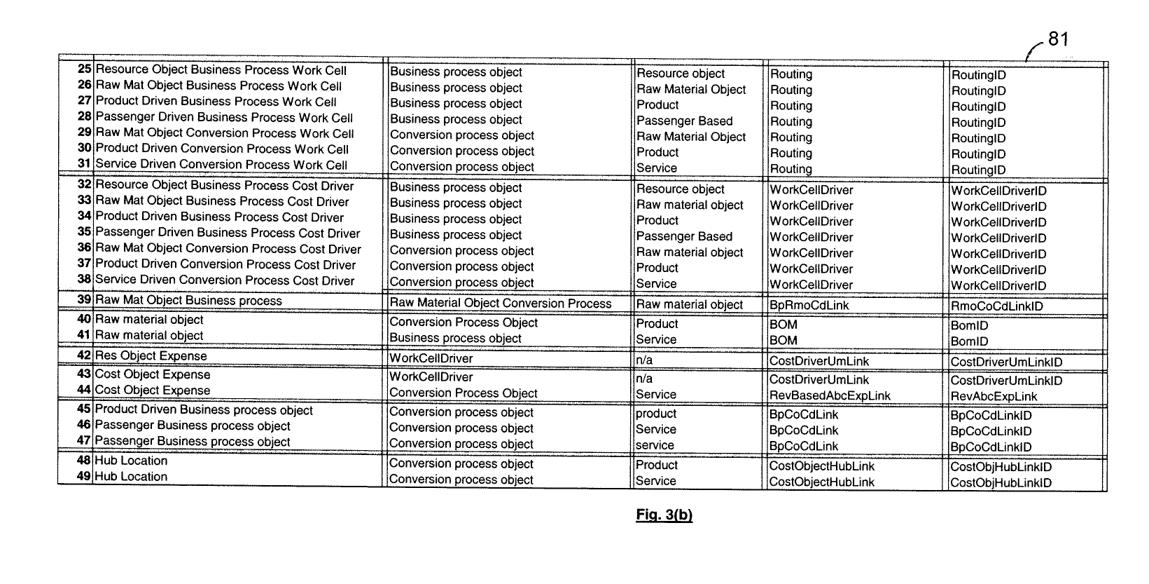

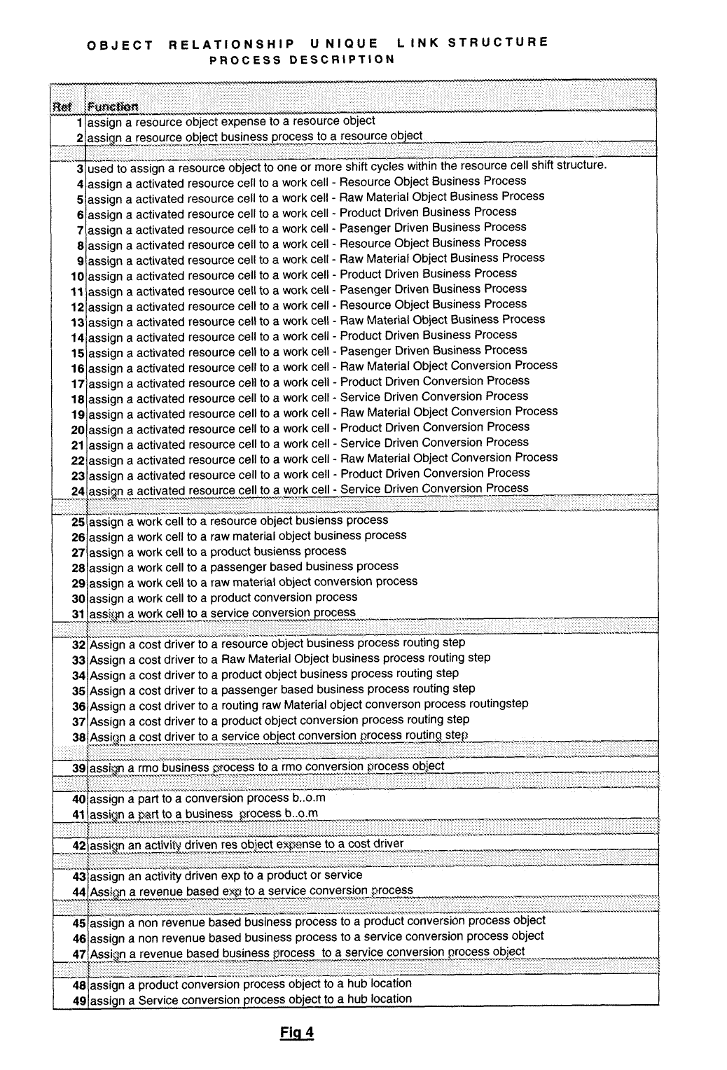

FIGS. 3(a) and 3(b) combine to provide a table showing object relationship link Table field names;

FIG. 4 is a table that provides a process description for FIGS. 3(a) and 3(b) field names;

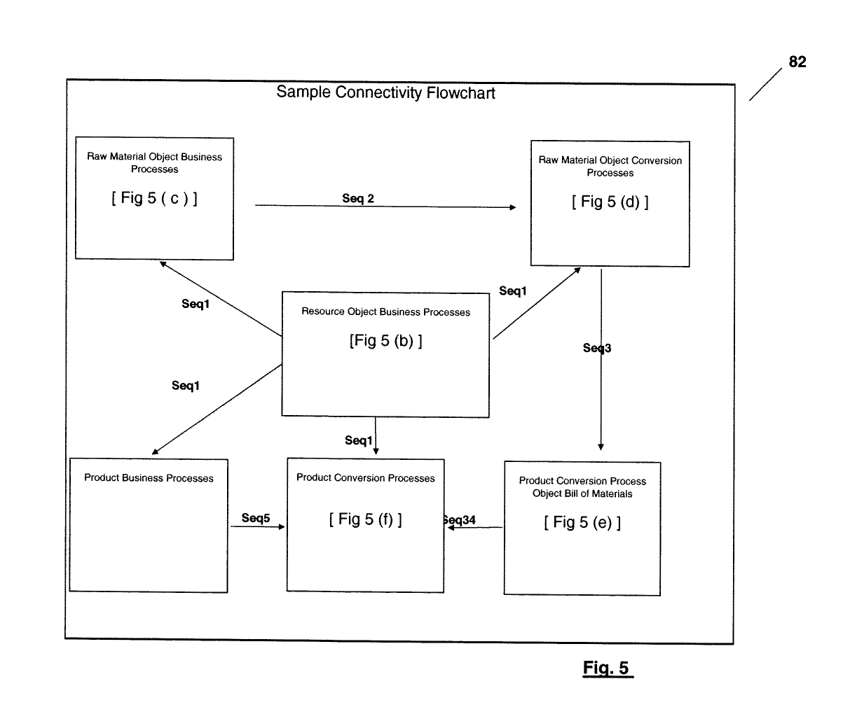

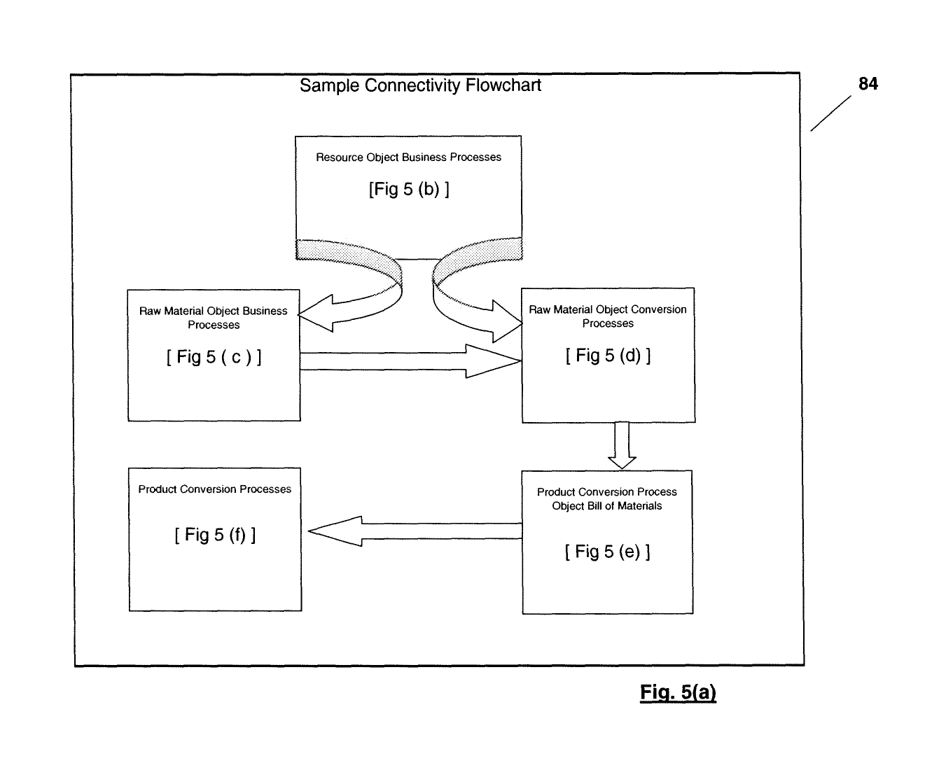

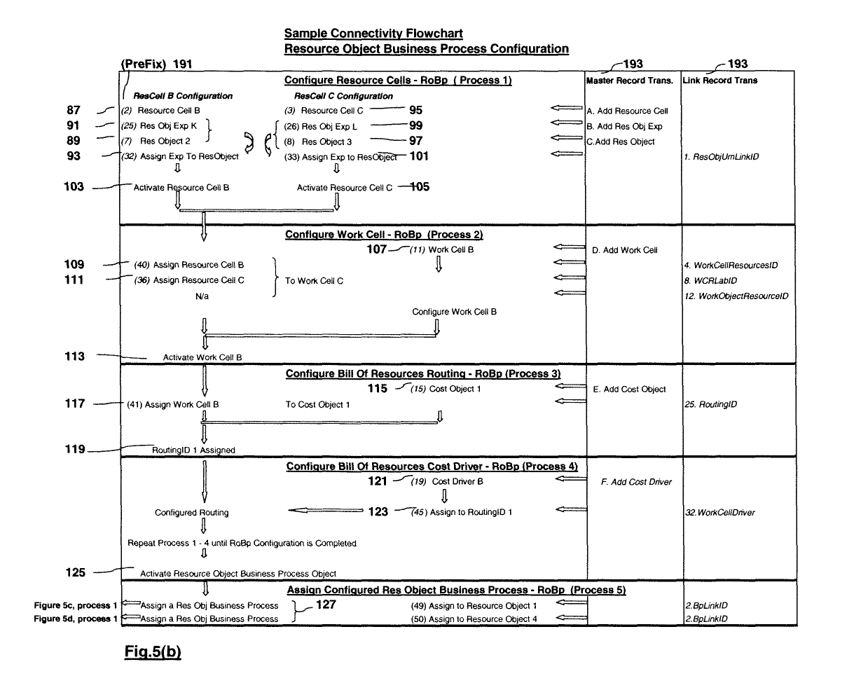

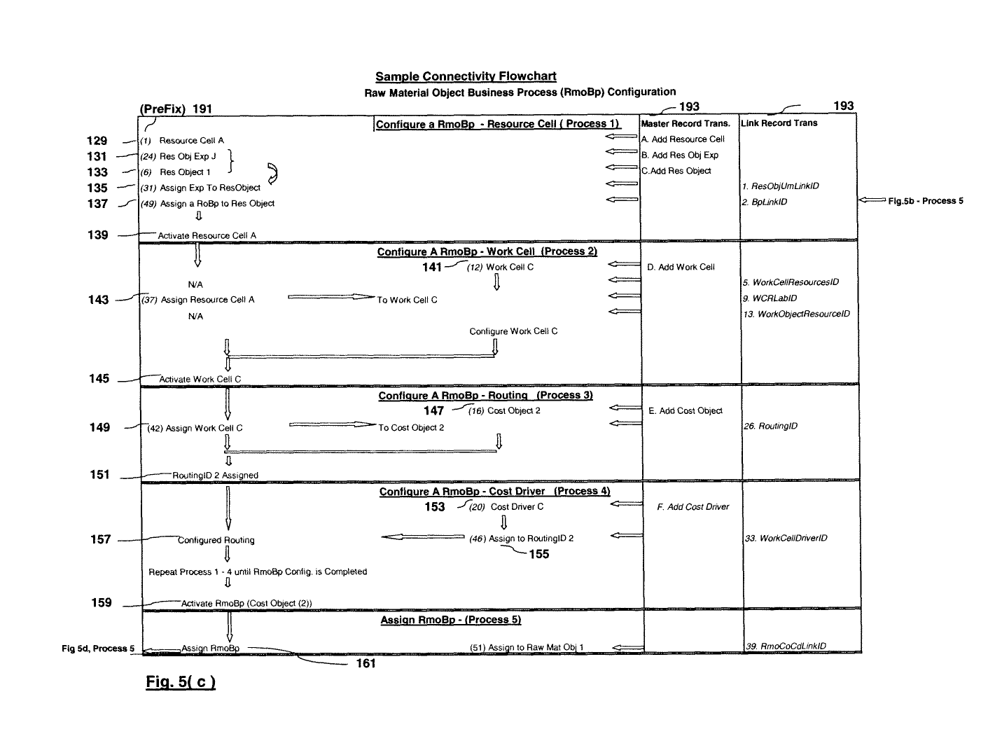

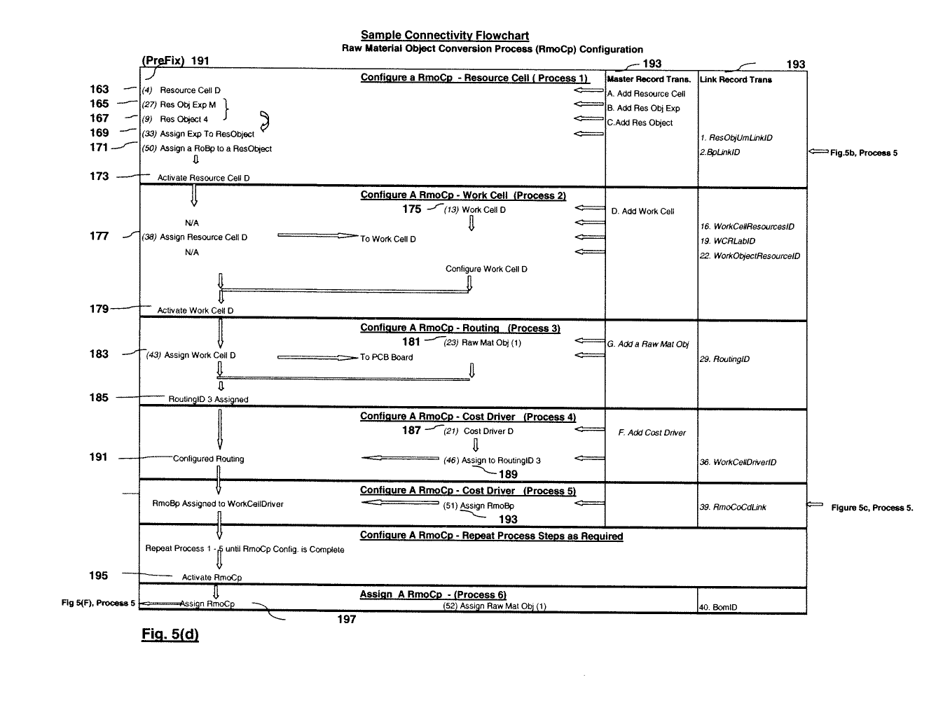

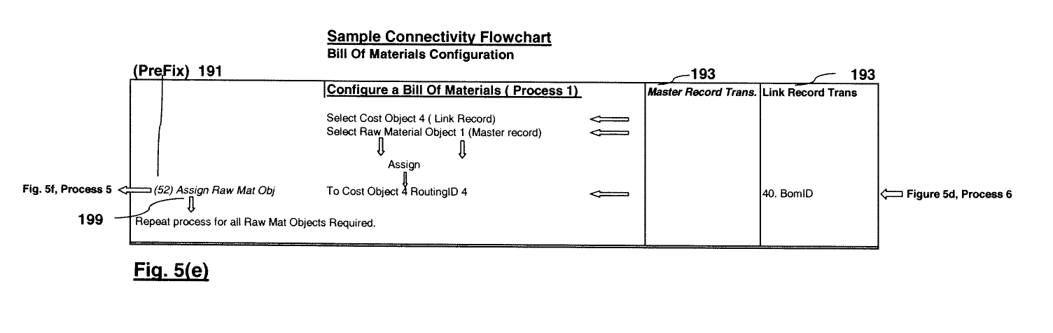

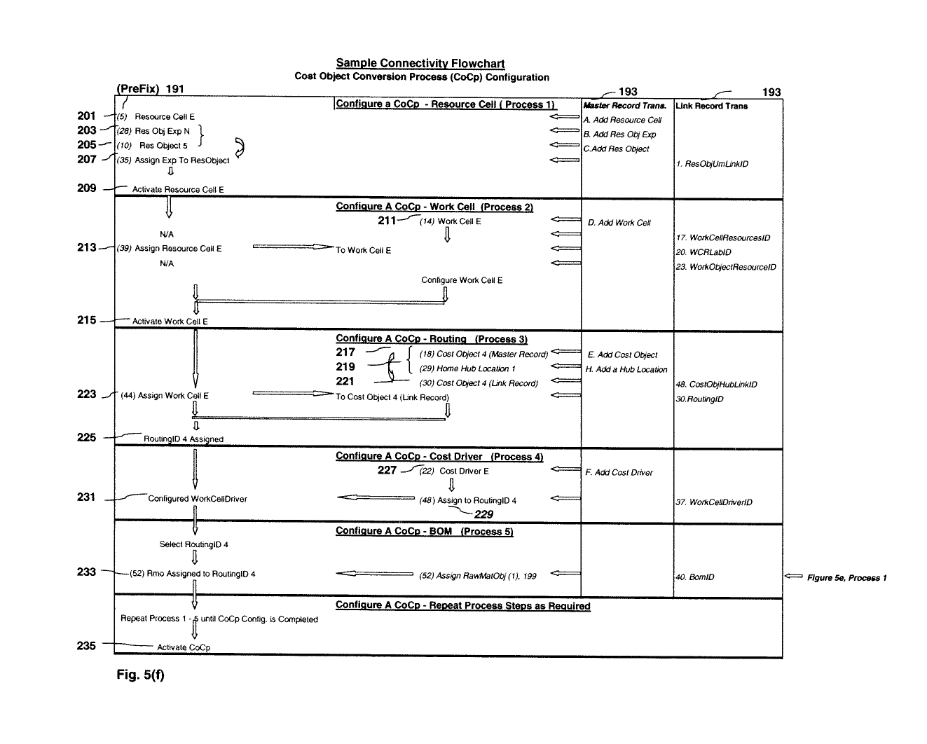

FIG. 5 is a flow diagram showing the flow of data between system processes;

FIG. 5(a) is a flow diagram summary showing a sample connectivity flowchart;

FIGS. 5(b) to 5(f) are flow diagrams showing a sample connectivity flowchart for each process represented in FIG. 5(a);

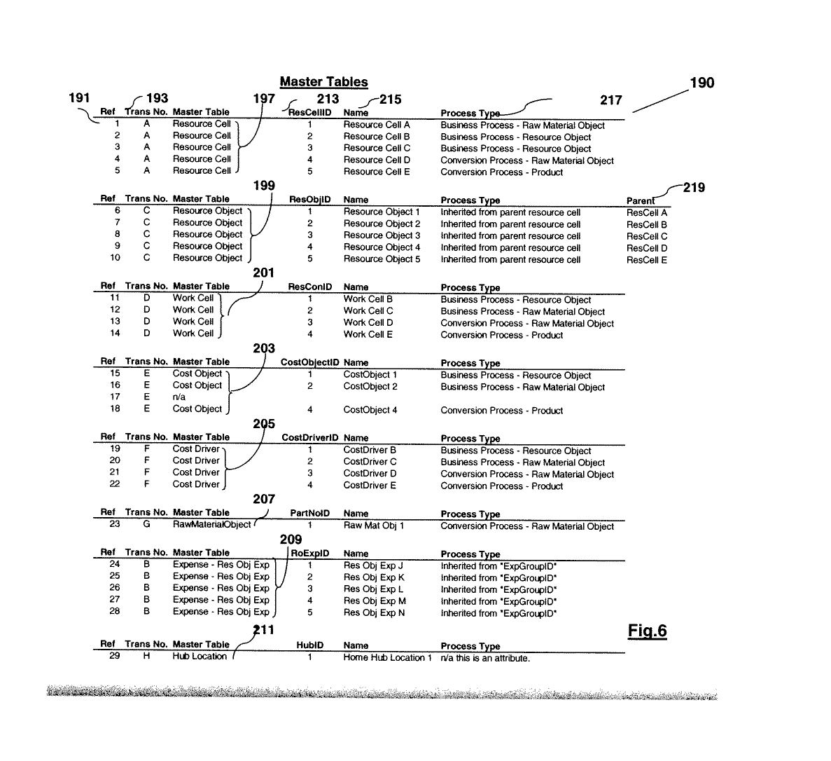

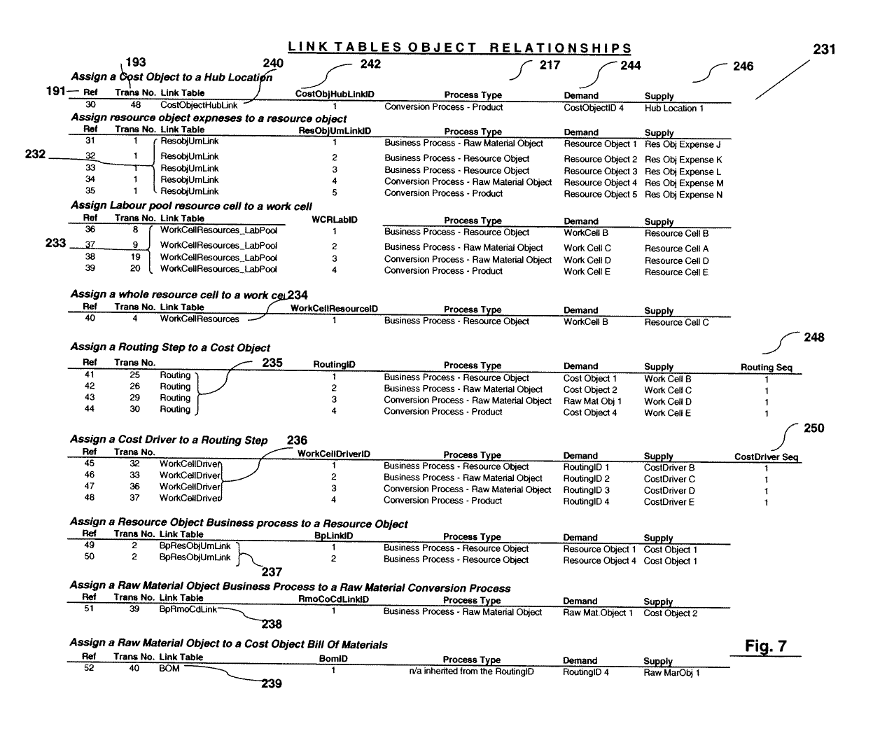

FIG. 6 is a diagrammatic representation of the master table;

FIG. 7 is a diagrammatic representation of a link table;

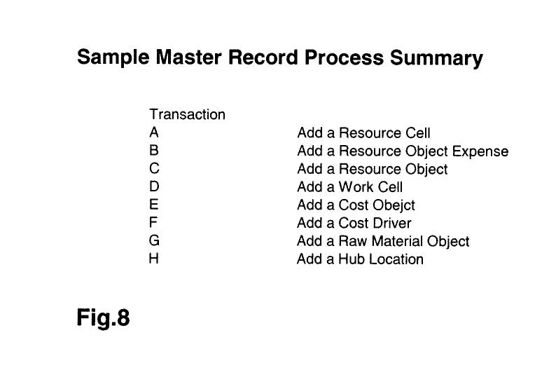

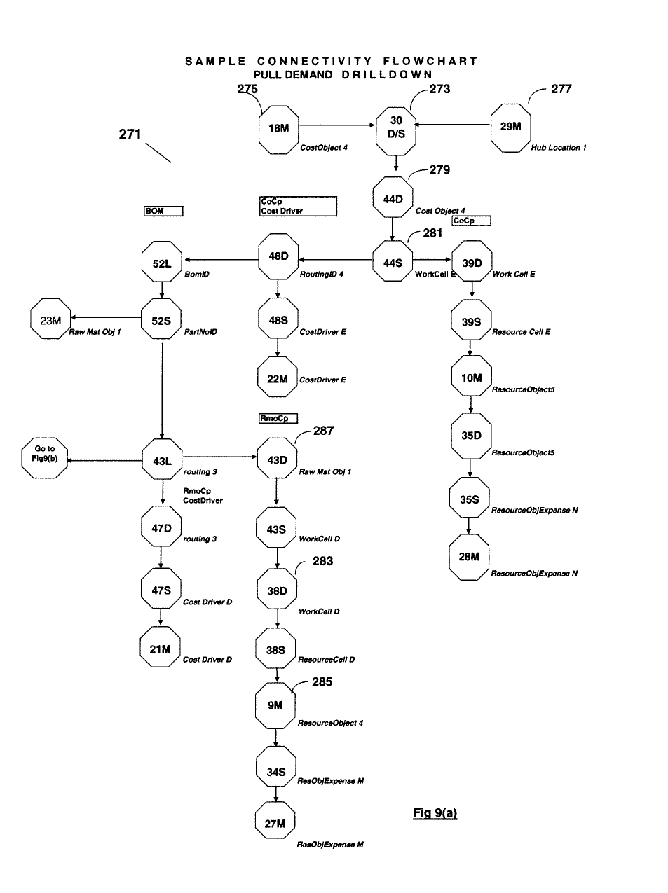

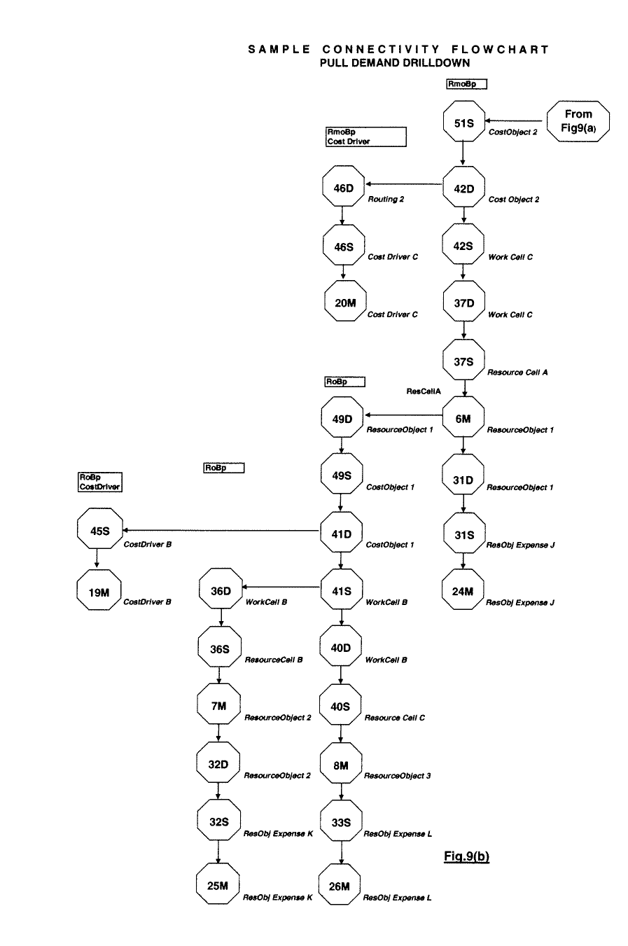

FIG. 8 is a transaction summary of processes to add a master record that may be executed according to the present invention;

FIGS. 9(a) and 9(b) are a diagrammatic representation of a sample connectivity flowchart;

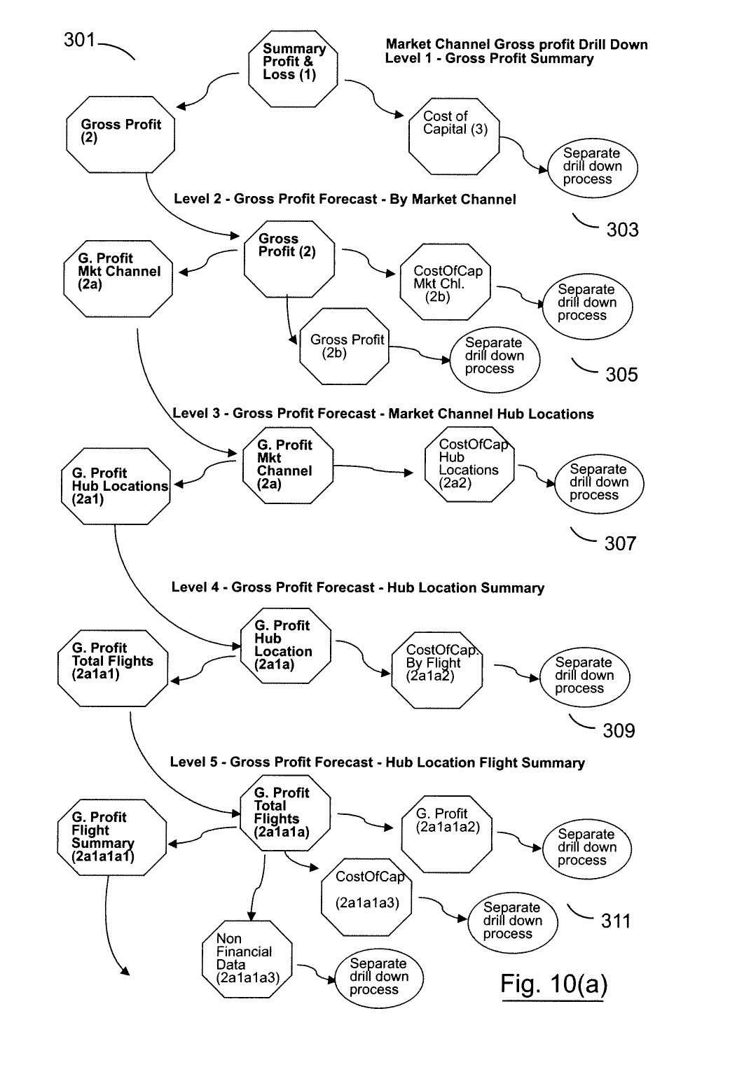

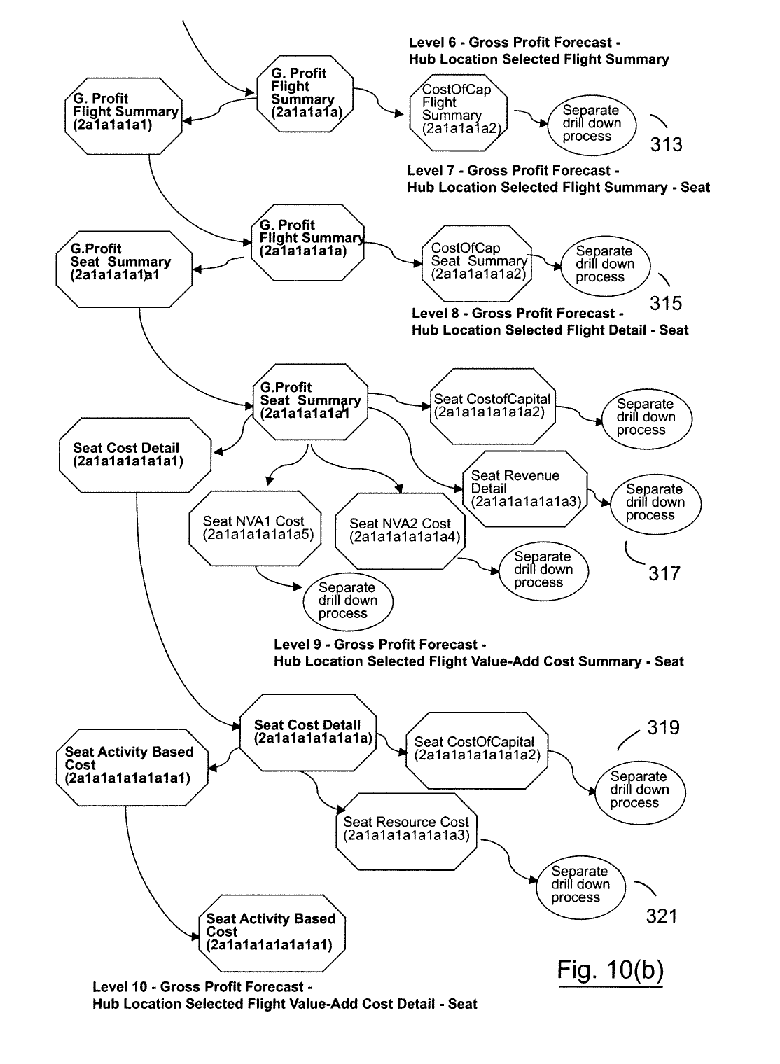

FIGS. 10(a) and 10(b) are a process flow indicative of a drill down process executed with the tool according to the present invention;

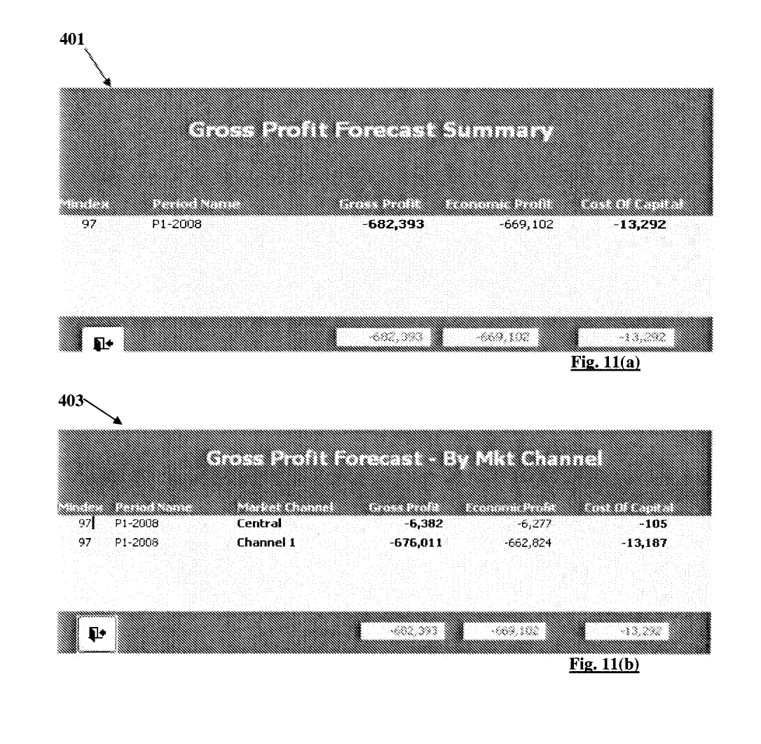

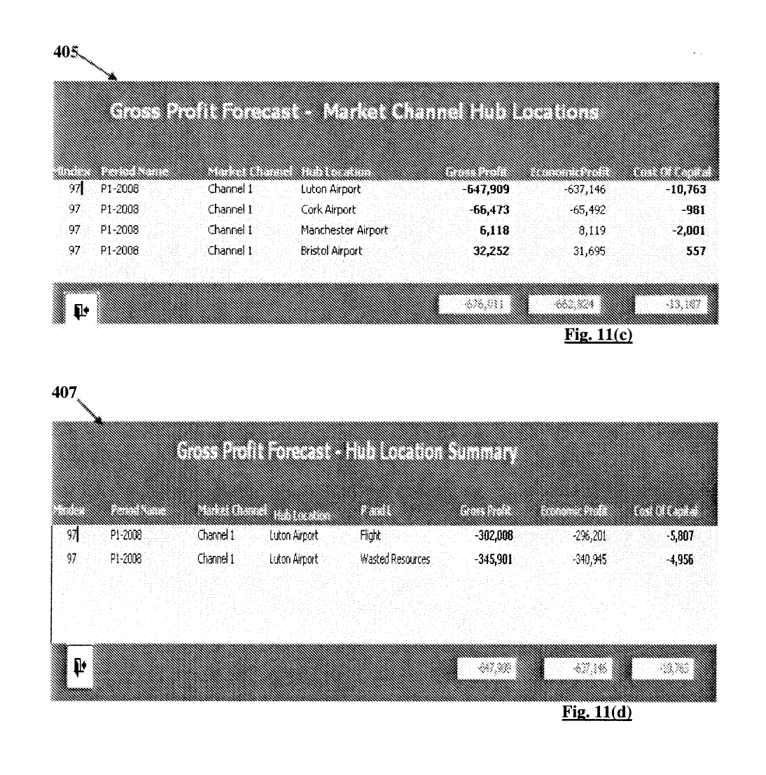

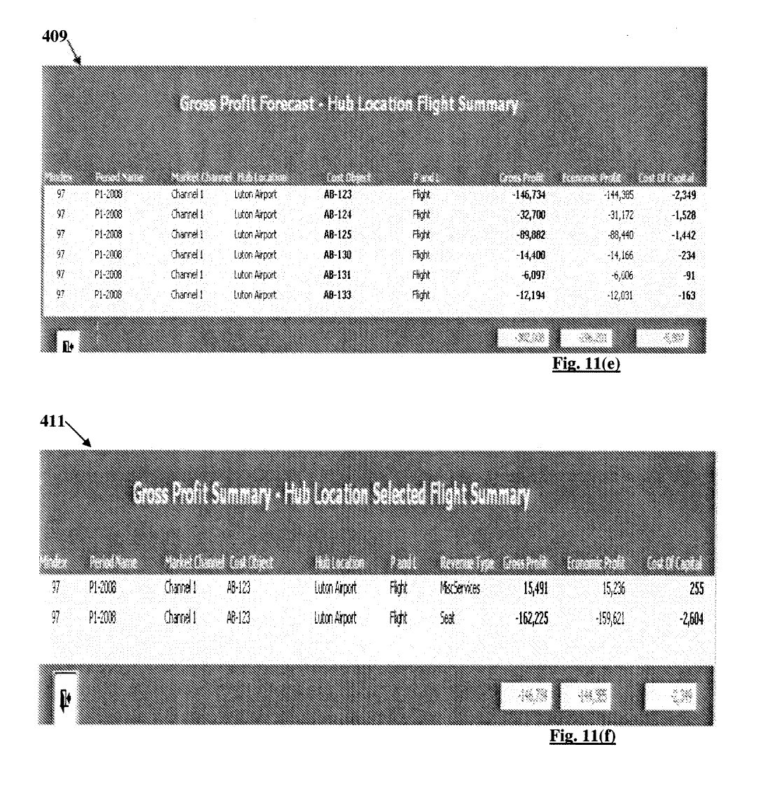

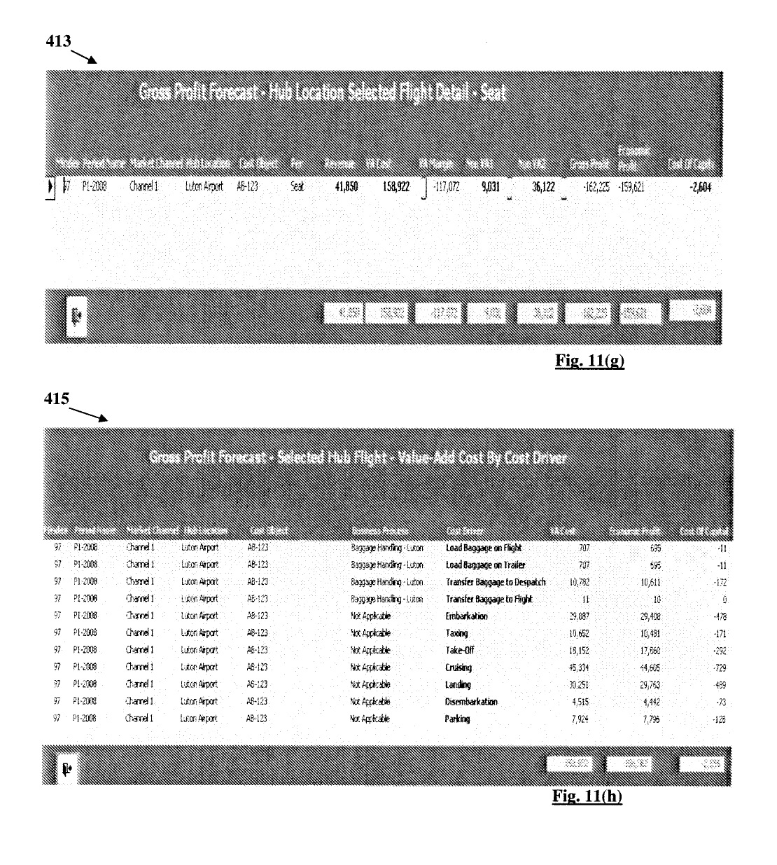

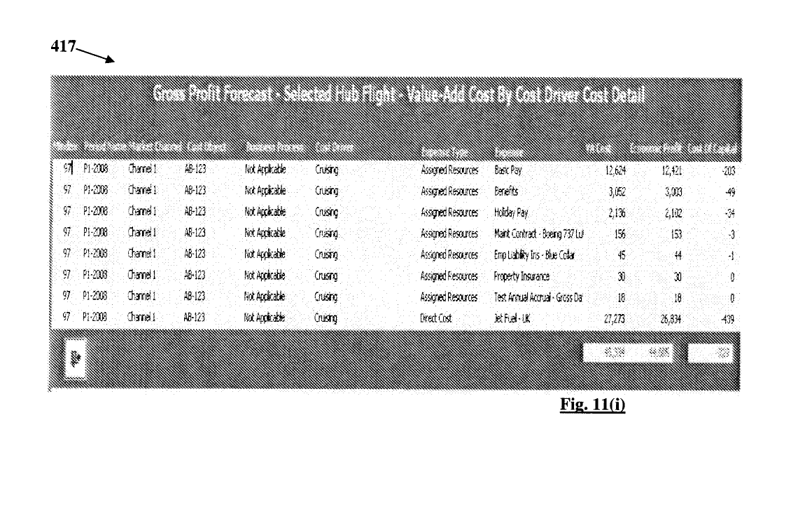

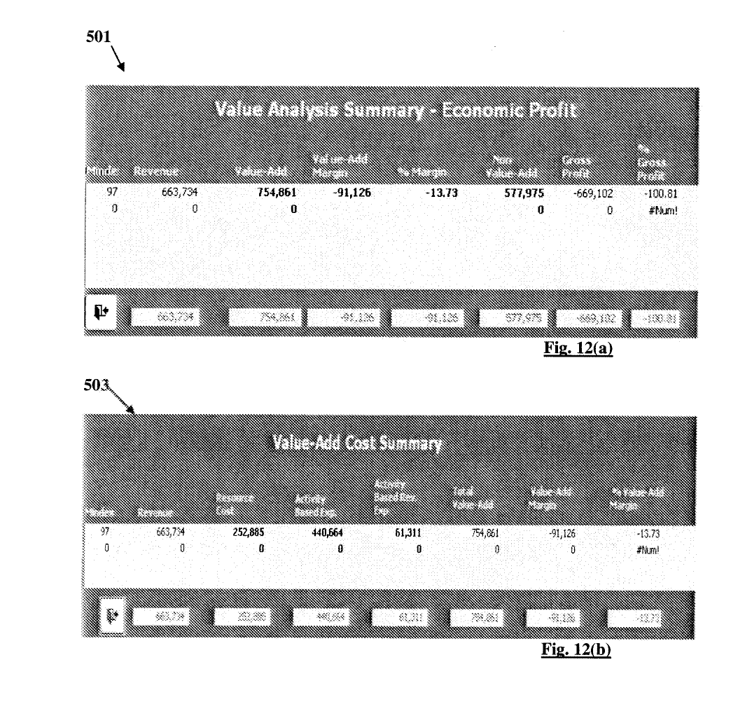

FIGS. 11(a) to 11(i) are screen shots displayed by the tool during the drill down process;

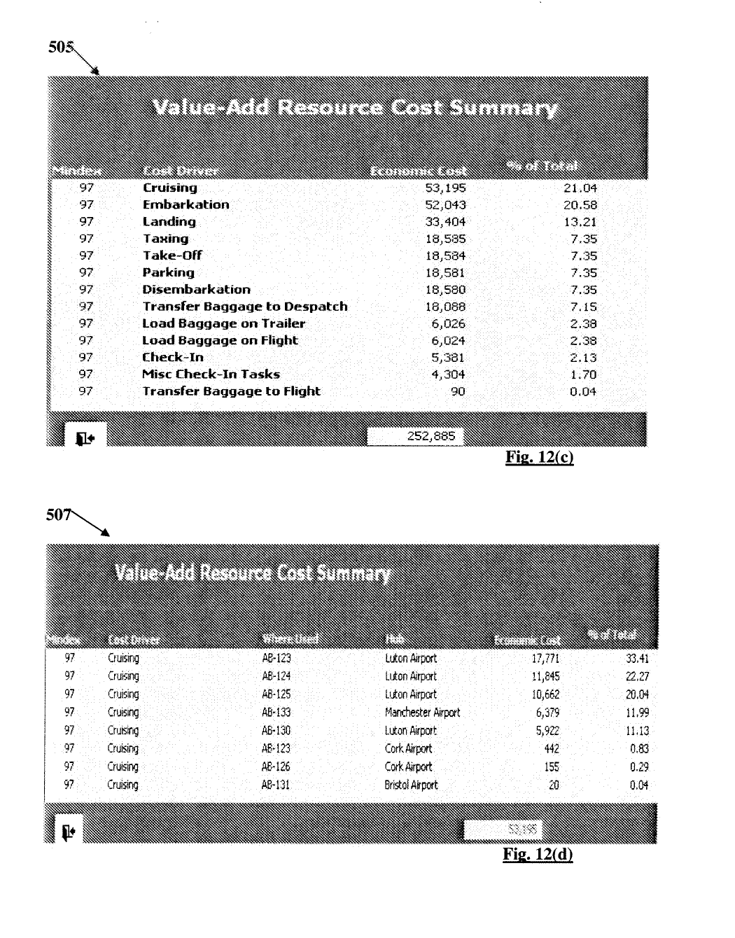

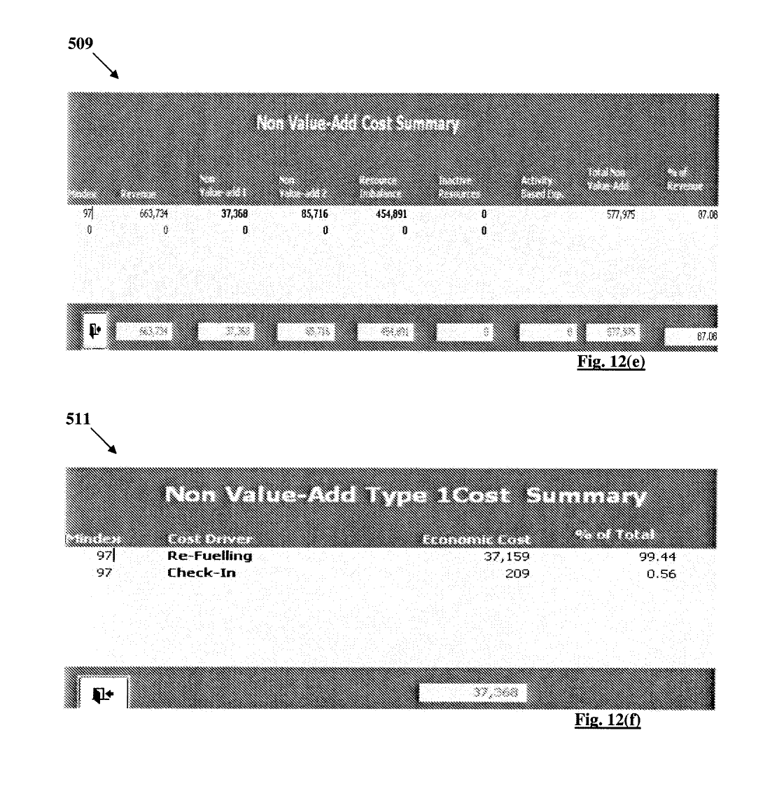

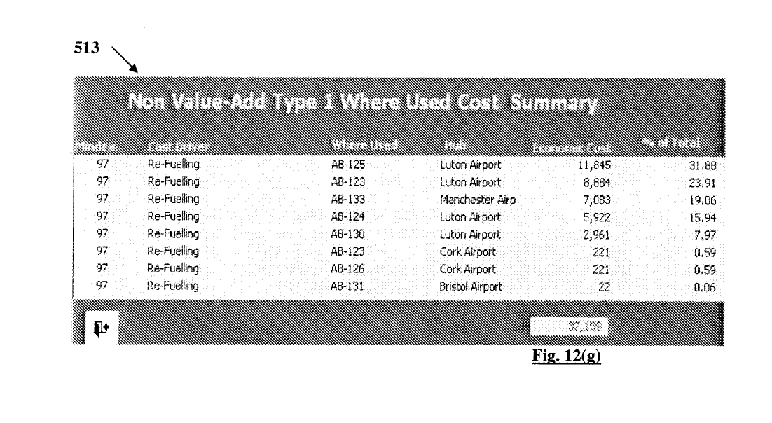

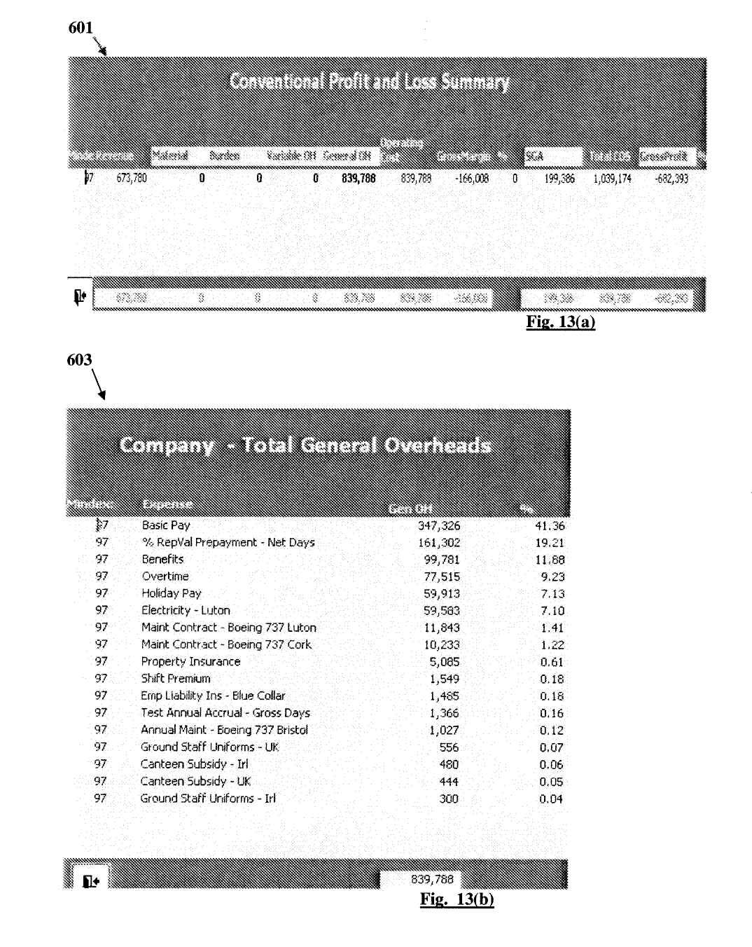

FIGS. 12(a) to 12(g) are screen shots displayed by the tool during an alternative drill down process; and

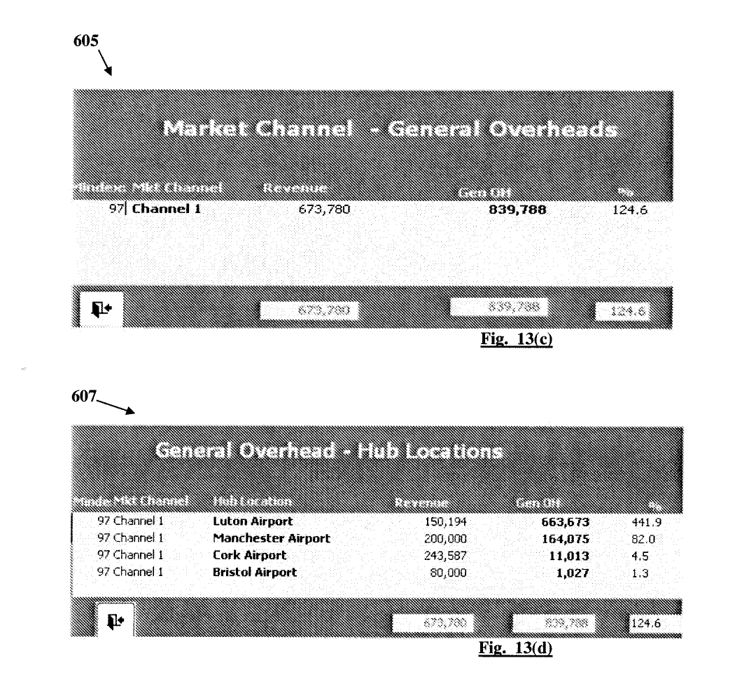

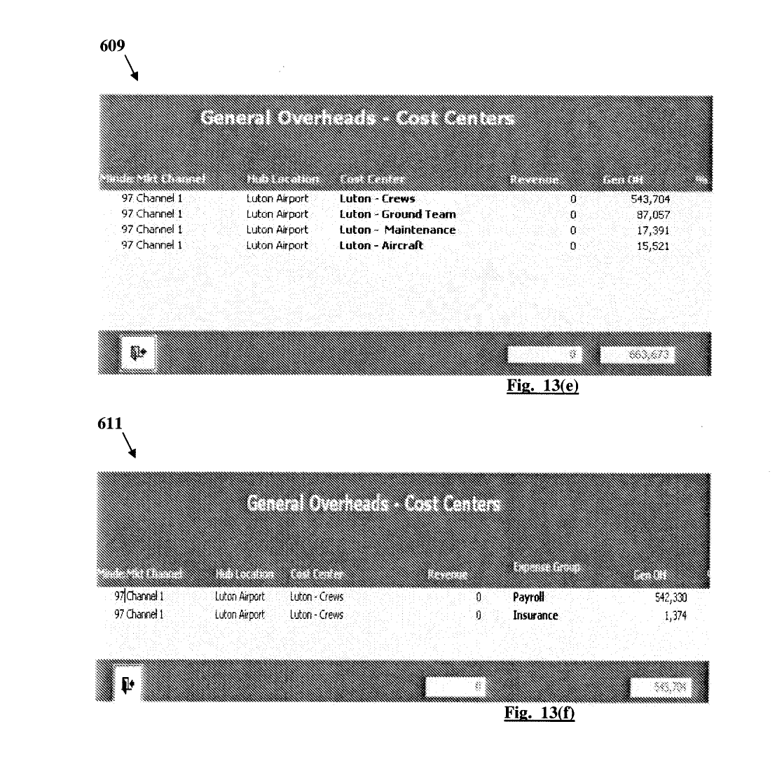

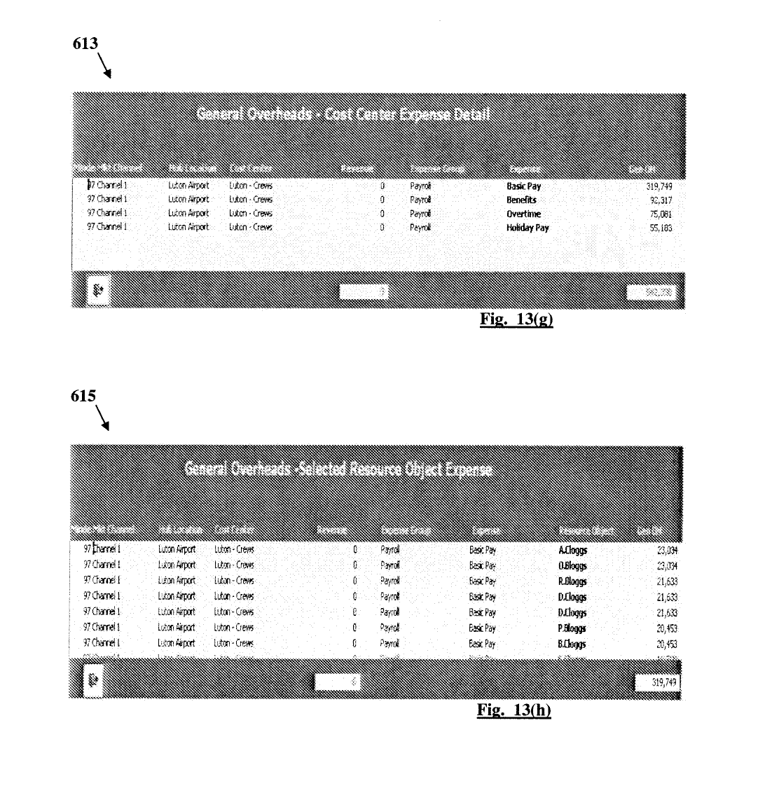

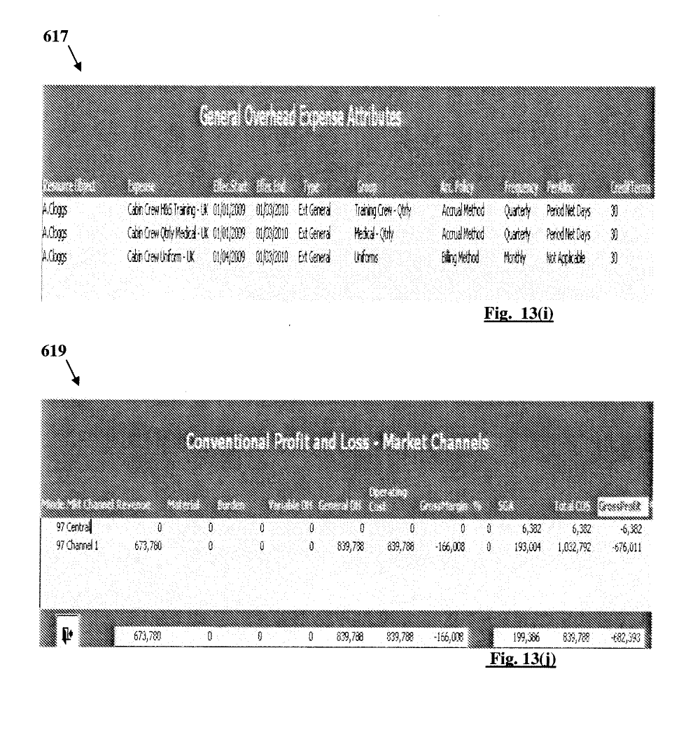

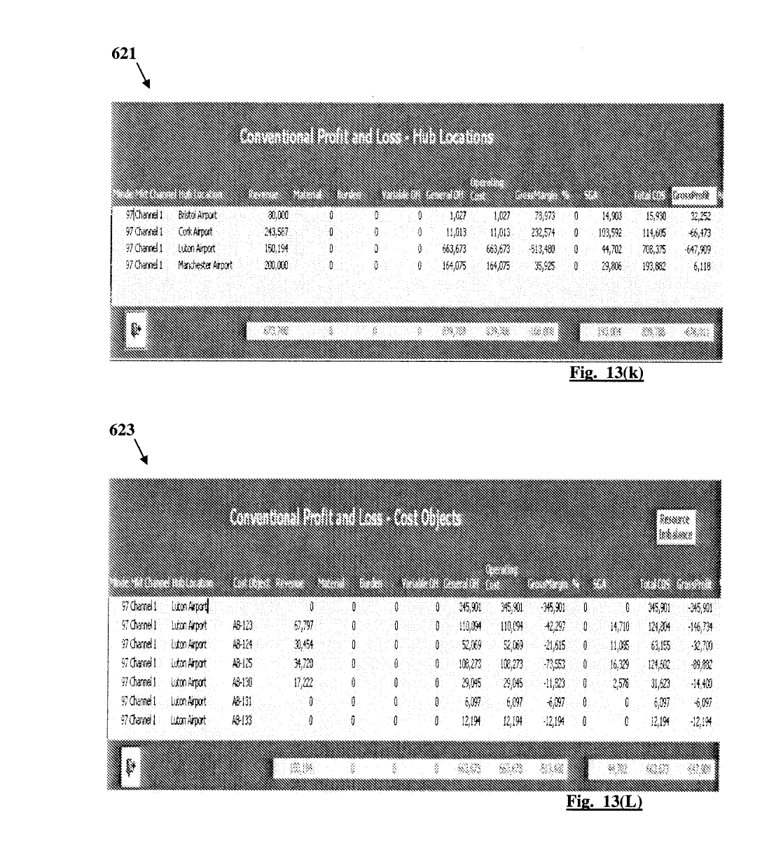

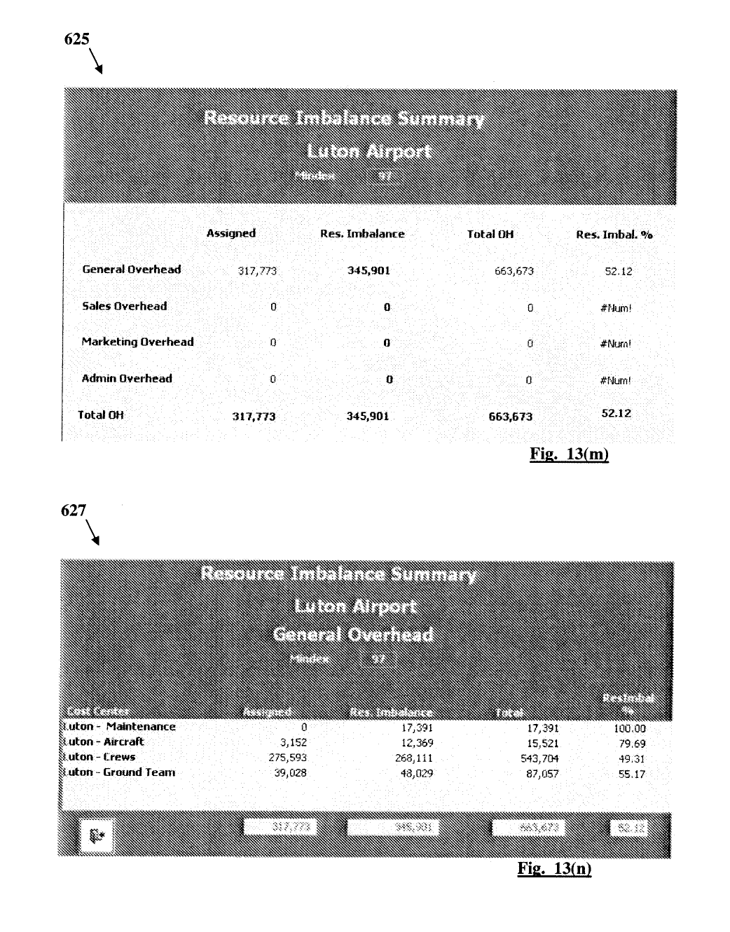

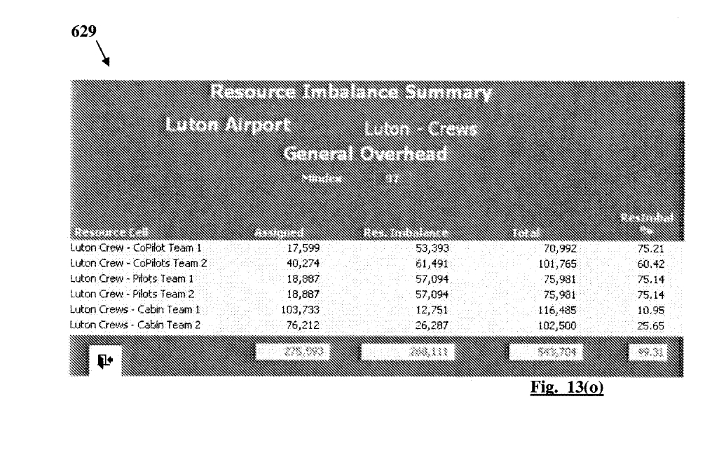

FIGS. 13(a) to 13(o) are screen shots displayed by the tool during a further still alternative drill down process.

Referring to the drawings and initially to FIG. 1 thereof, there is shown a diagrammatic representation of an object, indicated generally by the reference numeral 1, which forms part of the enterprise planning tool according to the present invention. The object 1 comprises a plurality of attributes 3, 5, 7, 9 and a time domain, 11, comprising a start time and a stop time for the object 1.

The attributes are the most fundamental level that the resource and cost structure for an enterprise can be resolved to. The attributes add structure and functionality to the enterprise planning tool. Additional functionality can be introduced into the enterprise planning tool by the addition of a new attribute. An object, which is configured from one or more attributes, is a tangible thing such as an expense, a resource, a product or a service.

Before describing the remaining drawings, it is of some benefit to clearly define some of the terms that are used throughout the specification. Below is a glossary of some of the more commonly referred to terms in the specification. The meaning of other terms not found in the glossary of terms may be determined intuitively from the description of those terms in the glossary.

### GLOSSARY OF TERMS

Attributes—Attributes add structure and functionality to the system. Attributes are the most fundamental level that the resource and cost structure for an enterprise can be resolved. Additional functionality can be introduced by the addition of new attributes. The connectivity between objects and therefore the speed at which complex drill downs and analysis is executed is based on the attributes that join objects. An attribute is a variable used for the configuration of an object.
Objects—Objects are configured from attributes. Objects are tangible things such as expenses, resources, products and services. Objects are configured from attributes and have a lifecycle. Examples of objects include 1) Activity based expense; 2) Business process resource object; 3) Business process passenger based; 4) Cost driver; 5) Resource cell; 6) Resource object; and 7) Work cell.
Relationships—Relationships are formed between objects to configure the software for the unique application. The scope of relationships between objects is controlled by a resource hierarchy and the UI configuration. Resources that pass through the value chain do so based on the relationship that exist between the objects. One side of the relationship is represented as the demand source and the other as the supply source. Relationships are established by the assignment of one object to another where the relationship is based on the matching of attributes and a common time dimension. The scope and requirements of attributes required to form a relationship are dependent on the purpose of the relationship.
Discrete Attributes—A discrete attribute is a system defined value that is combined with other attributes so as to form the structure from which all functionality, objects and relationships are dependent. A discrete attribute is an attribute that has not been combined with other attributes to form a configured attribute. Examples of discrete attributes include 1) Accounting policy (accrual, cashflow); 2) Activity type (unit, batch); 3) Assembly level (sub, final); 4) Cost partition (normal, abnormal); 5) Cost type (unit, time, area, etc.); and 6) Currency.
Configured Attributes—A configured attribute is an attribute configured from two or more attributes that originate from discrete and/or other configured attributes. Examples of configured attributes include 1) Cost driver configuration; 2) Cost object burden; 3) Expense configuration; 4) Expense Group; and 5) Process type.
Attribute Hierarchy—The attribute hierarchy allows the user to customise and simplify the process and non-finance personnel to add and create object relationships. For example, when a user is adding a new resource object expense such as an annual maintenance contract, the user selects and assigns from the pre-configured list the expense group “annual maintenance contract” and assigns the name for the new expense such as “Luton Boeing 737 Annual Maint”. Based on this the expense will automatically inherit all of the attributes related to the expense group such as the accounting policy (accrual), the expense frequency (annual), the period allocation method (gross days), which means that the expense for the annual cycle will be spread by period relative to gross days per period. Therefore, this simplifies the process for the user and in doing so also ensures that the addition of new expenses is done in a standardised way that ensures conformity to policy throughout the business.

What makes this possible is the responsibility for the configuration of such attributes by a central location such as the corporate finance headquarters for a group of companies ensures that conformity to corporate accounting policy is applied throughout the company. Where a company operates in regions that apply different accounting treatment, the attribute configuration for expense groups can be customised for special unique local accounting requirements.
Object Hierarchy—The object hierarchy makes different combinations of object relationships possible.
Value Chain—The value chain is customised for the user's business environment through the relationships established between objects. The value chain represents the link formed between objects based on the supply-demand relationship from within the resource hierarchy.
Time Dimension—Each object has a time dimension, a start date and an end date that represents the object lifecycle. When one object is assigned to another to form an object relationship, a test is performed to check whether they share a common time dimension. The common time dimension is assigned to the life of the object relationship.
Sequence Numbers—Sequence numbers correspond to the resource hierarchy. The order in which relationships are executed for resource fulfilment is controlled by sequence numbers. The user can sequence execution of certain transactions from within the resource hierarchy level. The sequence of execution also depends on the resource hierarchy level and the transaction in question.
Pull Based Demand—Pull based demand means that the process executes resource requirement fulfilment from the start of the value chain, through the resource hierarchy, based on the object supply-demand relationships. The methodology is a pull based resource demand system based on the relationships between different objects, configured from a common pool of attributes and linked together within the value chain to form a continuous process.
Resource Object—A resource object is a single item of resource such as an employee, building or an item of equipment.
Resource Cell—A Resource cell is a system location which as a general rule corresponds to a physical location. Resource cell types include 1) infrastructure 2) service 3) support and 4) activity. A resource cell consists of one or more resource objects, all resource cells have at least one resource object which is automatically added and assigned to the resource cell when added. The resource object automatically added to a resource cell is the intangible process type resource object. The criterion for the assignment of a resource object to a resource cell is that collectively they must function as a single unit. Attributes assigned to a resource cell are either inherited directly as attributes applied to the resource objects belonging to the resource cell such as the work calendar or to set a parameter that is applied to some attributes assigned direct to a resource such as the shift structure.
Resource Hierarchy—The resource hierarchy, combined with sequencing, controls the execution of pull demand along the value chain. It comprises the following discrete attributes that correspond to different levels within the resource hierarchy, 1) infrastructure 2) service 3) support and 4) activity. The function of the resource hierarchy is to control the order in which resources and resource costs flow from resource cells to resource objects and resource costs to business and conversion process objects.
Resource Imbalance—Resource imbalance refers to resources fall out or is the excess of resource supply over demand. Resource imbalance is the residual value of unused resources based on pull demand.
Work cells—A work cell is a system location where resources are grouped and available for the fulfilment of an objects needs, it is the cost driver that regulates the transfer of resources from the work cell to a cost object. A work cell is a virtual location for grouping and controlling resource supply and demand. A work cell is a system location whose function is as a routing location used in the configuration of the bill of resources. One or more resource cells may be assigned to the work cell. Work cells are configured from the following resources 1) resource cell 2) labour pool 3) resource object. Only those resources that share in common the following attributes (a) process type and (b) hub location are available for assignment. Only those resources that collectively function as a single unit are assigned to the same work cell.
Terms of Trade—The terms of trade assigned to a raw material or product in order specify the scope and responsibility for those costs incurred over and above the purchase or sell price respectively. An example of such is C.I.F which is assigned to indicate that the seller is liable for all costs, insurance and freight necessary to bring the goods to the named port of destination. Based on the terms assigned to a raw material object or product the system automatically assigns the routing, cost drivers and activity based expenses.
Calendar—The calendar contains important dates and milestones of the object, for example the calendar may show % wage rate change over a period of years that take into account wage increases and the like over that period of time. The system automatically builds one or more calendars for each object configuration. The system rebuilds the calendar whenever a start date or end date is applicable to the object changes.
Cloning—Cloning is a process whereby the record structure and object relationships, where applicable, for a host object is used as the basis for creating a new object with the same or similar record structure and object relationships. A cloned object is not a copy of the host object, the output of the cloning process is a new set of master and link table records whose indexes are unique to any other object structure or object relationships. The scope of a cloned object may vary from a simple master record to the creation of a complex set of master and link records that are representative of a completely new value-chain. Cloning can be applied to simple and complex structures, such as a new expense or the configuration required for a new product or service respectively. Multiple cloning of products and services is possible. Multiple cloning is applied to expense objects. Single cloning is applied to products and services. Object cloning reduces the time required to configure new structures by in excess of 90% of the time otherwise required. The cloning process also reduces the time required to build a new database or to expand an existing database.
Data Processing—by data processing, this will be understood to mean processing of records of objects, relationships and attributes. A multi-site deployment of the enterprise planning tool could potentially result in billions of records. Records are added to the system by objects and object relationships. The system creates records as it builds object relationships across the value chain and creates records to track resource fulfilment and costs across the value chain. As a result, resource costs along the value chain can be traced back to the location within the value chain where it originated.
Drill Down—Drill down will be understood to mean the action of delving to a deeper level of detail in the enterprise management tool. The combination of user added records and software generated records and how they are linked enables the user to drill down across multi-dimensional data.
Resource object group—Resource object groups include 1) land; 2) building; 3) equipment; 4) labour, grade based; 5) labour, employee based; and 6) process.
System Type—A system type applies to discrete attributes, one of the two lowest denominators that any object in the system can be resolved to. These include 1) resource object; 2) raw material object; 3) cost object; and 4) others.
System Process—A system process also applies to discrete attributes, one of the two lowest denominators that any object in the system can be resolved to. These include 1) conversion process; and 2) business process.
Resource object—A resource object is a discrete object acquired for the purpose of fulfilling the resource needs of other objects, for example an employee, building or item of equipment.
Master Records—A master record is a set of data for an individual object configured from attributes. Master records are grouped in the following categories 1) resources; 2) process type; and 3) expenses.
Cost Driver—A cost driver represents activities that are performed on an object as it passes through a routing, work cell, for example, unloading pallets is a cost driver.
Business Process Resource Object (RoBp)—This process refers to the addition of a business process driven by a resource object. An example of a business process resource object is a payroll processing cost driven by labour resource objects or equipment maintenance carried out by an internal maintenance department.
Business Process Raw Material Object (RmoBp)—This process is a business process driven by a raw material object. An example would be the raw material object procurement process. That includes a review of materials requirements, preparation and delivery of purchase orders to a vendor.
Business Process Product (CoBp)—This is a process driven by a product based object, for example a billing process that includes all of the process steps required from the preparation, processing and delivery of an invoice to a customer.
Business Process Passenger Based (CoBp (also))—This is a process driven by the number of passengers assigned to a CoCp—service (flight), for example, baggage handling.
Raw Material Object (RmoCp)—This refers to the configuration of a raw material object. An example is the raw material object conversion process for the process steps that a printed circuit board passes through from the time that title transfer occurs to the release of the printed circuit board to production.
Conversion Process Product (CoCp)—This process is a conversion process for a product based cost object. An example would be a motherboard and includes the process steps from the set-up of the resources required for the manufacture of a motherboard to title transfer of product to customer.
Conversion Process Service (CoCp(also))—This is the addition of a passenger based conversion process, An example would be the process steps from the preparation of an aircraft for a flight to the disembarkation of the passengers at the destination and any other process steps required to complete this route.
Resource Object Expense (ResObjExp)—These are expenses driven by resource objects e.g. utility, rent, maintenance contract.
Raw Material Object Expenses (RmoCpExp)—These are activity based expenses driven by raw material objects e.g. inspection labels placed on a component to indicate that it has been inspected.
Internal Resource Expense (IRE)—This is the output from a discrete resource cell, the purpose of which is to service the resource requirements from internal resources. An example of an IRE is a building.
External Expenses—There are four categories of external expenses 1) resource object expense; 2) raw material object expense; 3) activity based expense; and 4) burden. Activity based expenses are driven by the following process types—(a) conversion process product (b) conversion process service (c) business process product (d) business process passenger (e) business process raw material object (f) conversion process raw material object. Burden expense comprises (g) material procurement and (h) sales burden.
Object Configuration Bill of Resources—This process refers to the configuration of a routing structure for a conversion or a business process based object. This involves the assignment of work cells to an object whereby the order in which they are arranged (the routing sequence) represents the sequence in which resources as represented by work cells are consumed. Once configuration of the routing is complete the next task is to assign the cost drivers (tasks and activities) to each of the routings. The cost driver not only describes the activity performed, but also all of the attributes applicable to each activity that determines the precise amount of resources required of the routing step (work cell).
Link Tables—These refer to object relationships.

Below are some examples of objects and their attributes. In this case, the setting is an embodiment where the enterprise planning tool according to the present invention is applied to an airline operation. In such a scenario, one example of a resource object would be a grade based labour resource object, in this case a Pilot. The grade based labour resource object has the following attributes: (i) active or inactive (ii) multi-dimensional object (iii) labour group (iv) overtime applicable (v) shift premium applicable (vi) time dimension and (vii) resource cell. The active or inactive attribute is indicative of whether the pilot is available for assignment to a particular task. If active, this means that the pilot will be available for assignment to a flight. If inactive, this means that the pilot will not be available for the flight, and, for the duration of the time dimension, costs will be incurred and reported as the cost of inactive resources. The multi-dimensional object attribute relates to whether the company wants to track, for example, the cost of quality. If the pilot is not assigned to a quality related function then the multi-dimensional object is not applicable. The labour group attribute is used to specify the level of the grade scale that the pilot is on. The overtime applicable attribute is used to determine whether overtime pay is applicable or not to the pilot. This is indicated by simply ticking the overtime applicable attribute if the pilot qualifies for overtime pay. The shift premium applicable attribute is checked if applicable to the pilot. For example, this could be “time and a third” of normal pay rates for work on Sundays. The time dimension attribute sets the start and end date for the pilot. Finally, the resource cell attribute assigns a pilot to a Pilot labour pool resource cell. Based on this assignment, the pilot will inherit the attributes applicable to the labour pool such as the calendar and shift structure.

In relation to the above, it is important to note that overtime and shift pay can be set to default to the setting in a labour grade details pick list and switched off for individual grade based labour resource objects as required. The addition of labour resource objects and the time dimension associated with each is related to the resource and not the incumbent person in the position. The resource object inherits the hub location that its parent resource cell is located and the resource object assignment to a shift is restricted to the shift structure applicable to the parent resource cell. The basis on which shift premium is calculated and applied to qualifying labour resource objects is inherited from the resource cell, such as a rotating or fixed shift premium rate. The resource object can only be assigned to a resource cell that is permitted by the user interface based on the resource cell type, for example a pilot could not be assigned to an infrastructure resource cell type because infrastructure resource cells can only comprise land or buildings.

Another example of a resource object is an aeroplane, specifically a Boeing (Registered Trade Mark) 737. The Boeing 737 comprises the following attributes (i) active or inactive, (ii) resource cell (iii) occupancy (iv) replacement value and (v) fixed asset. The active or inactive attribute relates to whether the aircraft is available for a flight. If active, this means that the aircraft will be available for assignment to a flight. If inactive, the aircraft will be unavailable for the flight and for the duration of the time dimension, costs will be incurred and reported as the cost of inactive resources. The resource cell attribute relates to the resource cell to which the aircraft belongs. The occupancy attribute is assigned for passenger based resource objects and specifies the maximum number of passengers per flight. The replacement value attribute specifies the replacement value of the aircraft for insurance purposes and the fixed asset attribute determines whether the aircraft is a fixed asset. It is important to note that if the resource object is a fixed asset, a fixed asset profile form will open automatically when the record is saved in order that the user can add details for the new asset.

Yet another example of an object in the example of an airline operation is that of a resource object expense, in this case baggage handling equipment. This has the following attributes (i) expense type (ii) expense group (iii) cost rate (iv) currency (v) unit of measure (vi) cost per (vii) no. of instances (viii) no. of cycles (ix) effective start date (x) effective end date (xi) multi-dimensional object, and (xii) days credit. The Expense type is a discrete attribute set as general or customised. Customised is selected if the expense can only be assigned to one resource object. If available for assignment to multiple resource objects then the expense resource object is set as a general expense. The expense group is a configured attribute (one that is configured by the user) such as “Equip Quarterly—Rental”. The selection of the expense group and the assignment of this to the expense master record causes the expense to inherit all of the attributes related to the expense group such as the accounting policy, expense frequency, period allocation method and so forth. The “cost rate” applied relates to the value assigned attribute based on source currency, such as 5,000. The “currency” attribute is a currency type, such as US $. The unit of measure attribute is in this case a per item measure. The “cost per” attribute is a value based attribute that is assigned a value when the cost rate is stated as a rate quantity of items such as a cost per ton, for this example the default value is “1”. The No. of instances attribute is another value based attribute which is applied to a consumable that can be used more than once such as a Board Fixture. For this example the default value is “1”. The No. cycles attribute is a further value based attribute that is used to assign the number of times that an expense will be repeated based on the expense frequency inherited from the Expense Group assignment above. In the case of this example the frequency is quarterly, therefore if the user assigns a value of 16 for the number of cycles then the expense will be repeated for 16 quarters, that is, four years from the start date specified below. The effective start date is a value based attribute that assigns the date on which the first expense cycle occurs. The effective end date is a value based attribute that is calculated and passed to the master record automatically based on the start date and the number of expense cycles applicable to the frequency assignment to the expense. The multi-dimensional object is a discrete attribute used to assign an object to a special project. Finally, the days credit attribute is a value based attribute assigned by the user.

It is important to note that based on the selection of the expense group applicable to the new expense the following attributes will be inherited and passed to the master record (i) expense frequency (ii) accounting policy and (iii) period allocation method. The expense frequency in this case is a quarterly expense, the accounting policy is a prepaid expense and the period allocation method is the gross days method whereby the expense is spread by month for each expense cycle based on the gross number of days in each month.

Referring to FIGS. 2(a) and 2(b) of the drawings, there is shown a flow diagram of the operation of the enterprise planning tool indicated generally by the reference numeral 31. In step 32, the system is configured and in step 33 the system is customised. The system customisation is achieved by structuring local requirements for profit and loss, demographics, expense configuration, labour grade structure, currency and cost driver configuration.

In Step 34, Objects and object relationships are configured. A matrix, indicated by the reference numeral 66, represents the process for creating object connectivity and relationships presented in the context of the following; the Resource Hierarchy (34a), Resource and Object Configuration (34g to 34p) that represents the sequence in which different resource and object types are configured, the user interface for object and object relationship configuration (35-59) and the sequence applicable to each transaction required for the configuration of each object type (34q). Cost object and resource object expenses (34e and 34f respectively) are outside the scope of the resource hierarchy and only come within the scope of the resource hierarchy when assigned as the supply side of an object relationship.

The Resource Hierarchy (34a) comprises the following discrete attributes 1) Infrastructure 2) Service 3) Support and 4) activity. The function of the resource hierarchy, combined with the sequencing, controls the execution of pull demand along the value chain. This control is executed by controlling the order in which resources and resource costs flow from resource cells to resource objects and from resource costs to business and conversion process objects.

The queries and code related to the resource hierarchy (34a) is divided into two parts, Resource Cost Configuration (34b) and Object Cost Configuration (34c). The addition of cost object expenses (34e) and resource object expenses (34f) are outside the scope of the resource hierarchy and are added prior to object and object relationship configuration. It is only when cost object and resource object expenses are assigned as the supply side of an object relationship that monetary value associated with the expense can occur. When assigned as the supply side of an object relationship, such expenses come within the scope of control of the resource hierarchy and sequencing associated with the hierarchy. The function of the Resource Cost Configuration (34b) process is to configure resource objects prior to the assignment of resource costs to objects re Object Cost Configuration (34d). The execution of Resource cost configuration comprises two parts, the first part relates to those resource needs and costs that are independent of other internal resources and the second part relates to those resource needs fulfilled from internal resources.

The sequence in which resource costs are configured is critical to the outcome of the costs that will be subsequently assigned to other objects based on resource utilization. The sequencing involves the configuration of resource costs that are not dependent on other internal resources followed by those resource needs fulfilled from internal resources, the latter of which is controlled by sequence numbers applied to the execution of IRE (34i) and Resource Object business processes (34h) The purpose of the resource cost configuration is to ensure that the cost of resources that will be subsequently assigned to process objects is complete and representative of the resources assigned. The configuration of Resource cells (34g), resource objects (34h), internal resource expenses (34i) and resource object business processes (34j) come within the scope of Resource Cost Configuration.

It is important to note that because of the complexities in managing the inter-dependency of resource objects and the application of the sequencing process to control this process, the reference numbers used from 35 to 55 inclusive, as these relate to 34g thru 34j do not necessarily represent, in all cases, the order in which data entry occurs. For example, some resource cells must be configured before others in order that assignment from these can be made to resource objects belonging to a resource cell not yet activated. Also, some resource objects located in different resource cells are co-dependent. By means of the sequence number assignment and code these complexities are transparent to the user. Based on this, all that is required of the user is to create the object relationships for the fulfilment of resource needs, activate the resource objects and resource cell, the sequencing will manage the execution of the assignment process thereafter.

A resource cell (34g) is a physical and or system location, the purpose of which is to group resource objects that collectively function as a single unit. Resource Objects (34h) are discrete tangible resources such as land, building, equipment, labour or discrete intangible resource objects used for the purpose of capturing resource costs that are not dependent on tangible resource objects belonging to the same resource cell. An example of the function of a process resource object would be the assignment of the building resource occupied by a resource cell, if such resource costs were assigned to a tangible resource object, such as an item of equipment, then the removal of the equipment from the resource cell would have the affect of removing the building cost associated with the item of equipment. The user is not prevented from making such assignments as there may be instances where such an assignment is valid. An Internal Resource Expense (IRE), (34i) is an expense configured from a discrete resource cell, an example of an IRE is an electricity generator provided from internal resources, the cost of producing the electricity from the electricity generator is assigned to resource objects based on their utilization of this resource. A Resource Object business process (RoBp) (34j) is an internal business process driven by a resource object such as payroll processing or equipment maintenance. A resource object business process is configured from one or more multi-functional resource cells linked together through a bill of resources whereby resources and costs are passed to the business process objects based on cost driver assignment.

The function of the Object Cost Configuration (34c) is to assign resource costs to process objects based on resource utilization. The sequence in which resource cost assignment is executed is controlled by sequence numbers that are embedded in the software. The scope of object cost configuration includes Raw Material Object Business Processes (34k), Raw Material Object Conversion processes (34L), Cost Object Business Process—Product (34m), Cost Object Business Process—Passenger Based (34n), Cost Object Conversion Process—Product (34o) and Cost Object Conversion Process—Service (34p).

Raw Material Object Business Process (RmoBp, 34k) refers to a business process an example of which is “Procurement” the occurrence of which is dependent on business policies regarding inventory replenishment and raw material object requirements. The requirements for raw material object business processes are specified by the Raw Material Object Conversion process (RmoCp, 34L) which represent the demand side of the object relationship between the business and conversion process. Raw material object conversion processes (RmoCp, 34L) represent the processes and activities required from the moment of title transfer from vendor to procurer, including all intervening activities, to the release of material to production or service where required, the scope of this process is dependent on the terms of trade and the processes through which a raw material object must pass through, for example in the case where the terms of trade “Delivered Price” is applied, from receipt at dock (factory) to release from stock.

There are two types of cost object business and conversion processes, the first is generic and applies to most business requirements, referred to as “Product” and the second applies to passenger based processes, such as Airline service. Cost Object business process—Product (CoBp, 34m) refers to a business process such as production planning, work order release and billing. The requirements for cost object business processes is dependent on the activity associated with the cost object conversion process—product (CoCp, 34o) which represents the demand side of the object relationship between the business and conversion process objects. Cost Object Conversion Process—Product (CoCp, 34o) represents those processes and activities required from the release of a product to production or initiation of a service to title transfer, however from the perspective of the cost of capital this process is completed at the end of the cash conversion cycle when payment from customer is processed. Cost Object Business Process—Passenger Based (CoBp (Also), 34n) relates to business processes that are driven by a passenger based cost object conversion process—Service (CoCp, (Also), 34p) An example of a cost object business process—passenger based (CoBp, (Also), 34n) is baggage handling which is driven by the number of passengers associated with a flight, as represented by the cost object conversion process (CoCp, (Also), 34p), the demand side of the business and conversion process object relationship.

Finally as this relates to the object cost configuration process, the cost object conversion process—service (CoCp, (Also), 34p) represents the processes and activities required from the initiation of a passenger based service to the safe delivery of a passenger at the port of arrival. An example of a cost object conversion process—service (CoCp, (Also), 34p) is a flight which includes all of the activities from embarkation to disembarkation. Items (34q) represents the sequence in which each process is executed by object type, by cross referencing the user interface transaction references 35 to 59 and the resource and object configuration references 34e to 34p, the requirements for the configuration of each resource and object type may be extracted.

In step 35, the user adds a general cost object expense. A cost object expense is an expense that is dependent on a business or conversion process object, expenses are always represented as the supply side of the object relationship between the expense and cost object in this case. A general cost object expense may be assigned to one or more cost objects. An example of a cost object expense as relates to a business process is a license fee associated with the use of certain technology applied to the provision of a software application. An example of a conversion process cost object expense would be the landing fees related to a flight. There is no cost associated with a cost object expense until an object relationship is formed with a cost object business or conversion process object. In the case of this example, landing fees are applied automatically based on the number of flights per period and the number of times that the flight lands at the airport to which the fees apply.

In step 36, the user adds an external general resource object expense, this is referred to as an external expense so as to make the distinction between this and an internal resource expense which is discussed in (40) below. An external resource object expense is an expense that is dependent on a resource object, expenses are always represented as the supply side of the object relationship between the expense and resource object in this case. A general resource object expense can be assigned to one or more resource objects. An example of an external resource object expense is the pilot certification to fly a Boeing 737, or the fuel that the flight consumes or maintenance contracts required to maintain the aircraft. In the case of the fuel this type of resource object expense, because it is activity based, it is dependent on both the resource object to which it is assigned, but also that the fuel usage is dependent on the flight (cost object) to which the resource object is assigned.

In step 37, a user adds a resource cell. A resource cell is a system location whose resources consist of one or more resource objects which in turn are discrete objects acquired for the purposes of fulfilling the resource needs of other objects. The criterion for assignment of a resource object to a resource cell is that collectively the resource objects function as a single unit. An example of a resource cell and its resource objects is a continuous production line that comprises four distinct and separate resource objects, such as, an automated component placement machine, a wave solder machine, a manual assembly line and test equipment. These resource objects are joined together and function as a single unit. If however the test equipment is separated from the production line so as to function independently of the production line then the test equipment would no longer form part of the same resource cell and would be assigned to a new resource cell.

In step 38, a user adds and assigns a resource object to a resource cell. A resource object is a discrete object acquired for the purpose of fulfilling the resource needs of other objects. Land, buildings, equipment, grade based labour, employee based labour and process resource objects are examples of resource objects. When adding land, building and equipment resource objects a user is required to indicate on the user interface whether the resource object is a fixed asset or not. Should the user indicate that the resource object is a fixed asset, then in order to complete the addition of the resource object, the user is required to provide fixed asset profile information for the fixed asset configuration. Examples of fixed asset resource object is an aircraft purchased by the airline and a non fixed asset is the short term rental of an aircraft.

In step 39, a user assigns a resource object expense to a resource object. In this case the user may select an external resource object expense added in step (36) above, In the case of a customised resource object expense the processes to add and assign an expense are combined into a single process. The assignment is subject to the criteria for the formation of such an object relationship. The assignment process is repeated until all external resource object expenses have completed.

In step 40, a user adds an Internal Resource Expense (IRE). Add example of an IRE is an internal electricity generator required to fulfil the resource needs of resource objects to which it is assigned. In step 41, a user assigns an activated discrete resource cell to an IRE. In this case the resource cell that comprises the electricity generator is assigned to and represented for the purpose of assignment to other resource objects as an internal expense. The assignment of the electricity generator to one or more resource objects is through the medium of an expense rather that a resource cell. The assignment is subject to the criteria for the formation of such an object relationship.

In step 42, a user assigns an IRE to a resource object. This assignment is based on the utilization of the IRE resources attributed to the resource object. The assignment is subject to the criterion for the formation of such an object relationship. In step 43, a user assigns an activated resource object business process to a resource object. An example of a business process is the assignment of payroll processing costs to labour based resource object. The assignment is subject to the criteria for the formation of such an object relationship.

In step 44, a user activates a resource object. The activation of a resource object is subordinate to the activation of the resource cell to which it belongs. The purpose of the activation of a resource object is to indicate to the user that all of the object relationships related to the resource object have been added. It should be noted that the inter-dependency and therefore configuration of a resource cell and its resource objects as represented by 34g thru 34j is controlled by the two step process as described in (34b) and elsewhere above.

In step 45, a user activates a resource cell. The activation of a resource cell means that the configuration is complete and that the resource cell is available for assignment.

In step 46, the user adds work cells. A work cell is a system location whose function is as a routing location used in the configuration of a bill of resources. Work cells are configured from one or more of the following, a complete resource cell, labour resource objects assigned from a labour pool or from a single resource object selected from a resource cell. The criterion for the assignment of resources to a work cell is that collectively the resources assigned to a work cell function as a single unit. The same resources can be assigned to more than one work cell. An example of a work cell is an aircraft and its crew. In this example the aircraft is operational for 12 hours a day for six days a week, the resources required for this work cell is a Boeing 737 which is a resource cell that contains a single resource object, the aircraft. Because of the operational schedule for the flight this flight requires two crews, one crew for day 1 to day 3 and a second crew from day 4 to day 6. Each crew comprises a pilot, co-pilot and cabin crew assigned from different labour pool resource cells. The crew working from day 1 to day 3 belong to different labour pools than the crew that work from day 4 to day 6, therefore altogether the work cell requires resources from seven different resource cells in order to be operational for six days a week. One resource cell for the aircraft and two each for the pilots, co-pilots and cabin crew. All resources, whilst combined in the same work, cell must function as a single unit if the flight is to operate.

In step 47, a user assigns one or more activated resource cells to a work cell. The assignment of a resource cell to a work cell is restricted to activated resource cells and those resource cells and work cells that share in common the same process type and hub location. An example of an assignment of a resource cell to a work cell is the assignment of a resource cell representing an aircraft based in Luton to the work cell representing the resources required to service a flight operating from the Luton hub location.

In step 48, a user activates a work cell. The activation of a work cell means that a work cell is available for the configuration of a business or conversion based process object subject to the criteria for the object relationship being satisfied. In step 49, a user adds a cost object. This is the first of many steps required for the configuration of a cost object where the cost object represents a new business or conversion process object.

In step 50, a user assigns a cost object conversion process object to a hub location. The user can assign the same cost object to one or more hub locations. An example of this process is the assignment of the Luton—Cork flight to both Luton and Cork hub locations. In doing so, the same flight can be serviced from resources based in both Luton and Cork. The assignment of the cost object to the hub location is subject to the criteria for establishing such an object relationship and the restriction of the assignment to the time dimension that is common to both objects.

In step 51, a user assigns one or more activated work cells to a bill of resource for both business and conversion process objects. An example of this is the assignment of the package of resources required to service the Luton—Cork route to the cost object represented by this flight. Assignment is subject to both attribute and time dimension criteria being satisfied.

In step 52, a user adds a cost driver. An example of a cost driver as it relates to a flight is embarkation or traffic delay. In step 53, a user assigns one or more cost drivers to a routing step that represents a work cell assignment to a business or conversion process object. The assignment of a cost driver also includes the customization of the cost driver, such as it relates to, the lifecycle for the cost driver, the lead time applicable to the activity or task as represented by the cost driver and the value type applicable to the cost driver etc. The assignment of the expense to the cost driver is subject to the criteria for establishing such an object relationship and the restriction of the assignment to the time dimension that is common to both objects.

In step 54, a user assigns a cost object expense to a business or conversion process object. The assignment is made to a cost driver assignment per step (53) above. An example of a cost object expense assignment to a conversion process is the assignment of the landing fee on the Luton—Cork flight to the “Landing” cost driver. The assignment of the expense to the cost driver is subject to the criteria for establishing such an object relationship and the restriction of the assignment to the time dimension that is common to both objects.

In step 55, a user assigns an activated raw material business process to a raw material conversion process cost driver. An example of this process is the assignment of the procurement process to a procurement cost driver. The assignment of the business process to the conversion process object is subject to the criteria for establishing such an object relationship and the restriction of the assignment to the time dimension that is common to both objects.

In step 56, a user assigns an activated product business process to a product conversion process object cost driver. An example of a product business process object assignment is the assignment of the billing process to a product conversion process object cost driver. The assignment of the expense to the cost driver is subject to the criteria for establishing such an object relationship and the restriction of the assignment to the time dimension that is common to both objects.

In step 57, a user assigns an activated passenger based business process object to a service conversion process object. An example of the assignment of a passenger based business process is the assignment of baggage handling or check-in to a service conversion process object as represented by a flight. The process removes the restriction on the criterion for matching hub locations so as to allow the assignment of a business process such as baggage handling in Cork to be assigned to a flight that both originates and is serviced from Luton.

In step 58, a user assigns a raw material object to both product business and conversion process object routing steps. The assignment of a raw material to a business or conversion process object automatically inherits and assigns the resource and cost structure for the raw material, including both raw material object business and conversion processes.

In step 59, a user activates a cost object. This process applies to both business and conversion process objects for all cost object types such as resource object, raw material, product and service. In step 60, the user assigns forecast data. In step 61, the user executes queries and code. In step 62, the user generates a work table and allows input of queries in step 63 and tables in step 64 to generate reports in step 65.

Referring to FIGS. 3(a) and (b) there is shown a table of object relationship link table field names, demand and supply objects represented by each transaction type and table name, as indicated by the reference numeral 81. In FIG. 4 there is shown a brief description for each of the transaction types listed in FIGS. 3(a) and 3(b). In FIGS. 3(a), 3(b) and 4, a reference column with numerals from 1 to 49 inclusive is included so that the entries in the tables may be cross-referenced with each other. In other words, reference 1 entry in FIG. 3(a) has a corresponding description in reference 1 entry in FIG. 4, reference 39 entry in FIG. 3(b) has a corresponding description in reference 39 entry in FIG. 4, and so on. Each of the relationships is provided with the unique link code so that it may be accessed through the value chain. The link codes also give an indication of the objects that form part of the link as once one knows the object, it is possible to tunnel through the objects and the relationships for any connected and related objects and relationships.

Referring to FIG. 5 of the drawings, there is shown a sample connectivity flowchart, indicated generally by the reference numeral 82, detailing steps related to each process identifier in the sample connectivity diagram. The arrows and sequence numbers contained within FIG. 5 indicate the general direction and sequence by which resources and resource costs flow between different processes, such as resource object business processes, raw material object business processes, raw material object conversion processes, cost object business processes and cost object conversion processes. The data source applied to this example is FIG. 6 and FIG. 7 which is the same data source used by FIGS. 9(a) and 9(b) used to demonstrate the drilldown capability of the invention. Referring to FIG. 5(a), a relatively simplistic representation of the process flow as represented by FIG. 5(a), that excludes the cost object business process and complexities related to the assignment of resource object business processes to all resource objects as represented in FIG. 5. FIG. 5(a) is not intended to be a comprehensive representation of all the complexities of the process, but rather is indicative of the process flow.

Referring to FIGS. 5(a) to 5(f) of the drawings, there is shown a sample connectivity flowchart indicated generally by the reference numeral 84. The sample connectivity flowchart shown is a relatively simplistic representation of the process flow and as such is not intended to be comprehensive but rather is indicative of the process flow.

Referring to FIG. 5(a), which represents the interconnectivity and general order in which resources and resource costs flow between different process objects applicable to the sample flowchart, is subdivided into 5 parts as represented by FIGS. 5(b), 5(c), 5(d), 5(e) and 5(f). FIG. 5(b) is inclusive of those processes required for the configuration of a resource object business process, FIG. 5(c) is inclusive of those processes required for the raw material object business process configuration, FIG. 5(d) is inclusive of those processes required for the raw material object conversion process configuration, FIG. 5(e) is inclusive of those processes required for the conversion process bill of materials configuration and FIG. 5(f)) is inclusive of those processes required for the product conversion process configuration.

With reference to the FIGS. 5(b) to 5(f) there is included in each a reference to items 191 and 193. Referring to 191, the italic reference stated in parenthesis, such as “(2) Resource Cell B” as an example of a master record and “(41) Assign Work Cell B” as an example of a link record in FIG. 5(b), is inserted so as to cross-reference to the sequence in which each transaction is executed according to the master and link record data provided in FIG. 6 and FIG. 7 respectively. Referring to 193 and in particular to the alpha character that precedes the name in the case of the master record transaction and the numeric character that precedes the link record name in the case of the link record transactions in FIG. 5 (b), such as “A. Add a Resource Cell” and “8. WCRLabID” refers to the transaction number for master and link records in order to cross-reference each transaction to the data source contained in FIG. 6 and FIG. 7 respectively to provide further information related to these transactions and yet again, for additional information related to these transactions, reference may be made to FIGS. 3 and 4 for link records and FIG. 8 for Master records.

FIG. 5(b) comprises two resource cells, resource cell B 87 and resource cell C 95. Each resource cell has a resource object and each resource object has a resource object expense. Referring first of all to resource cell B 87, the resource cell B 87 comprises a resource object (2) 89 which comprise resource object expense K 91. Referring to 93, the assignment of expense K 91 to resource object (2) 89 results in the automatic addition of a unique ResObjUmLinkID link record. Referring next to resource cell C 95, the resource cell C 95 comprises a resource object (3) 97 which comprise resource object expense L 99. Referring to 101, the assignment of expense L 99 to resource object (3) 97 results in the automatic addition of a unique ResObjUmLinkID link record. At this stage the configuration of resource objects and resource cell is complete, Resource Cell B 87 and Resource Cell C 95 are activated and available for assignment as indicated by 103 and 105 respectively. Referring to 107, Work Cell B is added. Referring to 109, the assignment of Resource Cell B 103 to Work Cell B 107 results in the automatic addition of a unique WorkCellResourcesID link record. Referring next to 111, the assignment of Resource Cell C 105 to Work Cell B 107 results in the automatic addition of a unique WCRLabID link record, this completes the work cell configuration at which time Work Cell B 107 is then activated as indicated by 113 and available for assignment. The resource object business process, cost object 1 115, is added to which Work Cell B 113 is assigned as indicated by 117, this results in the automatic addition of a unique RoutingID (1) link record as indicated by 119. Referring to 121, Cost driver B is added. Referring to 123, Cost Driver B 121 is assigned to RoutingID (1) 119, this results in the automatic addition of a unique WorkCellDriver link record after which bill of resource configuration is complete and the resource object business process Cost Object (1) 115 can now be activated, as indicated by 125. As indicated by 127, after activating cost object (1) 115, the resource object business process is assigned to resource objects (1) and (4), located in FIGS. 5 (c) process 1 and 5(d) process 1 respectively.

FIG. 5(c) comprises one resource cell Resource Cell A 129. Resource cell A 129 comprises Resource Object (1) 133 which in turn comprises Resource object expense J 131. Referring to 135, the assignment of resource object expense J 131 to the resource object (1) 133 results in the automatic addition of a unique ResObjUmLinkID link record. Referring to 137, the resource object business process, originating from Cost Object (1) [127 in FIG. 5(b)], process 5 is assigned to resource object (1) 133 which results in the automatic addition of a unique BpLinkID link record. Referring to 139, Resource cell A 129 configuration is complete, activated and available for assignment to a Raw material object business process. Referring to 141, Work Cell C is added. Referring to 143 in which activated resource cell A 139 is assigned to Work Cell C 141 which results in the automatic addition of a unique WCRLabID link record, this completes the configuration of Work Cell C 141 which is then activated as indicated by 145. Referring to 147, the raw material object business process, Cost Object (2) is added. Referring to 149, Work Cell C 145 is assigned to Cost Object (2) 147 which results in the automatic addition of a unique RoutingID (2) link record as indicated by 151. Referring to 153, Cost Driver C is added. Referring to 155, Cost Driver C 153 is assigned to RoutingID (2) 151, this results in the automatic addition of a unique WorkCellDriverID as indicated by 157, this completes the configuration of raw material business process Cost Object (2) 147 and it can now be activated as indicated by 159. Referring to 161, the activated CostObject (2) 159 is then assigned to Resource Object (4) in FIG. 5(d) Process 1.

FIG. 5(d) comprises one resource cell Resource Cell D 163. Resource cell D 163 comprises Resource Object (4) 167 which comprises Resource object expense M 165. Referring to 169, Resource Object Expense M 165 is assigned to Resource Object (4) 167 which results in the automatic addition of a unique ResObjUmLinkID link record. Referring to 171, the resource object business process, originating from Cost Object (1) [127 in FIG. 5(b) process 5], is assigned to Resource Object (4) 167 which results in the automatic addition of a unique BpLinkID link record as indicated by 171. Referring to 173, Resource cell D 163 configuration is complete and the Resource Cell D is activated. Referring to 175, Work Cell D is added. Referring to 177, the Resource Cell D 173 is assigned to Work Cell D 175 which results in the automatic addition of a unique WCRLabID link record. The assignment of resource cell D 173 to Work Cell D 175 completes the configuration of Work Cell D 175 which is then activated as indicated by 179 and is available for assignment. Referring to 181, Raw Material Object (1) is added. Referring to 183, Work Cell D 179 is assigned to Raw Material Object (1) 181 which results in the automatic addition of a unique RoutingID (3) link record as indicated by 185. Referring to 187, Cost Driver D is added. Referring to 189, Cost Driver D 187 is assigned to RoutingID (3) 185 which results in the configuration of the routing 191 and the automatic addition of a unique WorkCellDriverID as indicated by 191. Referring to 193, Raw material object business process, Cost Object (2) [161, originating in FIG. 5(c) process 5] is assigned to WorkCellDriverID created by configured routing step 191 which results in the automatic addition of a unique RmoCoCdLink link record. Referring to 195, this completes the configuration of raw material conversion process for Raw Material Object (1) 181 which can now be activated and is subsequently inherited when Raw Material Object (1) 181 is selected in FIG. 5(e) process 1.

FIG. 5(e) comprises the assignment of the activated Raw Material Object (1) [196, originating from FIG. 5(d) process 6] to Cost Object (4) [221, originating from FIG. 5(f) process 3]. Activation of this record is not required as it is dependent of the activation status of Cost Object (4) [235, originating from FIG. 5(f)] to which it is assigned.

FIG. 5(f) comprises one resource cell, Resource Cell E 201. Resource cell E 201 comprises Resource Object (5) 205 which comprises Resource object expense N 203. Referring to 207, Resource Object Expense N 203 is assigned to Resource Object (5) 205 which results in automatic addition of a unique ResObjUmLinkID link record. Referring to 209, Resource cell E 201 configuration is complete and activated. Referring to 211, Work Cell E is added. Referring to 213, Resource Cell E 209 is assigned to Work Cell E 211 which results in the automatic addition of a unique WCRLabID link record. Referring to 215, Work Cell E 211 configuration is now complete and activated. Referring to 217, Cost Object (4) is added. Referring to 219, Hub Location (1) is added. Referring to 221, the Hub Location (1) 219 is assigned to Cost Object (4) 217 which results in the automatic addition of a unique CostObjHubLinkID link record.

Referring to 223, Work Cell E 215 is assigned to Cost Object (4) 217 as represented by CostObjHubLink 221 record which results in the automatic addition of a unique RoutingID (4) link record as indicated by 225. Referring to 227, Cost Driver E is added. Referring to 229, Cost Driver E is assigned to the RoutingID (4) 225 which results in the automatic addition of a unique WorkCellDriverID as indicated by 231. Referring to 233, Raw Material Object (1) bill of materials record [199, originating from FIG. 5(e) process 1], is assigned to the RoutingID (4) 225 which results in the automatic addition of a unique BomID link record 233. This completes the configuration of the Product Conversion process object, Cost Object (4) 221, which is now activated as indicated by 235, and made available for sales volume assignment. It can be seen from the foregoing that all of the objects and process steps are interrelated and connected via relationship or through an indirect relationship. This allows for the roll-up and true cost of an object, whether it is a product or service, to be ascertained.

Referring to FIGS. 6 to 9 inclusive, there is shown an example of how a drill down through the information may be achieved using the consistent structure described above. The four figures are interrelated and the same reference numerals in the figures relate to the same object or process step in the other figures. Also as mentioned at the introduction for FIGS. 5(b) to 5(f), the same data source is used for both these and FIGS. 9(a) and 9(b)

Referring first of all to FIG. 6 of the drawings, there is shown a diagrammatic representation of the master tables, indicated generally by the reference numeral 190. The master tables for the purpose of this representation include the Resource Cell 197, Resource Object 199, Work Cell 201, Cost Object 203, Cost Driver 205, Raw Material Object 207, Resource Object Expense 209, also included is the attribute table Hub Location 211. The master table comprises a primary key 213, a name 215 and a process type 217. The Resource Object 199 master table also comprises a parent field 219. References 191 and 193 are outside the scope of master table structure and are included in FIG. 6 to cross-reference to data source contained in FIGS. 5(b) to 5(f) and FIGS. 9(a) and 9(b). Reference 191 refers to the order in which records are added as represented by the drill down in FIGS. 9(a) and 9(b) and also used in FIGS. 5(b) to 5(f). Reference numeral 193, as it applies to FIG. 6 refers to the transaction to add a master record as represented in FIGS. 5(b) to 5(f).

With the exception of the Resource Object master table record there is no set requirement for the order in which master records are added. Because a resource object can only exist as a child to a resource cell parent, the parent is added before its children, the resource objects. For this reason, the user interface requires that the addition of a resource object also includes the assignment to the parent and for this reason the reference to the parent master record is contained in the resource object master record as a foreign key, as indicated in FIG. 6 by the reference numeral 219. In the case of the link table transactions the user interface controls the requirements to establish object relationships. The process type code is excluded from the resource object master record because this is inherited from the parent resource cell.

Referring to FIG. 7, there is shown a diagrammatic representation of the link tables with object relationships, indicated generally by the reference numeral 231. References 191 and 193 are outside the scope of the link table but are included in FIG. 7 in order to cross reference the link record data entry sequence and transaction number used in FIGS. 5(b) to 5(f) respectively. Reference 191 has also been included so that FIG. 7 may be cross-referenced with the link record data entry sequence illustrated in FIGS. 9(a) and 9(b). The link tables with object relationships are the transaction detail from which the drill down path flowchart of FIGS. 9(a) and 9(b) may be constructed. The link tables for the purpose of this representation include the ResObjUmLink 232 to record resource object expenses assigned to resource objects, WorkCellResources_LabPool 233 to record labour pool resources assigned to a work cell, WorkCellResources 234 to record non labour pool resource cells assigned to a work cell, Routing 235 to record a routing step (work cell) assigned to a cost object, WorkCellDriver 236 to record cost drivers assigned to a routing step, BpResObjUmLink 237 to record a resource object business process assigned to a resource object, BpRmoCdLink 238 to record a raw material object business process assigned to a raw material object conversion process, BOM 239 to record a raw material object conversion process and material cost assigned to a cost object conversion process, CostObjectHubLink 240 to assign a cost object conversion process to a hub location. Each link table and Object Relationships includes a plurality of categories and category headers including a link code 242, demand code 244, supply code 246, Process type code 217 and other codes as required for the Object Relationship. The Routing 235 link table has a further routing sequence header 248 and the WorkCellDriver 236 link table has a further cost driver sequence header 250.

Referring to FIG. 8, there is provided a master record transaction summary, indicated by the reference numeral 221. The list is representative of the master records for FIG. 5(b) to FIG. 5(f) and FIGS. 9(a) and 9(b).

Referring to FIGS. 9(a) and 9(b), there is shown a diagrammatic representation of a sample connectivity flowchart, indicated generally by the reference numeral 271. Each of the objects comprises a number between 1 and 52 which equates to the reference in the master chart and the link table of FIGS. 6 and 7 respectively and a letter L, M, D or S. “L” relates to the link code, “M” relates to master record, “D” relates to demand side of transaction and “S” relates to supply side of transaction. The arrows in the flowchart refer to the drill down direction and demonstrate the connectivity and how one can drill down from the conversion process object to the master record behind the expenses and objects. It is possible to extract the resource and cost detail related to a resource or cost from anywhere in the value chain.

For example, the object 273 (“30D/S) relates to the object relationship represented in “CostObjectHubLink” table by combining the object 275 (“18M”), relates to “Cost Object 4 in the master table and the object 277 (“29M”), a “Hub Location” using the process to “assign a cost object to a hub location”. The object 279 (“44D”) relates to the “assignment of a routing step to a cost object”, in this case cost object 4, and object 281 (“44S) also related to the “assignment of a routing step to a cost object”, however in this case it relates to the supply side and the Work Cell E is assigned to cost object 4 as per the link table with object relationships.

All of the resources and costs are placed into the hierarchical structure in this manner and have relationships with other resource object, cost objects, work cells and the like. In this way, it is possible to drill down from (for example) a particular cost or (for example) a particular work cell and extract the relationships of that particular cost or particular work cell and see what other objects are related to it. From this, it is possible to move to a higher or lower level of abstraction and obtain the required detail and information for a particular given task.

For example, in the embodiment shown in FIGS. 9(a) and 9(b), there is illustrated the drill down from a conversion process object back through the value chain associated with the selected conversion process object. The queries that calculate the resource requirements and costs associated with these relationships are built around the structure shown in FIGS. 9(a) and 9(b). When at object cell 283 (“38D”), which relates to an “assign labour pool resource cell to a work cell” it is possible to see what the costs of the entire work cell are by tunnelling upwards to “Assign a Routing Step to a Raw Material Object” 287 (“43D”) or alternatively it is possible to tunnel down to resource object 285 (“9M”) based on the queries linked to these object relationships.

Referring to FIGS. 10(a) and 10(b) of the drawings, there is shown a flow diagram indicative of a drill down process carried out by the tool according to the present invention. In the present example, the flow diagram is representative of the market channel gross profit drill down for an airline, indicated by the reference numeral 301. The drill down has, in this instance, ten levels. Each level provides more detail than the last. The first level 303 provides a gross profit summary. The second level 305 provides a gross profit forecast by market channel. The third level 307 provides a gross profit forecast by market channel hub locations. The fourth level 309 provides a gross profit forecast by hub location summary. The fifth level 311 provides a gross profit forecast by hub location flight summary. The sixth level 313 provides a gross profit forecast by hub location selected flight summary. The seventh level 315 provides a gross profit forecast by hub location selected flight summary by seat. The eighth level 317 provides a gross profit forecast by hub location selected flight detail by seat. The ninth level 319 provides a gross profit forecast by hub location selected flight value add cost summary by seat and the tenth level 321 provides a gross profit forecast by hub location selected flight value-add cost detail by seat. By implementing this process, it is possible for the business manager to drill down through all the records to determine the route cause of a loss making activity and provide them with the appropriate knowledge to tackle the problem.

The purpose of the following reports and drill down is to demonstrate the capability of the invention and is not intended to prescribe or restrict the scope or scale of the report structure. Three drilldown reports are provided as illustrated by FIGS. 11, FIG. 12 and FIG. 13. All reports are extracted from a common data set. Each report serves different needs from within the same organisation and demonstrates how this enterprise planning tool exceeds the capability of existing planning tools. The scope of the data set spans complex relationships between different market channels that are comprised of hub locations located in different jurisdictions and therefore exposed to different currency, pricing and price change. This data set also contains complex relationships between objects that originate from different hub locations and are combined to serve the needs of flight routes that operate from with a single market channel.

The scope and capability of the present invention is unparalleled as evidenced by the following figures, furthermore, this is executed in a seamless and transparent way that the user is more focused on what is automatically revealed as the user navigates between the different levels. The purpose of FIG. 11 is to provide an insight into profitability by market channel, hub location and flights and services. Throughout this report the user can seamlessly navigate between cost and profitability stated on both a forward looking basis for cost to economic cost and at a click of a mouse button answers are automatically provided to explain the root cause attributed to the cost of capital drivers. FIG. 11 enables management to understand profitability and root cause at a level that is unparalleled.

FIG. 12 is derived from the same data set, the focus for this report is to provide insight into the profit and loss performance from the perspective of continuous process improvement, for this reason the cost and profitability is stated inclusive of cost of capital. This report is used as a continuous process improvement tool whereby separate projects are established off-line for the purpose of change management. The purpose of this report in this context is to identify opportunities to drive improvement and to plan for and monitor change as part of the rolling forecast and budget cycle. This concept and integration as part of the rolling forecasting cycle is unparalleled.

FIG. 13 is based on cost exclusive of cost of capital. This report allows the user to drilldown through profit and loss summaries for market channels, hub locations, flights and services, also to drill down to resource cells that comprise the cost centres used for organisational reporting, also to reveal where resource imbalance occurs at both an organisational and resource level. The scope of this report also exceeds the capability of known enterprise planning tools.

Each of the following reports comprises multiple levels representing just one of many drill down paths that the user can navigate through. At each level the user can branch away from the route as represented in this example. The following example would be used to gain insight into the underlying winners and losers both in terms of historically stated cost and cost adjusted for cost of capital. The data used in this example is from the perspective of a user looking ahead from 2007 to 2008 based on the latest forecast data. Each report is extracted from a common data set, links can be made between the FIGS. 11, 12 and 13, if required in order to allow the user to navigate between these different perspectives where appropriate.

Referring to FIGS. 11(a) to 11(i) inclusive, there are shown a plurality of screen shots of the information returned to the user from the various levels 403-417 of the drill down process.

The purpose of the following screenshots (11(a)-11(j)) is to demonstrate the drill down capability of the tool according to the present invention. This example is based on an airline company that operates from a couple of regions, described as market channels and hubs located within each market channel from which passenger flight services are provided. The enterprise planning tool makes possible the level of connectivity between objects such that configuration of analytical reports, whether executed from a search command or drill down as in the following example, offers an unparalleled level of flexibility based on the object relationships. The complexity of the underlying data configuration is transparent and the navigation from one level to the next is executed seamlessly from a single data source. This example combines the resource and cost structure for resources located in different countries that serve the same flight needs, this principle could be applied equally to a company that manufactures a product in China, ships the product to Holland for final configuration prior to distribution of the product throughout Europe.

The level of connectivity offered by this invention extends beyond object relationships to multi-dimensional relationships such as price change, currency rate change and cost of capital. For the purpose of clarity the following example is based on a drill down from gross profit that includes both forecast cost and forecast cost adjusted for cost of capital. Also included in this report, but not included in the drill down path chosen for this example, is non financial data such as flight load factors, passenger loading and the like. The following report could be extended, if required, to branch from gross profit into a conventional profit and loss format, process cost, cost centres and resource cells level of detail and to the underlying accounting policies and assumptions on which expenses were configured. Reports can be modelled, standardised and executed in a seamless way that is designed for the particular needs. The drill down demonstrates the connectivity between different object relationships that is required in order to make this possible. Also, the following drill down from the gross profit summary to the identification of the root cause for the performance problem can be revealed in 45 seconds. All changes are processed prior to the execution of this report in order that the data set on which these reports are based is the current version.

The purpose of the following reports and drill down is to demonstrate the capability of the invention and is not intended to prescribe or restrict the scope or scale of the report structure. The following comprises nine levels representing just one of many drill down paths that the user can navigate through. At each level the user can branch away from the route as represented in this example. The following example would be used to gain insight into the underlying winners and losers both in terms of historically stated cost and cost adjusted for cost of capital. The data used in this example is from the perspective of a user looking ahead from 2007 to 2008 based on the latest forecast data.

Referring to FIG. 11(a), this screenshot 401 shows a report that is obtained by the selection of a period 1 from which the user can drill down by selecting the cost of capital to review the affect of each cost of capital driver to explain the difference between gross and economic profit, or alternatively by selecting the gross profit can drill down to review the gross profit source. In the case of this example the drill down to level 2, as shown in FIG. 11(b) is based on selecting the gross profit drill down option, the user selects this option in order to reveal performance by market channel, in the case of this example an airline company might want to reveal what the overall performance was for the European, North American, South American regions and the like. The user selects the gross profit drill down option by simply selecting the header using a pointing or other device known in the art in the known manner.

FIG. 11(b) comprises a screenshot 403 that reveals performance based on region. The user has three drill down options from this page, the user can drill down from the cost of capital to review the root cause by region, drill down from the gross profit option to review the performance by flight route within the selected region or in the case of this example, from the select a market channel, to drill down to review performance by hub location within the selected region. The user has selected Channel 1 in order to understand what the performance was for each of the centres at which resources are located to support Channel 1 operational requirements and is directed to level 3 as represented by FIG. 11(c).

In FIG. 11(c) there is shown a screenshot 405 showing the gross profit forecast by market channel hub location. By drilling down to this level it is revealed that the least profitable hub location based on both a forecast cost and economic cost bases is Luton Airport. The user has two drill down options from this page, from the cost of capital the user can drill down for a selected hub location to review the root cause for the difference between forecast and economic profit for the selected hub location. Alternatively the user may select the gross profit option, as in the case of this example for Luton airport gross profit in order to drill down to level 4 to reveal the impact on profitability from both utilized and under utilized resources as represented in FIG. 11(d).

In FIG. 11(d), there is shown a screenshot 407. By drilling down to this level it is revealed that under-utilization of resources located at Luton Airport account for 47% of the loss and the balance of the loss is attributed to flights and related services. The user has four drill down options from this page, for wasted resources the user can drilldown from the cost of capital in order to review the root cause for the cost of capital attributed to wasted resources or from the gross profit to review the root cause based on forecast cost to explain the source for the wasted resources; alternatively the user can execute a similar drill down to review the cost of capital and forecast gross profit for all flights that originate from, in the case of this example, the Luton hub location. From the wasted resources gross profit drill down the source for under utilization detail may be reviewed. Based on this example the forecast under utilization of resources warrants further consideration in order to determine how utilization may be increased through special promotions or failing this to consider reduction in the number of aircraft in service in order to drive cost reduction. In the case of the present example, the user wants to understand the performance of the individual flights operating from the resources located in the Luton hub location. By selecting the drilldown option for the flight gross profit the user is directed to level 5 as represented by FIG. 11(e). Note that the invention allows resources located in different hubs to be assigned to the same flight route. This is made possible by the object relationship configuration.

In FIG. 11(e), there is shown a screenshot 409 representative of the detail in level four in which it is revealed that flight AB—123, Cork—Luton accounts for [symbol] 146,734 or 49% of the loss from flight and related services. The user has three drill down options from this page, by selecting a cost object the user can drill down to review non-financial data, such as the loading factor, number of passengers and average ticket price for this flight for the selected flight. This also reveals the lost revenue where the load factor is lower than the criteria set for the route. The next drill down option is to select the cost of capital for a cost object in order to review the difference between forecast and economic profit. In the case of this example, the user selects the third option to review the source of the gross profit for the selected flight from the gross profit for flight AB—123 and is directed to level 6 as illustrated by FIG. 11(f).

Referring to FIG. 11(f), there is shown a screenshot 411 representative of the detail in level 5 in which by drilling down to this level it is revealed that the revenue generating services that are excluded from the ticket price, such as check-in, on-board entertainment and the like returned a profit of [symbol] 15,491 thereby revealing a loss of [symbol] 162,225 attributed to the ticketed portion of the flight revenue. The user has four drill down options from this page, for misc. services the user can drill down from the cost of capital in order to review the difference between forecast and economic profit or from the gross profit to review the profit and loss summary for the misc. services; alternatively in order to review the financial performance for the ticketed portion of the flight the user can select the cost of capital in order to review the difference between forecast and economic profit and in the case of this example from the gross profit to review the profit and loss extract report for this loss and is directed to level 7, as illustrated by the screenshot 413 in FIG. 11(g).

The screenshot 413 in FIG. 11(g) reveals that the ticketed portion of the revenue was insufficient to cover the value-add costs the result of which is a loss of [symbol] 117,072 before non value-add costs. This loss after value-add costs prompts immediate action to determine how the value-add costs which should represent costs that a passenger would be willing to pay for are not recovered in the ticket price. The user has eight drill down options from this page, in summary the scope of this includes revenue, value-add cost, non value-add type 1, non value-add type 2 and cost of capital. There are two drill down options from each of the value-add and non value-add options. In the case of this example the user selects the Value-add cost option and is directed to level 8, as represented in FIG. 11(h), reveals an analysis of the value-add costs based on each activity and segment of the service provided and included in the ticket price.

The screenshot 415 in FIG. 11(h) reveals that the costs related to the transfer of baggage to despatch are very high relative to other baggage handling costs, this warrants further investigation which is outside the scope of this example whereby the user can drilldown into the bill of resources related to this activity in order to investigate the process time and resource costs for this activity. The user has two drill down options from this page, one relates to business process cost driver detail and the other, as indicated as non-applicable under the business process heading, flight cost driver detail. In the case of this example the user has selected the cruising activity in order to reveal the operational and resource cost composition for this activity and is directed to level 9, as illustrated by screenshot 417 in FIG. 11(i).

The screenshot 417 in FIG. 11(i) reveals both resource and activity based costs that comprise the total cruising cost. Further drilldown from this level which is outside the scope of this example reveals the composition of the resources, such as the number of crew and fuel consumption rate and inflation related to the activity based costs.

It will be understood from the foregoing that by being able to drill down through the level of detail it is possible to provide an enterprise planning tool that will provide the manager with more accurate and useful information that will allow them to make more informed decisions. This capability is made possible by the structure of the enterprise planning tool in that it comprises a plurality of objects each having a plurality of attributes, and the fact that the interconnectivity of the objects through their relationships allows for an effective and efficient drill down to the route cause of a problem. This was not possible with the existing methods and systems. For the purpose of explaining the scope of the drill down options that is a standard feature of these reports these options where explained in detail for FIG. 11 so that as the drill down options relate to FIGS. 12 and 13 a more general indication of the scope of the drill down capability is provided instead.

Referring to FIG. 12(a), this screenshot 501 shows a report that is obtained by the selection of period 1 in which the user can review a profit summary that focuses on the impact of value-add and non value-add costs on overall performance for the selected period. The drilldown to level 2 as shown in FIG. 12(b) is based on selecting the Value-add cost option. The user selects this option in order to reveal a summary of the value-add costs by category in order to understand the distribution of cost according to each category. When the user has completed the drilldown for value-add costs, the user will return to screenshot 501 in order to drill down for non value-add cost.

FIG. 12(b) comprises a screenshot 503 to reveal the composition of the value-add costs according to the following categories; Resource cost which is derived from the utilization of internal resources; activity based expenses which is representative of the services provided from external sources, the cost for which is recovered from the product or service price; and finally is the activity based expenses the cost for which is passed onto a customer or passenger inclusive of a profit margin. Normally the user would drill down from each of these categories in order to reveal the source of each value-add cost and determine if there is an opportunity to reduce the cost and implement as part of the continuous process improvement program, in the case of this example the drilldown option selected is “resource cost”. From the selection of this drilldown option to level 3 as shown in FIG. 12(c) the user can review a list of the cost drivers or otherwise referred to as tasks or activities, in descending order, that comprise the total value select for resource cost in level 2.

FIG. 12(c) comprises a screenshot 505 to reveal the composition of the total value-add resource cost as represented in level 3. This list comprises the tasks and activities listed in descending order, based on resource cost. Normally the user will drilldown for each of the cost drivers in order to reveal the source of the demand for the resource requirement. The objective of this drilldown is to determine how best to plan for future cost reduction by inclusion of these tasks in the continuous process improvement program. In the case of this example the user selects the cruising activity for all flights, from the selection of this drilldown option to level 4 as shown in FIG. 12 (d), the user can review according to each flight serviced from its hub location the resource cost attributed to this activity.

FIG. 12 (d) comprises a screenshot 507 to reveal the cruising resource cost for each flight according to its hub location. From this report and outside the scope of this example, the user can drilldown to review the process time and resources that comprise the costs attributed to the cruising activity for each flight. Because this drilldown is based on the economic cost the user is able to review the composition of the cost of capital that is attributed to this activity. Based on this understanding of the root cause attributed to the cost of the cruising activity, the user is now ready to assign a plan of action across all sources for this activity. Such a plan of action may include components that are generic to all and customised for others, the objective of this is that the change that is brought about by this review process will drive change to cause a reduction in value-add cost and overall improvement in value-add margin. On completion of the review of value-add resource costs the user would normally return to screenshot 503 in order to repeat a similar process for the remaining value-add cost categories. In the case of this example the user returns to FIG. 12(a) as illustrated by screenshot to drilldown from the non value-add option.

The second pass from FIG. 12a), which comprises screenshot 501 is to select the non value-add option in order to direct the user to level 2b, as shown in FIG. 12 (e). The user selects this option in order to reveal a summary of the non value-add costs by category in order to understand the distribution of cost according to each category.

FIG. 12(e) comprises a screenshot 509 to reveal the composition of the non value-add costs according to the following categories; Non value-add type 1 cost which represents non value-add costs that are essential for the purpose of the processes that these support in the short to medium term; Non value-add type 2 cost which represents the non value-add activities that can not be changed in the short and medium term, but can be planned for change in the longer term; Resource Imbalance is the excess of the supply of resources provided from internal resources and the demand for such; Inactive resources refers to those resources that are currently obsolete, but because these have not been disposed of, continue to drive cost; activity based expenses which is representative of the services provided from external sources, the cost for which is not normally recovered in any form from the customer or if charged to the customer will eventually cause a customer to seek an alternative source that is more competitive.

Normally the user would drill down from each of these categories in order to reveal the source of each non value-add cost and determine if there is an opportunity to reduce the cost and implement as part of the continuous process improvement program, in the case of this example the drilldown option selected is “Non Value-add type 1”. From the selection of this drilldown option to level 3a as shown in FIG. 12(f) the user can review a list of activities, in descending order, that comprise the total value selected for non value-add type 1 cost in level 2a.

FIG. 12(f) comprises a screenshot 511 to reveal in descending order of cost those activities that comprise the non value-add category selected from level 2a. Normally the user will drilldown for each of the listed activities in order to reveal the root cause for the cost, in the case of this example the re-fuelling activity option is selected in order to direct the user to level 4a, as shown in FIG. 12(g). FIG. 12(g) comprises a screenshot 513, the user selects this option in order to reveal the root cause, that is, the flights according to their hub location that are responsible for driving the re-fuelling costs as detailed in level 3a. The objective of this review is to determine in the short to medium term how the costs associated with such activities can be reduced or eliminated. The result of this review is to include the planned change in the continuous process improvement program. In the case of this example re-fuelling cannot be eliminated, however, refuelling if planned to run concurrently with another activity, for example such as during the time between flights, will result in a reduction in the total cycle time associated with a flight and therefore the elimination of the cost associated with this activity will be achieved.

Referring to FIG. 13(a), this screenshot 601 shows a report that is obtained by the selection of period 1 in which the user can review a traditional profit and loss summary based on cost and revenue that excludes cost of capital. There are eleven drilldown options from this report. In the case of this example three drilldown options are selected to demonstrate the scope from the drilldown, two relate to General Overheads and the third relates to Gross Profit. Two drilldown options for general overheads is provided below in order to demonstrate the difference in the scope and application of this information. In the case of this example the first drilldown option selected is for General Overheads in which the user is directed to level 2, as illustrated by FIG. 13(b). The user selects this option in order to reveal a detailed list of the line item expenses that comprise the total general overhead spend.

FIG. 13(b) comprises a screenshot 603 that details the line item expense detail that comprises the summary level expense as represented in Level 1. The purpose of this report is to provide insight into the type and magnitude of the individual expenses that comprise general overheads. Rather than providing further drilldown from this report down to market channel, hub location, cost centre and resource cell level, drilldown to these levels is accessed from the spend field in FIGS. 13(c), 13(d), 13(e) and 13(f) which in this case the drilldown is selected from the cost centre. Furthermore, in the case of this example, the screenshots for these drilldown options is not provided as the format is a repeat of the format as presented for FIG. 13(b). After review of FIG. 13(b) the user returns to FIG. 13(a) in order to continue the drilldown for general overheads in order to reveal the general overhead spend by market channel. The second pass from FIG. 13(a) which comprises screenshot 601, is to select the general overhead header name in order to direct the user to Level 2a. The drilldown to Level 2a as shown in FIG. 13(c) is selected in order to reveal the general overhead spend by market channel.

FIG. 13(c) comprises a screenshot 605 to reveal the composition of the total general overhead spend by market channel, in the case of this example there is only one market channel that comprises general overheads as detailed in level 1. In the case of this example the user selects the market channel drill option and is directed to Level 3a as shown in FIG. 13(d). This option is selected in order to reveal the market channel general overhead spend by hub located within the selected market channel.

FIG. 13(d) comprises a screenshot 607 to reveal the composition of the general overhead spend for market channel 1 by hub location as selected in Level 2a. This report presents both the general overhead spend by hub location but also the general overhead spend relative to the revenue attributed to flights operating from each hub. Normally the user may drilldown for each hub location in order to reveal general overhead spend detail by cost centre located within the selected hub location, in the case of this example the user selects the Luton Airport and is directed to Level 4a as shown in FIG. 13(e).

FIG. 13(e) comprises a screenshot 609 to reveal the composition of the general overhead for the Luton Airport as selected in Level 3a. This report lists the general overhead spend by cost centre located at Luton Airport. Normally the user will drill down for each cost centre in order to reveal the general overhead spend detail for each cost centre, in the case of this example the user selects the cost centre Luton—Crews and is directed to Level 5a as shown in FIG. 13(f).

FIG. 13(f) comprises a screenshot 611 to reveal the composition by expense group for the Luton—Crews cost centre general overheads. This report lists the expense groups listed in descending order in order that the user may select an expense group as required and is directed to Level 6a as shown in FIG. 13(g).

FIG. 13(g) comprises a screenshot 613 to reveal the composition of the expense group selected from level 5a by expense line item. This reports lists the expense line item spend in descending order in order that the user may select an expense item as required and is directed to level 7a as shown in FIG. 13(h).

FIG. 13(h) comprises screenshot 615 to reveal the composition of the line item expense selected from level 6a. This report lists the composition of the selected line item expense by resource object that drives the expense requirement. In order to understand the scope of other expenses applicable to a resource object the user selects a resource object and is directed to level 8a as shown in FIG. 13(i).

FIG. 13(i) comprises a screenshot 617 to reveal details of other non payroll expenses that are applicable to the resource object selected in Level 7a. The expense details listed of each line item expense applicable to the selected resource object includes the lifecycle for the expense, the accounting policy, expense frequency and period allocation method applied to the expense, amongst others. On completion of the general overhead drill down the user may return to FIG. 13(a) to select any of the other 10 drilldown options, in the case of this example the user returns to FIG. 13(a) to select the gross profit drilldown option.

The third pass from FIG. 13(a), which comprises screenshot 601, the user selects the gross profit option and is directed to level 2b, as shown in FIG. 13(j). The user selects this option in order to reveal the profit and loss account summary by market channel.

FIG. 13(j) comprises screenshot 619 to reveal the profit and loss account summary by market channel. Normally the user will drilldown for each market channel as required, in the case of this example the user selects Market channel 1 and is directed to Level 3b, as shown in FIG. 13(k) to reveal the profit and loss summary for the hub location that comprise the selected market channel.

FIG. 13(k) comprises a screenshot 621 to reveal the profit and loss account summary by hub location within the market channel selected in level 2b. Normally the user will drilldown for each hub location, in the case of this example the user selects the Luton Airport and is directed to Level 4b, as shown by FIG. 13(L). The user makes this selection in order to reveal the profit and loss by flights that operate from Luton Airport and resource imbalance associated with the location.

FIG. 13(l) comprises a screenshot 623 to reveal the profit and loss summary by flight that operates from the location selected in Level 3b. Additional drilldowns, not revealed in this example allow the user to drill down to the cost centre and resource cell cost detail associated with each hub location profit and loss summary. In the case of this example the user selects resource imbalance and is directed to level 5b, as shown in FIG. 13(m) to reveal a summary of the resource imbalance for the selected hub location.

FIG. 13(m) comprises screenshot 625 to reveal a summary of the total overhead costs assigned to flights and services that operate from the selected hub location in Level 4b and the remaining resource cost that represents the excess of resource supply over demand. Normally the user will drilldown for the resource imbalance by overhead category to reveal the resource imbalance by cost centre in the case of this example the user selects the resource imbalance for the general overhead category and is directed to Level 6b, as shown by FIG. 13(n).

FIG. 13(n) comprises screenshot 627 to reveal the resource imbalance by cost centre. Normally the user will drilldown for each cost centre in order to reveal the resource imbalance for the resource cells that comprise the selected cost centre, in the case of this example the user selects the Luton—Crews cost centre and is directed to Level 7b, as shown by FIG. 13(o) to reveal the resource imbalance for the resource cells that comprise the selected cost centre.

FIG. 13(o) comprises screenshot 629 to reveal resource imbalance detail by resource cell for the cost centre selected in Level 6b. This is the lowest level of detail that resource imbalance can be measured, this provides management with the insight required to review various strategies for addressing and driving change at this level to improve overall profitability.

In addition to the above, there are a number of particularly advantageous aspects of the present invention that warrant further mention, namely: 1) Resource structure; 2) Resource hierarchy; 3) Time dimensions; 4) Expense attributes; 5) Cost dimensions; 6) Connectivity and pull demand; 7) Cost drivers; 8) Utilization method; 9) Resource cost configuration; 10) Routing yield; 11) Object cost configuration; 12) Procurement burden; 13) Resource Imbalance; 14) Cost of capital; and 15) Cloning. Below are some detailed descriptions of each of these advantageous aspects.

### 1) Resource Structure

This aspect of the system refers to how resources are added and organised within the system structure. Traditional historical accounts and financial plans are organised to reflect the organisational reporting requirements, such as cost centres and departments. The resource structure applied to this enterprise planning tool provides a much more flexible structure for the following reasons:

Individual resources, referred to as “Resource Objects” are arranged in resource cells. Resource cells are the lowest level of configuration for the grouping of resource objects. The criterion for the assignment of a resource object to a resource cell is that all of the resource objects arranged in a resource cell collectively function as a single unit. The system allows for the assignment of the same resource cell to one or more work cells. A work cell is a system location that may or may not be the same as a physical location whereby resources are arranged for the specific requirements of a process, such as a flight. A flight is a very good example of the flexibility as this allows the user to configure resources in whatever way required for the particular resource need. A flight can be represented as a single work cell that comprises resources from different resource cells such as the aircraft, and the different labour pools from which each of the different types of crew members might be drawn.

The enterprise planning tool handles the assignment of resources to a work cell for labour pool and non labour pool resource cells differently. The labour pool provides flexibility for managing the assignment of labour that is not required in its entirety from the pool but only a fixed number of the total resources in the pool is required for one assignment and maybe a different number is required for another assignment. An example of this is a pool of pilots who are all certified to operate a range of aircraft, if the flight operator has the flexibility to assign pilots to one flight route for a period of time and a different route for another period of time, then this requirement can be reflected by grouping the pilots in the same labour pool and by assigning the number required for the flight rather than the specific pilots assigned.

The labour pool resource cell structure also supports the assignment of overtime to a particular work cell and flight combination, so for example if overtime is required on a particular route the system will not only assign the overtime to the flight but will also backflush the overtime to the labour pool resource cells from which the crew was assigned. The enterprise planning tool according to the invention allows the user to assign a work cell to a bill of resources more than once and controls the sequence in which the costs are applied for the work cell by enabling the user to sequence the order in which resources from each work cell are applied in the fulfilment of the resource needs of an object. Capacity utilization is calculated for each work cell and back flushed to the resource cell from which these are comprised. The enterprise planning tool also supports the selection of an individual resource object from a resource cell for assignment to a work cell.

The benefits of this can be summarised as follows: There is total flexibility for the configuration of resources in a single work cell. The user can assign a resource cell or part of a resource cell to more that one work cell. The work cells hours utilized are automatically back flushed to the underlying resource cells. A capacity constraint restriction applicable to resource cells is automatically applied to the underlying resource objects. This supports the granularity of data by creating a link between the objects to which resources are assigned and the specific expenses and origins of these expenses associated with the underlying resources.

### 2) Resource Hierarchy

The function of the resource hierarchy is to control the order in which resources and resource cost flow from resource cells to resource objects and business and conversion process objects. The resource hierarchy comprises the following levels, 1) Infrastructure; 2) Service; 3) Support; and 4) Activity. There are two processes applied in the execution of resource fulfilment: resource cost configuration and object cost configuration.

Resource cost configuration is the first of two processes executed; the function of this process is the resource fulfilment of all resource objects. There are two transactions applied in the execution of this process, that is, internal resource expenses and resource object business processes. On completion of this process the resource configuration is complete and the resources are ready to fulfil process object resource needs. Resource cost configuration is executed from resources located in the first three levels of the resource hierarchy to resource objects located in all four levels.

Object cost configuration is the second process and relates to the fulfilment of the resource needs driven by products and services and the demand that these drive for business processes. Business process resource requirements are fulfilled from resources located in the support level in the resource hierarchy and conversion process object requirements are fulfilled from resources located in the activity level.

The sequence in which transactions are executed within the resource hierarchy is controlled by sequence number ranges that are unique to each level and transaction combination. In the case of the resource cost configuration the user is required to sequence the order for each transaction within the range controlled by the system. In the case of object cost configuration the sequence numbers set by the software is sufficient for the execution of this process.

The objective of this structure is to ensure that the flow of resources as represented by the software is a true representation of the physical flow and resource requirements fulfilment. The execution of these transactions is dependent on the object relationship and the link between these objects that enable the user to drill down from a configured object, such as a product or service to all the resources that were consumed across the resource hierarchy.

The sequence in which resource fulfilment is executed is controlled at two levels, firstly by transaction type sequence ranges set for each of the levels and the second which is restricted to the infrastructure and service. The user is enabled to assign the order of execution within the range controlled by the enterprise planning tool. The purpose for this control is so that resource fulfilment cascades in a predefined order whereby resource needs are fulfilled from within the same level before cascading to the next level below the level where the resource is located and then down to the next level if required. Resource fulfilment can never be executed to a level higher in the resource hierarchy than where the resource is located. Resource fulfilment must always cascade downwards.

The movement of resource cost from the infrastructure and service level is referred to as “Resource Cost Configuration” and the movement of cost from the support to the activity level and within the activity level is referred to as “Object Cost Configuration”. Costs originating from any level in the resource hierarchy that do not flow to a customer are regarded as “Resource Imbalance”.

### 3) Time Dimensions

Each object has its own time dimension, a start and end date that represents the object life cycle. With the exception of system locations such as resource cells and work cells, object time dimension for an object can be edited. When one object is assigned to another to form an object relationship a test is performed to determine if both objects share a common time dimension. A common time dimension is a period of time that is automatically assigned to the life of the object relationship. The user interface will not allow an object relationship to be formed unless there is a common time dimension.

Should the time dimension applicable to either of the objects to the object relationship be changed the system will automatically re-assign a new time dimension to the object relationship. However, if the outcome of changes to the object time dimensions does not return a valid common time dimension for the object relationship then the system will automatically de-activate the relationship. Finally, if subsequent to de-activation a change results in the re-establishment of a common time dimension, then the system will automatically reactivate the object relationship.

The significance and benefit of this process is that a change to an object's time dimension will automatically update and change the activation and common time dimension of object relationships throughout the database wherever that object is part of different object relationships.

For example, an extension to the time dimension for a resource object will result in an automatic re-evaluation of the object relationships that the resource object has for the revised duration of the common time dimension. An extension to the time dimensions for object relationships results in the automatic assignment of cost associated with these for the extended common time dimension. Likewise, a change that reduces the time dimension for an object could result in costs resulting from object relationships from being automatically deleted.

It is important to note that only object time dimension changes that result in change to the object relationship common time dimension may impact on the number of cost records created, where the object relationship common time dimension is not affected by a change to one or both of the object's time dimensions then there cannot be a resulting change to the cost records. Object relationship common time dimension that include incomplete periods are represented by a factor that is applied to the cost for the relevant period in order to automatically adjust for that part of the period that the cost record is not applicable.

### 4) Expense Attributes

The purpose of expense attributes is to define certain characteristics that determine how an expense record is processed. The attributes that affect how an expense is processed are 1) Expense Frequency; 2) Accounting Policy; 3) Period Allocation Method; and 4) Expenses Status.

The expense frequency refers to the frequency at which an expense occurs, such as quarterly, bi-annual or annual. This is not the same as expense recognition which is dependent on the combination of expense frequency, accounting policy applied to the expense, period allocation method and object relationship time dimension. The benefit of expense frequency attribute is that subject to the time dimension of the resulting object relationship between the expense and the object to which it is assigned, the expense will be automatically applied to the object relationship for the period as defined by the object relationship time dimension.

The accounting policy defines an expense as one of the following: 1) Accrual; 2) Prepayment; 3) Billing; and 4) Cashflow.

The period allocation is applicable to the accrual and prepayment accounting policies. Period allocation refers to the method that is applied to spread an accrued or prepaid expense. The period allocation methods available for the enterprise planning tool are: 1) Gross days; 2) Net days; and 3) Even. Based on the methodology applied, the enterprise planning tool will distribute each expense cycle based on the assigned criterion between the start and end recognition dates applicable to each expense cycle. In the case of the even method the expense will be spread evenly for complete months and where the start and end recognition dates are not the 1^{st} and last day of the periods, respectively, the even spread value for a complete period is spread between the two partial periods pro-rate to the gross days applicable to each.

The expense status is used to distinguish between billable and non billable expenses, for example meals provided on a flight, the cost of which is covered by the ticket, is a non-billable expense. Check-in charged as additional to the ticket price is a billable expense. Based on the expense status attribute applicable to an expense the enterprise planning tool applies different processes to calculate the extended period cost and expense driven revenue where applicable.

In addition to the above, the enterprise planning tool automatically handles expense recognition based on the expense attribute assignment. Expense recognition is calculated relative to the object relationship. For accruals and prepayments the tool calculates the start and end recognition dates, applies the cost between these dates and then modifies the expense where the common time dimension for the object relationship is less that a complete expense cycle. The billing method is applied where it is sufficient to recognise and expense when incurred. The cashflow method is applied to recognise expenses when the liability is discharged.

There are numerous benefits to providing an enterprise planning tool with these features. First of all, the user interface allows the user to select an expense group, such as a car rental where the expense group has all of the attributes required to process the expense. The benefit of this is that the user does not need to be concerned about the accounting policy or period allocation spread mechanism, however the control over these is exercised by finance adding expense groups in order to ensure that expense recognition is reflected in a consistent way for given expenses. Both expense attributes and object relationship common time dimensions are processed automatically in determining expense recognition. Changes to either expense attributes or time dimensions will automatically result in revised cost by period and where applicable the revenue associated with a billable expense.

### 5) Cost Dimensions

Cost dimensions refer to the monetary value basis on which data is processed. Each of these dimensions serves different business needs and when integrated as part of the costing and planning tool extends the scope of the application beyond the bounds normally associated with such systems. The cost dimensions transform the system into a management tool that serves many needs. There are five cost dimensions: 1) Source currency; 2) Default currency; 3) Price change value; 4) Currency change; and 5) Cost of capital. The benefit of this is that the output from the tool can be interrogated or analysed from each of these perspectives. The enterprise management tool makes the requirements to derive this level of analytical capability very cost effective. All value based records are added to the system based on the source currency, cost of capital is assigned by year and price and currency rate change is forecast by period.

Examples of how this can be of benefit to the user are as follows: in relation to the source currency, the net requirements are provided by currency and the net requirements and risk are provided at a product or service level. In relation to the default currency, the spend based on default currency and prior to the application of price change provides a benchmark basis that may be used by management, such as a standard cost, target cost applied to all costs and revenue. In relation to price change value, this can be used as a management tool to measure and monitor the effectiveness of plans in meeting cost reduction expectations or simply as a means of measuring the change in the price basis for revenue and expenses since the start of the planning or forecasting cycle. In relation to currency change, this measures the change due to the difference between the annual default exchange rate and the forecast rate. By reviewing the extended currency change variance for one or more periods, management can easily monitor the overall impact of a mixed bag of currency exposure or by individual currency. In relation to cost of capital, the cost of capital is a hidden cost not normally visible, because the cost of capital is calculated for each record this can be viewed from many perspectives such as total economic profit down to the cost of capital associated with an under utilized resource.

### 6) Pull Demand and Connectivity

The connectivity that enables pull demand, drill down and makes analytics possible is dependent on a simple rule that all objects must be joined to at least one other object to form an object relationship. For each object relationship one object must represent the demand side of the relationship and the other object must represent the supply side of the relationship. With the exception of expenses and cost object conversion process objects all other objects have both demand and supply side to their relationships. Expenses are always represented as the supply side and cost object conversion process objects as the demand side of an object relationship. Expenses can be attached direct to a conversion process object as the combination of both satisfies the requirements for an object relationship. An example of which is an activity driven expense assigned directly to a product or service. All other monetary values that flow from expense to a conversion process object do so through various object relationships joined together to create a path from the various expense sources to each conversion process object that initiated the requirements as represented by the expenses. Likewise the business process requirements driven by a conversion process object and the resource requirements that these drive are also part of the same path that links these expenses to the conversion process object.

The enterprise planning tool functions as a pull system whereby activity associated with cost object conversion process objects drive demand for all of the objects and resources associated with these along the value-chain. Pull demand would not be possible without object relationships and the connectivity that links these to a single driver, that is, the activity associated with a conversion process object. The supply side of an object relationship is represented as a resource source whose output can be either time or non time based. The demand side of an object relationship is represented as a time or non time based resource requirement.

The resource requirement is expressed as the quantity of the resource provided from the supply side of the relationship. An example of this is an electricity generator that is the supply side of an object relationship the output from which is measured in terms of Kwh, the demand side of the relationship is an item of equipment that requires electricity to process the demand driven by a cost object conversion process object. The resource requirement for the item of equipment is measured in terms of a number of Kwh, the connectivity between the two objects allows the cost of resources to flow from the electricity generator to the equipment at the rate at which the equipment consumes the electricity.

Until initiated by a conversion process object activity, all costs are represented as resource imbalance. The conversion process object activity causes value to flow from the resources invested in the business to a customer. Demand that is initiated in anticipation of customer demand does not flow to the customer. The consumption of such resources represents a movement in resource imbalance from one location in the value chain to another, resource imbalance in this instance is represented as inventory.

Demand pull is a two stage process, 1) Resource cost configuration; and 2) Object cost configuration. Resource cost configuration refers to the scope and assignment of costs to resource objects prior to the execution of pull demand initiated from cost object conversion process objects. The objective is that the costs as represented by the fulfilment of a resource requirement that was initiated by a conversion process object is representative of the actual resources that were consumed by the resource prior to its consumption by another object. For example, building cost associated with a clean room or operating theatre should be inclusive of the specialised infrastructure required to enable it to function as intended. Equally, the cost of resources such as labour should be inclusive of all the costs incurred to make this resource available. Resource cost configuration is based on pull demand. In this case, the pull demand is initiated by the deployment of a resource and the recognition of the resources required, making this possible. Object cost configuration is initiated from pull demand that is initiated from a cost object conversion process object.

### 7) Cost Drivers

Cost drivers and their attributes play a role in the configuration of a business or a conversion process object. Cost drivers are the activities or tasks performed in the configuration of a business or conversion process object. Cost drivers provide a link between a work cell and the business or conversion process object in order to specify the basis on which the process object resource needs will be fulfilled from the work cell to which the cost driver was assigned.

The cost driver is one of two objects that is required for the configuration of a bill of resources, the other is the work cell. The bill of resources provides total flexibility for the configuration of resources for the fulfilment of object resource needs. The bill of resources can be configured from one or more resource cells as required for discrete and cross-functional processes respectively. The requirements for the configuration of a work cell are determined by the resource needs of the object to which these are assigned to the bill of resources. The focus of this section is the role of the cost driver in enabling the user to configure a bill of resources that is a reasonable and fair representation of the activities and resources consumed by both business and conversion process objects. Typically, when applied to activity based costing, the cost driver is a single dimensional object. An example of this is the number of calls made by a call centre.

Many of the leading experts in activity based costing and software applications argue that the user should keep the number of cost drivers to a minimum because this only adds complexity to the process. By intentionally restricting the number of cost drivers the accuracy for the outcome may be compromised. The cost driver configuration attribute assigned to the cost driver simplifies the process for adding cost drivers and offers the user unlimited opportunity to apply business reasons for determining the number of cost drivers that are applicable rather than allowing processing restrictions to determine this.

The attributes assigned to a cost driver are what determine how the resource fulfilment for a business or conversion process object is processed. The cost driver attributes are: 1) Value Type: 2) Process Type; 3) Driver Type; 4) Cost Driver Configuration; 5) Time Dimension; and 6) Input or output based.

At the most basic level, a value type assigns the value for a cost driver as value-add or non-value add. The user has flexibility to add as many value types to the value type library. The value type assigned at this stage is a default value and may be changed when the cost driver is assigned to a routing.

The process type is a configured attribute that describes a combination of system type and system process such as: 1) Business Process—Resource Object; 2) Business Process—Product; 3) Business Process—Raw Material Object; 4) Business Process—Passenger Based; 5) Conversion Process—Product; 6) Conversion Process—Raw Material Object; and 7) Conversion Process—Service (Passenger based). The assignment of the process type to a cost driver serves to restrict the objects of the same type to which a cost driver may be assigned.

There are two types of driver types: 1) Process Type; and 2) Activity Type. The assignment of a process type is restricted to a business process type to indicate that the lead-time applicable to the cost driver is fixed and not affected by the activity associated with the business process. The assignment of an activity type is applicable to both business and conversion process objects whereby the cost driver lead-time is applied to the activity related to the object.

Cost driver configuration refers to a system library that contains code related to each of the possible combination of attributes that defines the rules that are applied when a cost driver configuration is assigned to a cost driver. The advantage of cost driver configuration is that when adding a new cost driver the user only needs to assign a configuration type and the software will automatically execute the processing requirements based on the rules applied to the configuration. Also, the number of cost drivers that a user assigns to an object routing is restricted to the level of precision and granularity of data required. A cost driver configuration is comprised of the following combination of attributes: 1) Process Type; 2) Pack configuration; 3) Batch size; and 4) Sample size. With the exception of the process types each of the attributes is used as the basis for converting the lead-time related to a cost driver to an equivalent lead-time for the object to which the cost driver is assigned.

The process type is a configured attribute that describes a combination of system type and system process. The library of cost driver configurations is arranged according the process type in order that each configuration is unique to the process type that it is applicable to. This simplifies the selection of a cost driver configuration that is representative of the rules that apply to a cost driver when adding a new cost driver. Furthermore this simplifies the process for the assignment of a cost driver to a routing step for a process object because the scope of cost drivers made available to the user through the user interface is restricted to those cost drivers that share in common the same process type as the object.

The pack configuration differs from a batch size in that the pack configuration relates to different configurations for an object such as: 1) Unit; 2) Pack; 3) Line Item Count; and 4) Lot quantity. The lead-time applied to the cost driver for each pack configuration type is converted to an equivalent lead-time per unit of object by converting the pack configuration quantity (located in the object master record) to the number of items that this equates to, based on this quantity the cost driver lead-time is divided by the equivalent number of items and the batch size and multiplied by the sample size to calculate the lead-time rate that can be applied to all items processed. An example of this process is as follows,

| | |
|---|---|
| Item | Motherboard PCB |
| No. PCBs per bulk pack | 1000 |
| Batch Size per pallet | 10 Bulk Packs |
| Sample Size | 100% |
| Activity | Remove Pallet from truck |
| Leadtime | 5 Minutes |
| Total number of items | 10000 (Items per bulk pack multiplied |
| | by batch size) |
| Sample Size | 100% |
| Total Number of Items | 10000 |
| Leadtime per item | 0.03 Seconds |

Unit refers to an item such as a single printed circuit board. The pack refers to a quantity of items contained in pack or box. The bulk pack refers to the number of packs in a carton. The line item count is typically applied to business processes such as to indicate the number of line items per invoice or purchase order etc. The cost driver lead-time is also converted to a rate applicable to the object. The lot quantity is also typically applied to processes such as work order release in which case represents the quantity of a particular product that is released to production. It can also be used to represent the lot size basis for purchase order released in order that the total volume of material required can be converted to purchase orders which in turn are used to drive the business process requirements. When assigning a cost driver to a routing step the quantity related to the pack configuration is inherited from the object master record and may not be changed.

The batch size is used to indicate multiples of a pack configuration that the cost driver lead-time relates to. The default value set for a batch is one and can be adjusted to represent the quantity applicable when assigning a cost driver to a routing step. The sample size indicates the percentage of the underlying quantity applicable to a cost driver that the cost driver lead-time is applicable for. The time dimension is the default life cycle for the cost driver which can be edited within the bounds of the start and end dates set by the default range when assigned to a routing. The assignment of the input or output basis is used to automatically apply the volume relative to the routing step to the cost driver lead-time.

The benefit of the cost driver configuration and other attributes is that these make the process for the addition and application of a cost driver a very simple process. The addition and assignment of cost drivers need only be considered in the context of business needs. The user decides on the level of granularity that is appropriate.

### 8) Utilization Method

The granularity of data limits the extent to which data may be interrogated, analysed and from which conclusions may be drawn. The closer the level of granularity is to the actual attributes that cause change, the greater is our ability to more accurately reflect this in the processing and reporting of data. The utilization method applied in the process to assign resource cost is a true representation of the actual resources consumed, therefore where this is matched with equally representative resource cost the outcome of this process is an accurate representation of the resulting resource cost assignment and object cost.

The utilization method applied as the basis on which costs are assigned to an object as an alternative to the use of a cost rate is of significant importance. Notwithstanding the differences between the basis on which cost information is compiled, the utilization method delivers the level of granularity that reflects actual resource requirements whereas the cost rate condenses the underlying data into a single rate. The benefit of the utilization method goes beyond resource cost assignment and is discussed in the context of other items such as capacity constraint and cost of capital. Also, the utilization structure is simply one part of a complex process that links data throughout the value chain.

The following reviews the scope of the traditional method of applying cost rates and an example of the scope and depth of detail associated with the application of the utilization method. The standard approach applied to both traditional costing methods and activity based costing for the assignment of cost to an object is to multiply the quantity that represents activity associated with an object by the cost rate per unit of quantity. Cost rates may be expressed as a rate per hour or rate per activity such as per order processed where the total cost is divided by the total number of hours or number of orders processed to derive a cost rate per hour or order processed respectively.

The problem with the cost rate method is that the cost assignment is at a summary level therefore there is no insight into the source and scope of the origins of the cost passed to an object. As costs are assigned to an object along the value chain using the cost rate method visibility is lost beyond a summary detail level. The outcome of the cost rate method is also dependent on the assumptions made regarding capacity base, e.g., theoretical, practical or normal capacity. By applying the cost rate method any opportunity to drill down and analyse the underlying data has been foregone.

### EXAMPLE

| | Month 1 |
|---|---|
| Total cost assigned to Order Processing | 100,000 |
| Number of orders processed | 12,500 |
| Avg cost per order | 8 |

Cost is assigned to an object by multiplying the cost rate by the quantity of the object represented by the cost rate in order to calculate an object cost.

On the other hand, utilization is a measure that expresses the percentage of the resource capacity that is consumed by one or more objects. The resource for which the capacity is represented can be a discrete or a multi-functional resource. A discrete resource is a resource that comprises a single resource cell whose output has a single unit of measure. A multi-functional resource is a resource source consisting of one or more resource cells that may be combined in one or more work cells. Work cells are assigned to a bill of resources where these represent the routing steps from which the resources required for each task or activity is located. Activities or tasks are represented by cost drivers. The standard time required for the execution of a cost driver is expressed as the lead time applicable to the activity or task. In addition to applying the volume or number of times that a particular task is repeated, in order to determine the extended time required of the work cell resources, the extended work cell hours for each task may be adjusted for work cell downtime.

Although work cells are representative of physical locations, in the context of the enterprise planning tool software, these are virtual locations that are used as providing a link between an object demand and the resources required. The gross hours required of a work cell (extended lead time grossed up for work cell downtime) is converted to the gross hours required of the resources assigned to the work cell. The gross hours required of the resources is calculated by grossing up the work cell hours that the resources were assigned to by the downtime applicable to these resources. Although a resource may be assigned to one or more work cells, because resource cells can only be assigned to a work cell that shares in common the same process type, the resource cell capacity utilization that is driven from different work cells and by different object demand is combined in the same process in order to be able to extract the combined demand and therefore utilization for each of the resource cells. There is a separate query for each process type in order that all of the demand for each resource may be captured together. For each cost driver assignment assigned to a routing step the number of records will be increased by the number of resource assignments to each work cell. The output from the utilization query is then used as the basis for the assignment of the resource costs to the objects that are responsible for the resource demand.

### 9) Resource Cost Configuration

The purpose of this process is to execute the resource object cost-roll up from expense attributes and resource requirements based on the object relationship. Resource object cost roll-up is based on the source currency cost of resources and expenses prior to adjustment for price change. The objective is that the cost of resources passed from a resource cell to resource objects is a reasonable representation of the resource that will ultimately be passed on to business and conversion process objects when applied in the fulfilment of their resource requirements. There are two significant data configuration processes in arriving at a completed resource object cost roll-up which are outlined below.

### 9.1) Resource Cost Configuration_1

The purpose of this process is to convert resource object costs from expense attributes to extended period costs. All costs at this stage are stated in source currency and prior to price change. The scope of this process is as follows: 1) Rebuild resource cell calendar to reflect changes to company calendar, gross, paid and unpaid shutdown days and overtime; 2) Rebuild depreciation and net book value to reflect any changes to resource objects, asset values, and the like; 3) Rebuild object relationship common time dimensions; and 4) Recalculate expense assignment values.

### 9.2) Resource Cost Configuration_2

The purpose of this process is to execute resource object resource requirements fulfilment from internal resources. Examples of this process is the subdivision and assignment of building costs to resource cells, the assignment of maintenance provided from internal resources and the assignment of internal resource object business processes such as payroll to labour resource objects. The execution of this process is dependent on the combination of the following processes: 1) Resource Hierarchy; and 2) Utilization Method

In relation to the resource hierarchy aspect, based on the sequence number assignment for internal resource expenses and resource object business processes the enterprise planning tool automatically rebuilds the sequencer table which is delivered to the code that manages the order in which resource cost assignment is executed.

In relation to the utilization method aspect, the resource cost assignment is based on the resources consumed by a resource object, expressed as a % of the capacity for the resource. In other words, the resource cell utilization which is applied to the monetary value of all the matching resource cell cost records. Each assignment results in the propagation of new records, copied from the resource source, that become part of the record set for the resource object. The monetary value of the resource source records are reduced accordingly in order to complete the transaction that represents the movement of cost from the resource source to an object. The order in which the user assigns the sequence number to each transaction should ensure that the resource requirements for all of the resource objects belonging to a resource cell are completed before assignment from the resource cell can be initiated. The same process is repeated by selecting the next sequence number to execute the transaction which moves cost progressively down the resource hierarchy until all transactions have been executed and the resource object cost configuration is completed. Each time resources are assigned from a resource cell, the monetary value of the resource cells records is reduced until the value remaining is zero or almost zero at which point the utilization for the resource cell has reached 100% and there is not more available capacity.

### 10) Routing Yield

The purpose of this process is to convert sales activity to input and output quantities for each routing step in a bill of resources. The reason for extracting input and output quantities by routing step is so that when assigning a cost driver to a routing the activity base applied to the cost driver as either input or output based can be automatically selected and applied based on the activity attribute included in the cost driver configuration. The input and output quantities are calculated by applying formulae derived from the routing yield and compounded yield.

### 10.1) Compounded Yield

The compounded yield, or first pass yield as it otherwise referred to as, is calculated

| Routing ID | YieldFactor | Input % | InputQuantity | OutputQuantity | CostObjectVolume | TTM |
|---|---|---|---|---|---|---|
| 20 | 80 | 0.1342177 | 1490.116 | 1192.093 | 200 | 70 |
| 21 | 80 | 0.1677722 | 1192.093 | 953.6743 | 200 | 70 |
| 22 | 80 | 0.2097152 | 953.6743 | 762.9395 | 200 | 70 |
| 23 | 80 | 0.262144 | 762.9395 | 610.3516 | 200 | 70 |
| 24 | 80 | 0.32768 | 610.3516 | 488.2813 | 200 | 70 |
| 25 | 80 | 0.4096 | 488.2813 | 390.625 | 200 | 70 |
| 26 | 80 | 0.512 | 390.625 | 312.5 | 200 | 70 |
| 27 | 80 | 0.64 | 312.5 | 250 | 200 | 70 |
| 28 | 80 | 0.8 | 250 | 200 | 200 | 70 |

by starting at the transfer title volume yield and multiplying 100% by the yield for that process, then for the routing step before that to multiply the compounded yield for the one just calculated by the routing yield for the current routing step. This process is repeated until the compounded yield has been calculated for all routing steps. This is illustrated by table 1 below:

### (TTM=Title Transfer Mark)

It can be seen from the above that Routing ID 20 Input yield is the compounded yield for the nine routing steps (20 to 28 inclusive) and is calculated by multiplying the yield factor of that routing step and the preceding eight routing steps as follows:

0.8*0.8*0.8*0.8*0.8*0.8*0.8*0.8*0.8=0.1342177

| | |
|---|---|
| Input quantity for routing 20 = title | 200 |
| transfer output = | |
| Divided by compounded yield, | 0.1342177 |
| Input Qty routing 20 | 1490.116 |
| Output from routing 20 = Input | 1490.116 |
| Multiplied by routing 2 yield | 0.80 |
| Routing 20 output | 1192.093 |

### 11) Object Cost Configuration

The purpose of this process is to execute the roll-up of business and conversion process objects based on resource requirement fulfilment from configured resource object cost structure (Resource Object Configuration process). The objective of this process is that cost of resources passed from resource objects to business and conversion process objects is a reasonable representation of the resources consumed. The level of accuracy is dependent on the accuracy of the resource object cost configuration, the level of detail as reflected in the business and conversion process object bill of resources and the scope of business processes assigned to form object relationships with the conversion process objects that these are dependent on. There are two significant data configuration processes in arriving at a completed business and conversion process cost roll-up which are outlined below:

### 11.1) Object Cost Configuration_1

The purpose of this process is to compute the utilization data that will be applied in the utilization method for the assignment of resource object costs to business and conversion process objects. The scope of this process is as follows: 1) Convert sales activity to input and output quantities by routing step; 2) Convert routing volume to raw material resource requirements; 3) Build cost object business process object utilization; 4) Build Raw material object business process object utilization; 5) Build Cost object business process resource cell utilization; and 6) Build Cost object conversion process resource cell utilization.

### 11.2) Object Cost Configuration_2

The purpose of this process is the fulfilment of business and conversion process object resource requirements. This process is similar to the “Resource Object Cost Configuration” process and is also dependent on the following processes: 1) Resource Hierarchy; and 2) Utilization Method.

In relation to the resource hierarchy, unlike resource object cost configuration there is no requirement for the user to assign sequence number for the execution of each of the following processes: 1) Raw material object business process assignment; 2) Raw material object conversion process assignment; 3) Cost Object business process assignment; and 4) Cost Object conversion process assignment. Each of the above processes is executed based on the sequence numbers set by the system to which the user does not have access to edit.

In relation to the utilization method, because resource demand is pull based the sales activity that is used to drive cost object conversion object utilization is backflushed using the output from the routing volume to convert the volume to both business and conversion process requirements which are then executed in the above sequence. This level of connectivity is made possible based on object relationships.

The following is the sequence and processes executed in deriving the completed object cost configuration:

Step 1) Raw Material business process assignment. Based on the business processes (see bill of resources) such as procurement, materials requirements, materials planning and control activity that are driven by activity required to support sales activity, these activities are converted to resource requirements which are fulfilled from the “Support” level resource cells located in the resource hierarchy. The assignment of resource cost is based on the utilization method.

Step 2) Raw material conversion process assignment. Based on the terms of trade for the purchase of raw materials, the bill of resources is configured to represent the movement of raw material from the title transfer to the release from the raw material warehouse to production. The resource requirements are fulfilled from the activity level of the resource hierarchy. The assignment of resource cost is based on the utilization method.

Step 3) Cost object business process assignment. This is a similar process to that applied to raw material object business processes. In this case, the activity is driven directly from the cost object conversion process requirements.

Step 4) Cost object conversion process. This is similar to the raw material object conversion process in that the scope is dependent on the conversion requirements for the object and the terms of sale.

The output from the object cost configuration is the assignment of resource object costs to the conversion process and all of the processes that this drives and the resulting resource object costs assigned to these processes. By means of the connectivity between each of these processes re Object Relationships” claim, the output for each of these processes can be linked together to extract the total resource object costs that can be attributed to a conversion process object and all of the processes and costs driven from this source.

### 12) Procurement Burden

The procurement burden refers to the costs incurred in the transfer of raw material from the vendor based on the terms of trade. The subject of this section is the configuration of procurement burden expenses and the automated process that builds the records associated with these expenses. A process similar to the following is applied for sales burden. Sales burden refers to the costs incurred from the time that a product is dispatched to the customer until title transfer to the customer occurs.

### 12.1) Terms of Trade Configuration

This process refers to the system configured costs related to each terms of trade that is available for assignment to a raw material object master record, such as ex works, F.O.B or C.I.F. C.I.F. refers to cost, insurance and freight and is a term used to indicate the cost that the seller is liable for and is therefore included in the sell price. F.O.B. refers to Free on-board which in this case means that the seller is liable for costs until the goods are loaded on-board ready for shipment.

The scope of this process is as follows: 1) Add an expense by country of origin, such as “Freight—Ex Vendor” associated with a country, in this case we will use China. 2) Configure all expenses applicable to a terms of trade associated with a country of origin, such as, Terms of Trade “Ex Works”—Expenses—1) Freight—Ex Vendor; 2) Freight Insurance—Ex Vendor; 3) Customs agents fees; and 4) Customs clearance fees.

Once the terms of trade have been configured by country of origin the terms are released to the user interface so that when the user adds a new raw material object and selects the country of origin, the terms of trade from which the user may select for assignment to the object are restricted to configured terms associated with the country selected.

### 12.2) Automated Bill of Resources

When a new raw material object is added, based on the terms of trade selected the bill of resources records applicable to the terms of trade costs will be automatically built, this includes to the following records: 1) Routings; 2) Cost Drivers; and 3) Expenses. When the raw material object is assigned to a bill of materials, the bill of resources associated with each raw material object will be automatically assigned to the new bill of materials added for a conversion process object.

The benefit of this process from the user's perspective is that it is totally automated once the user has added a raw material object. This process ensures that terms of trade expenses are applied consistently. All costs associated with terms of trade are linked to the cost of the parent conversion process object to which the raw material object is assigned.

### 13) Resource Imbalance

Resource imbalance is the residual value remaining as a wasted cost due to the excess of resource supply over demand. Although resource imbalance is derived from capacity utilization, the scope of the enterprise planning tool to resource imbalance and the insight that it provides from a profitability management perspective is far greater than that obtained from the more traditional application of this data.

The traditional approach is to measure capacity utilization and under-utilization for stand alone departments. Although this is valid from the perspective of the effectiveness of a single department, this does not go far enough for the purposes stated in the application in suit. Furthermore, the application of capacity utilization and under-utilization is traditionally restricted to processes directly applied in the manufacture of a product or service. Both accounting and costing systems do not provide the required level of connectivity between resources, the measurement of these dependencies and the ability to make an accurate representation of the cost of the resources consumed. Therefore, it is beyond the scope of current accounting and costing practices and enterprise management tools based on those systems to represent utilization in anything other than from the perspective of an isolated department and the costs associated with the department. Proponents of activity based costing argue that cost assigned to a cost object should be representative of the resources required whilst at the same time argue that the number of cost drivers should be restricted. Furthermore, currently available enterprise planning tools based on activity based costing do not have the capability to extract resource imbalance and therefore cannot provide the insight offered by the solution of the present invention.

One aspect of the enterprise planning system that makes possible the measurement and analysis of resource imbalance is connectivity between resources. The connectivity formed through object relationships enables the drill down from where resource imbalance occurs to the source from which the wasted resources originated. Pull demand initiated from conversion process object resource needs cause a chain reaction throughout the value chain that causes the flow of resources and associated costs along the value chain to the conversion process object. Where resource requirements is initiated in anticipation of customer needs, rather than in response to their needs, this causes an increase in inventory which for the purpose of this application is reported as resource imbalance because the flow of resources and cost cannot flow to the customer and are temporarily or even permanently retained as an increase in inventory.

The scope and benefit of resource imbalance can be measured from two perspectives at resource cell level, the first of which is resource imbalance measured for resource cell where fall out occurs. This is similar to the traditional perspective insofar as it is a measurement of under utilization for a given set of resources. The difference between the prior art and the present invention is the level of granularity at which the imbalance can be reviewed and the insight into the source of the resources wasted. Granularity means that the cost of resource imbalance can be viewed for a given resource item or items and the source where the costs associated with the resource cell originated from. The limitation from this perspective is that the resources reported as utilized for this resource source may ultimately be wasted downstream due to low utilization. For example:

### Cost

| | |
|---|---|
| Resource D Resource Imbalance | 50,000 |
| Where resource originated from | |
| Resource D | 10,000 |
| Resource C | 20,000 |
| Resource B | 20,000 |

Applying the traditional approach to utilization measurement coupled with inadequate representation of resource fulfilment from resource sources B and C, the under utilization cost would be reported as 10,000. With adequate representation of resource cost assignment, it would be reported as 50,000. However, what would be hidden is that 40,000 of the 50,000 loss was related to resources originating in resource centres B and C. Knowing where resource imbalance originates from and the source of the resources attributed to this enables management to consider if aspects of the process requirements should be changed or outsourced and thereby eliminate the loss associated with this source or if other profitability management strategies should be initiated.

The limitations of this perspective are resolved by the second perspective from which resource imbalance can be viewed. The second perspective is normally hidden and therefore cannot be measured and controlled. This problem is resolved by the enterprise planning tool of the present invention by the connectivity between object relationships that enables the software to automatically trace all of the object relationships from a single conversion process object to all the resources required to make its conversion from resources possible. Because of this connectivity, the resource imbalance associated with a resource that originated at the start of the value-chain may be extracted from all locations along the value-chain where fall out for this resource occurs. The resource imbalance measured from the perspective of the source where a resource originated can be expressed as follows:

Resource Imbalance=1−Weighted Compounded Utilization

In other words, the weighted compounded utilization for all of the processes that the resource passes though along the value-chain until ultimately consumed by a conversion process object, this calculation is equivalent to the first pass utilization for the resource, For example:

| | Cost | Process Utiliz % |
|---|---|---|
| Resource A | 100,000 | 40% |
| Process 1 | 40,000 | 80% |
| Process 2 | 32,000 | 60% |
| Conversion Process Object | 19,200 | |

Based on the traditional measurement for under-utilization, a cost of 60,000 would be reported for a 60% under-utilization for the resource cell A, visibility for the 40% reported as utilized is lost once resource A moves into process 1 and 2 until ultimately consumed by a conversion process object. The resource imbalance from this perspective would represent this as follows:

| | | Cost | Under-Utiliz % |
|---|---|---|---|
| Resource Imbalance—Resource A | | 80,800 | 80.80% |
| Represented by: | Resource A | 60,000 | 74.25% |
| | Process 1 | 8,000 | 9.90% |
| | Process 2 | 12,800 | 15.84% |
| | Total | 80,800 | 100.00% |

Based on this the total cost of resource imbalance by resource can be extracted and the source and cause for the fall-out can be located. This provides insight into a hidden cost that can now be measured and managed.

### 14) Cost of Capital

The purpose of this process is to calculate the cost of capital for the following drivers: 1) Customer credit; 2) Vendor credit; 3) Process cycle time; 4) Resource imbalance; and 5) Inactive resources. The first step in this process is to convert the annual cost of capital rate to rate per gross day and a rate per hour. Cost of capital is based on the forecast cost and revenue. Forecast cost is the extended cost converted based on the cost adjusted for price change and converted to the default currency using the forecast exchange rate. The forecast revenue value is similar, the extended revenue based on the revenue adjusted for price change and converted to the default exchange rate using the forecast exchange rate.

### 14.1) Customer Credit

Customer credit is calculated by applying the following formula to each revenue record:

Forecast Revenue*Days Credit*Cost of Capital rate per day

### 14.2) Vendor Credit

Vendor credit refers to all expense, payroll and raw material costs and is based on the credit terms assigned to each item. For example, the credit related to payroll is dependent on the frequency at which payroll is processed. Expense and raw material credit is specific to each item of expense or part. Vendor credit is calculated by applying the following formula to each vendor based record:

Forecast Cost*Days credit*Cost of Capital rate per day.

Vendor credit cost of capital is transacted as a credit to offset part of the process cycle time cost of capital.

### 14.3) Process Cycle Time

The process cycle time refers to that segment of the cash conversion cycle from when a resource fulfils a business or conversion process object resource need to the end of the cash conversion cycle. The process cycle for a conversion process object will always end with the termination of the cash conversion cycle. A business process object can have a cash conversion cycle that is either dependent or independent of the cash conversion cycle for the parent conversion process object. Where the cash conversion cycle for a business process is dependent on the conversion process object, the process cycle time for a resource consumed by a business object is from the time that a resource need was fulfilled to the time that payment for the product or service was made. When a business process object has a cash conversion cycle that is independent of the parent conversion process, the process cycle time is measured from the time that a resource is consumed by a business process to the time that payment for the business process object is received.

This example demonstrates how the cash conversion cycle for the parent conversion process object can influence the business process object cost of capital. However, this is a simple case for a two generation relationship. The cut off for the cash conversion cycle time is title transfer, the cost of capital for the cycle from the title transfer to the receipt of payment is captured by the customer credit cost of capital. A much more complex scenario which the enterprise planning tool supports is as follows:

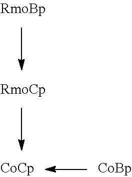

In this example all of the RmoBp (raw material business object) will be linked to a single record in each of the RmoCp where an object relationship exists, likewise the RmoCp record linked to the RmoBp records will also be linked to the CoCp record where the Object relationship between the RmoCp and CoCp is formed. The result of this in terms of the process cycle time can be demonstrated as follows:

### RmoBp Records (Activity)

| | |
|---|---|
| Prepare purchase order | 0.05 Hrs |
| Release purchase order | 0.02 Hrs |

### RmoCp Records

| | | |
|---|---|---|
| Order to dock cycle | 280 | Hrs |
| Receiving dock | 0.025 | Hrs |
| Receiving Inspection | 0.05 | Hrs |
| Transfer to warehouse | 0.01 | Hrs |
| Warehouse Cycle | 140 | Hrs |
| Pull Kit | 0.05 | Hrs |
| Deliver to production | 0.10 | Hrs |
| Cycle Time | 420.13 | hrs |

### CoCp Records

| | | |
|---|---|---|
| Load Machine | 0.05 | hrs |
| Process | 0.10 | Hr |
| Burn-in | 24 | hrs |
| Functional Test | 0.1 | Hrs |
| Pack | 0.05 | Hrs |
| Load Container | 1.00 | Hrs |
| Ship | 280 | Hrs |
| Cycle Time | 305.2 | Hrs |

Therefore the total process cycle time for the following RmoBp activities is Prepare purchase order

| | | |
|---|---|---|
| Current activity | 0.05 | |
| Completion of current cycle | 0.02 | |
| Total Supply Completion Cycle | 0.07 | Hrs |

### Cycle Time to End of Conversion Cycle:

| | | |
|---|---|---|
| RmoCp Cycle Time | 420.13 | Hrs |
| CoCp Cycle Time | 305.20 | |
| Total Process Cycle time | 725.4 | Hrs |

This example demonstrates that the resources consumed in preparing a purchase order are invested in the business for a total of 725.4 hours until paid for. The cost of capital associated with this activity is:

Purchase order preparation resource cost*cost of capital rate per hour*725.4 hours in process

Therefore, if the cost of capital rate is 20% then 725.4 hours to a cost of capital rate of 11.63% that is applied to the total resource cost incurred in preparing the purchase order.

### 14.4) Resource Imbalance

Resource imbalance is the residual value remaining as a wasted cost due to the excess of resource supply over demand. Cost of capital is calculated for each resource imbalance record as follows,

Cost Of Capital=([Forecast Cost]*[ReslmbalFactor])/2*[CoCPeriodRate %]

### Where [ReslmbalFactor]=([GrossHrs]−[UtilizedHrs])/[GrossHrs]

### 14.5) Inactive Resources

Inactive resources refers to resources that are no longer required but for which there are period costs. Cost of capital is calculated for each inactive resource record as follows:

Cost Of Capital=[Forecast Cost]*[CoCPeriodRate %]

### 15) Object Cloning

Object cloning involves the selection of a host object that is the closest representation of the configuration for the new object. The objective of cloning is to significantly reduce the time required to add a new object and reduce errors and omissions in doing so. The most time intensive aspect of adding a new object is in integrating the object with all aspects of the system environment, the terms “plug and play” describes what needs to be accomplished by the cloning process. When we clone a resource object we want it to be functional and in order to be so it must be cloned with all the relationships in place. A cloned object will inherit all of the expenses and business process dependencies required to reflect the resources required to sustain the new object. The cloning process does allow customisation in order that aspects of the clone's configuration can be customised, as required. From a system perspective the level of complexity associated with cloning an object is related to the number of relationships required of the cloned object. At the most complex end of the scale for cloning an object is the process to clone a conversion process object such as a flight.

The following are a summary of scope of cloning: 1) Resource Object expense; 2) Activity based expenses; 3) Raw material object activity based expenses; 4) Business processes; 5) Conversion process; and 6) Resource cell customised calendars. The benefit of this is that time required to build a new database can be reduced significantly.

There now follows a brief discussion of some of the most advantageous features of the present invention. The enterprise planning tool according to the present invention includes the integration of costing, economic value analysis, rolling forecasting and budgeting. By having such a system, the problems of lack of flexibility and scalability of existing enterprise planning tools caused by the techniques applied in the configuration of object costs are circumvented. This is partially due to the fact that according to the present invention, the cost data is configured using internal reporting techniques that reflect the complete scope and order in which resources are consumed. These techniques support the integration of economic value analysis thereby widening the scope of information used for management decision making.

The known accounting techniques are not designed to support lean manufacturing. By implementing a system according to the present invention, data that is compatible with lean manufacturing, Six Sigma and Theory of Constraints is provided so that continuous process improvement can be integrated as part of the rolling forecasting cycles. Furthermore, the existing enterprise planning tools have limited drill down and analytical capabilities because of the lack of connectivity that exists between different objects and the lack of granularity in the underlying data. One significant advantage of the present invention is that within the system a cost object conversion process value chain can be represented as an algorithm. In this way, a change to an attribute or a value associated with an attribute anywhere along the chain would automatically update values affected by this change along the chain. This means that management personnel can drill down and changes would be updated instantaneously and executed in a consistent and accurate manner.

Another advantage of the present invention is that due to the specific structure implemented, the cost of capital is calculated automatically whenever any attribute or attribute values are changed. This means that such a complex process has practically no overhead to management in accessing this level of insight. Additionally, due to the fact that the current and forecast exchanges rates are controlled centrally by finance personnel, the budget managers need only plan expenses based on source currency so that they are not making or referring to finance regarding appropriate rates to use. This frees up time and resources in the organisation.

The aspects of the methodology that allow the enterprise planning tool according to the present invention overcome the problems with the known enterprise planning tools may be summarised as follows: (i) The present invention provides an objects based system derived from attributes and time dimensions where object relationships connect all objects in the value chain to each conversion process object. Conventional activity based costing systems do not provide the level of connectivity and therefore drill down capability associated with this methodology and software. (ii) The data source is designed rather than adapted for the purpose of costing, planning and profitability analysis. (iii) The data source provides a very flexible source from which resource cost assignment can be configured. On the other hand, ABC's dependency on cost pools is very rigid and inflexible. (iv) The use of pull resource demand that makes the distinction between pull demand driven by resources and process objects. The former does not rely on activity for the assignment of resource costs which provides a more accurate assignment of costs. (v) The resource cost assignment between resources recognises and supports the needs for discrete and cross functional resource supply applied to discrete resource objects.

In addition to the above, there are numerous other advantageous aspects of implementing an enterprise planning tool in accordance with the present invention. The application of a bill of resources and the structure associated with this provides a totally flexible structure for representing and applying resource fulfilment. This enables greater flexibility and granularity in the compilation of process object resource needs and cost. Each cost driver applied to this methodology can be configured in many ways compared to the limited single dimensional aspect of cost drivers applied to activity based costing. Secondly, the resource cost assignment is based on capacity utilization applied to the resource cost detail in order to retain visibility, drill down and analytics capability not possible from software based on conventional activity based costing. Thirdly, the application of the bill of materials, which is outside the scope of activity based costing, extends the scope of the application of a bill of materials to both business and conversion process objects.

Fourth, the present invention allows for total integration with economic value analysis which in turn automatically calculates and extracts the cost of capital. Economic value analysis is outside the scope of conventional activity based costing. The level of integration supported by the methodology and enterprise planning tool according to the present invention is beyond the scope of current methodologies and software. Fifth, all values related to the output from this planning tool are derived from attributes and mechanisms that support standardisation, simplicity and control unlike existing software that adds expenses and applies spread mechanisms to resolve expenses to period cost. Sixth, this methodology and enterprise planning tool is the first of its type to resolve any business, whether for profit or not, to an algorithm that describes the attributes, attribute values, time dimensions and object relationship. A change to any attribute, attribute value, time dimension and object relationship anywhere along the value chain will automatically cause change upstream and downstream from where the change occurs, this represents connectivity that is unprecedented in any other costing and or planning software.

In addition to the differences outlined between activity based costing and the methodology applied in this invention, in the case of the former, object costs are derived from departmental or cost centre expense reports whereas in the case of the latter cost centre and departmental expense reports are derived from object costs. Notwithstanding the other differentiating features and scope of the methodology applied to this invention and activity based costing, activity based costing is a top down process whereas the methodology applied to this invention is a bottom up process.

Throughout the specification, there has been an extensive discussion on the shortcomings of the known tools as well as a comprehensive description of numerous advantages of the present invention. These are summarised together below. Many of the known enterprise planning tools are based on activity based costing and principles normally associated with activity base costing the scope of which is significantly less that what is required for the configuration of an enterprise planning tool. For this reason known planning tools tend to focus too much on what activity based costing brings to the tool rather that offering a combination of tools and techniques that deliver the scope and robustness required of an enterprise planning tool. The limitations of the methodology on which the known enterprise planning tools are based is discussed further below.

The known enterprise planning tools are built around a limited core processing capability as referred to above to which is applied content such as graphics, report writing, what-if scenarios and version control. Although the known enterprise planning tools have visually adopted the appearance and graphics commonly associated with spreadsheets there has been a lack of innovation and development at the core of the product. What the known enterprise planning tools do is to eliminate hundreds or more spreadsheets and enable all of the budgets and forecasts for an enterprise to be captured within a single source environment beyond this it is little more that moving the same processes heretofore based on spreadsheet to a database environment. Therefore, the standardisation of format, structure and improvement in reporting has not realised any significant improvement in the scope and quality of information. What this invention seeks to do is to focus on the core processing capability of the tool based on an innovative approach that leverages software technology and processing capability. This innovation marks a significant shift that is as radical a change as was the development of activity based costing when it replaced traditional costing systems that had been around since the industrial revolution.

The scope of activity based costing applies to the assignment of overhead costs to products and services. Activity based costing enables the known enterprise planning tools to align budgeted and forecasted overheads to products and services. The function of activity based costing as applied to known enterprise planning tools is more to do with the manipulation of the data for the purpose of cost assignment than for the actual compilation of the budgets and forecasts.

Activity based costing applied to known enterprise planning tools do not build budgets and forecasts. Known enterprise planning tools still rely to a great extent on a combination of data from different sources to build budgets and forecasts. Much of the fixed overheads are still calculated using spreadsheets as the source that is entered or imported to the enterprise planning tool. Payroll costs and variable costs are in some applications calculated within the structure of the known enterprise planning tools. Other data such as material costs are assigned as a summary of costs calculated externally to the known enterprise planning tools. Because known enterprise planning tools rely on a combination of data that is compiled external to and by the enterprise planning tool, such tools lack the level of integration of a single source database. For these reasons the standardisation and simplification of the process for the compilation of budgets and forecasts is compromised compared to the present invention.

The known enterprise planning tools are compromised because of the lack of detail and the fragmentation of the data source used in the compilation of budgets and forecasts. Because the invention is a single source database created from attributes, objects and activity it is a self-contained tool that does not rely on the compilation of data outside the environment of its own database. For this reason standardisation and simplification of processes are assured. Standardisation is achieved because the tool is self-contained, therefore there is no risk that the methods and accuracy of the data that would otherwise be compiled in a less secure and unregulated way, as is the case for the known enterprise planning tools, can adversely affect the quality and reliability of the data. Therefore the level of accuracy and precision required for management decision making is compromised in the case of the known enterprise planning tools. The level of accuracy and precision of the known planning tools is further compromised due to the lack of detail that is a barrier to the simplification of processes compared to the invention.

Furthermore as this relates to the invention, because budgets and forecasts are configured from attributes, data quality, reliability and process simplification is attributed to the segregation of control over those attributes. The segregation and control over attributes refers to, for example, to resource object expense groups and exchange rates whereby a central function, such as finance headquarters can control the configuration of expense groups and exchange rates applied. Expense groups are assigned when adding a new resource object expense, an example of which is an annual maintenance contract. The expense group includes all of the attributes related to a resource object expense in order that the expense attributes can be converted to a period expense. Therefore for an expense such as annual contract the rules such as the accounting policy, expense frequency and period allocation method are inherited from the expense group. The benefit of this from a users perspective, especially for a non-finance person is that they do not need to be concerned about how the system will manage the execution of the expense. Furthermore, the same finance headquarters can set the default and forecast exchange rates, the benefit of this is consistency and simplification for the user in that the user need only be concerned with the assignment of the cost rate for a new expense based on the source currency. Standardisation and simplification as these relate to the invention are not only advantages over known enterprise planning systems but in the context of the quality, accuracy and precision of the resulting data ensures that the reliability of the information that management base decisions on is superior to that of known enterprise planning systems.

Furthermore, the data sources for activity based costing are derived from accounting techniques that are designed primarily for external reporting and are structured to report at an organisational level. This data source is decomposed and reconstructed into a format that is applied to activity based costing, namely cost pools. The decomposition of organisational cost reports, namely cost centres from which cost pools are constructed involves compromising the data quality and accuracy which is subsequently incorporated into the information used by management for decision making. The requirements of external and internal reporting techniques are different and in order to make accurate management decisions from an enterprise planning tool, it would be highly advantageous to have data configured using internal reporting techniques that is detailed, accurate and useful to the user. The invention is configured from the lowest level of detail so there is no compromise in data quality as there is never any need to decompose data structures that were not designed with the needs of this system in mind. What adds to the precision and accuracy compared to the known enterprise planning tools is that everything about this invention was designed with flexibility, robustness, standardization, consistency and simplification whereas known enterprise planning tools have adopted the same methodology originally applied to spreadsheets.

Known enterprise planning tools claim to be both tops down and bottoms-up, however, it must be stated that whether tops down or bottoms up, this can only be within the context of the level of granularity that data is added to the system. Therefore, when compared to the known enterprise planning tools, the invention functions at a totally different level of granularity because resources and objects are compiled from attributes. The difference in the level of granularity not only delivers more accurate and precise data quality it also means that the range between tops down and bottoms up is vastly greater than that of known enterprise planning tools. Because of this, the analytics, drill down, modelling etc capability of the invention is the equivalent to a highly engineered, high precision tool compared to known enterprise planning tools. This capability means that the insight offered by this invention enables management to make better decision for their business.

Known enterprise planning tools claim that they support lean manufacturing, however the scope of this is little more than the value type classification of expenses and activities. The invention is compatible with lean manufacturing, we can relate the principles of lean manufacturing and other aspects of lean manufacturing such as value, value stream, flow, pull and perfection as follows; value is represented by the classification of expenses and activities according to value type, resource imbalance and inactive resource costs are automatically set to default as non value-add. Value stream as represented by the resource hierarchy and the application of sequencing to control the flow of data as a clear representation of how value flows, pull is represented by how value flows based on how resource requirements are fulfilled in response to customer needs, pull demand that is not initiated in fulfilment of a customers immediate needs only cause flow from one state of resource imbalance in the value stream to another, perfection is represented in the unique way that continuous process improvement can be adapted as part of the normal budgeting and forecasting cycle such as how the tool integrates the management of Kaizen Events. The invention enables a user to schedule the changes from the current to the future state by phasing out activities, as represented by cost drivers, no longer relevant and adding new activities to complete the re-configuration for the future state planned for the process. The scope of a process in this context refers to both conversion and business process objects. Changes that are planned to occur over a number of periods will be reflected in the period budget or forecast, so too will the affect of these changes cascade throughout the value-chain both for those resources that the re-configured process is dependent on, and also on those objects that are dependent on the process.

Known enterprise planning tools in general do not support economic value analysis and as currently configured cannot support the scope required for calculating the cost of capital, namely vendor and customer credit, total process cycle time, resource imbalance and inactive resources. The current invention is configured to capture the cost of capital at a record level for those costs normally hidden and therefore not available for consideration in making decisions related to the future of their business. The current invention has leveraged current software technology in order to process data at this level of detail. Economic value analysis and the knowledge of what drives cost of capital is very advantageous when applied to lean and continuous process improvement in prioritising the scheduling of Kaizen Events based on an understanding of those projects that will yield the greatest return in terms of both historical and economic cost. Furthermore, Cost of capital is a hidden cost not accessible from conventional reporting and decisions made in the absence of this insight and understanding can cause management to make decisions to the detriment of their business that they otherwise might not. By incorporating economic value analysis and supporting lean and continuous process improvement this invention enables management to make more informed decisions than otherwise if relying on known enterprise planning tools that are not configured for this purpose.

Multi-dimensional cost base refers to the ability to peel back the layers of cost and profitability from a forecast cost in order to identify the impact of currency exchange rate change, price change, in addition to the ability to add the cost of capital to forecast cost as discussed above. This capability combined with the level of granularity of the data configuration serves to create a synergistic outcome that enables the invention to deliver an analytical capability that also enables management to ask of the system questions that known enterprise planning tools do not have the data from which answers can be extracted.

The known accounting systems are not designed to measure and report at a highly detailed level and they are not designed to comprehensively monitor the effectiveness of a business strategy implemented in an organization. The ability to be able to monitor the affect of change and the effectiveness of current business strategies can be monitored through resource imbalance and especially as this relates to tracing the origin of resources that fall-out along the value-chain as opposed to just focusing on where fall-out occurs. This capability is further enhanced by the assignment of resource object to multi-dimensional objects that are used to represent a particular business strategy.

The know enterprise planning tools are designed from a simple resource structure that does not support complex supply chain structure such as an airline company that operates in many geographical regions, each of which may consist of hub locations located in different countries. Another example of a complex supply chain structure is a business based in Ireland that outsources some of its manufacturing operations to China and Malaysia and operates a final configuration hub in Holland to service the European market and other hubs to support other market regions. Both examples are of complex supply chains that involve multiple jurisdictions that comprise different currency, cost base and regulations. Unlike the known enterprise planning tools this invention is structured in order to allow a user to configure such complex supply chain structure within the scope of the resource hierarchy in a seamless way that simplifies the representation of what is a very complex set of relationships. Known enterprise planning tools do not have the capability to represent the connectivity required for such complex supply chains and for this reason cannot serve the needs of management who require the insight required for the management of such complex structures.

It will be further understood that the method according to the present invention will be performed largely in software and therefore the present invention extends also to computer programs, on or in a carrier, comprising program instructions for causing a computer to carry out the method. The computer program may be in source code format, object code format or a format intermediate source code and object code. The computer program may be stored on or in a carrier including any computer readable medium, including but not limited to a floppy disc, a CD, a DVD, a memory stick, a tape, a RAM, a ROM, a PROM, an EPROM, a hardware circuit or a transmissible carrier such as a carrier signal when transmitted either wirelessly and/or through wire and/or cable. The term computer will be understood to encompass a broad range of computing devices used by individuals to run an enterprise planning tool including but not limited exclusively to a personal computer (PC), a laptop, a netbook, a personal digital assistant, a handheld device such as a mobile phone, Blackberry® or other mobile computing device.

Throughout the specification, the term “Process Object” has been used in certain instances as shorthand for both business process object and conversion process object and functions and operability associated with process objects are also applicable to business process objects and conversion process objects. The term “cost object conversion process” encompasses both product conversion process objects and service conversion process objects. Similarly, the terminology “market channel” may be used interchangeably with region, regions, market segments and the like.

In the specification the terms “comprise, comprises, comprised and comprising” and the terms “include, includes, included and including” are deemed totally interchangeable and should be afforded the widest possible interpretation.

The invention is in no way limited to the embodiments hereinbefore described which may be varied in both construction and detail with the scope of the claims.

What is claimed is:

1-78. (canceled)

79. An enterprise planning tool comprising a plurality of interconnected objects, with each object comprising at least one attribute, and, each object having a time dimension associated therewith;
the plurality of interconnected objects comprising at least resource objects, process objects and cost objects, with all of said objects comprising attributes;
whereby each of the objects has a relationship with at least one other object in the enterprise planning tool, thereby connecting the objects in the enterprise planning tool together, with the relationship between two objects consisting of at least one attribute common to both objects in the relationship, and, at least part of the time dimension for both objects overlapping;
the relationships between objects being such so that each of the objects in the enterprise planning tool is connected to each of the remaining objects in the enterprise planning tool either directly or indirectly through one or more connected objects having common attributes;
the enterprise planning tool comprises process objects, which process objects comprise at least one resource cell with the resource cell comprising one or more resource objects, and, the enterprise planning tool comprises at least one work cell where the work cell groups one or more resource cells;
the enterprise tool further comprises a bill of resources, which bill of resources in turn comprises a plurality of work cells and a plurality of cost drivers, where the cost drivers comprise one or more process objects and/or external expenses;
such that with the enterprise planning tool in operation,
the objects in the enterprise planning tool are arranged into an object hierarchy so as to define a value chain; and,
the enterprise planning tool implements a pull-based resource demand methodology through the value chain;
whereby, the pull-based resource demand method is sequenced in two stages: firstly, driven by the resource objects and resource object processes, and, secondly, driven by cost objects and cost object processes.

80. The enterprise planning tool as claimed in claim 79, in which, the objects comprise one of an expense, a resource, a business process, a product and a service.

81. The enterprise planning tool as claimed in claim 80, in which, the object hierarchy comprises a plurality of levels including an expense, a resource, an internal resource expense, a resource object business process, a raw material object business process, a raw material object conversion process, a cost object business process, a product based cost object conversion process and a service based cost object conversion process.

82. The enterprise planning tool as claimed in claim 79, in which the attributes are arranged in an attribute hierarchy.

83. The enterprise planning tool as claimed in claim 79, in which there are provided a plurality of resource object groups.

84. The enterprise planning tool as claimed in claim 83, in which the resource object groups comprise a land group, a building group, an equipment group, a labour grade based group, a labour employee based group and a process group.

85. The enterprise planning tool as claimed in claim 79, in which the work cells are arranged in the sequence in which resources are consumed.

86. The enterprise planning tool as claimed in claim 79, in which the cost drivers comprise process type, batch type, sample size and pack configuration.

87. The enterprise planning tool as claimed in claim 79, in which the cost drivers when assigned to a routing step are sequenced in the order in which activities or tasks are performed.

88. The enterprise planning tool as claimed in claim 79, in which there are provided a plurality of resources arranged in a resource hierarchy.

89. An enterprise planning tool as claimed in claim 88, in which the resource hierarchy comprises a plurality of levels including an Infrastructure level, a Service level, a Support level and an Activity level.

90. The enterprise planning tool as claimed in claim 89, in which the resource hierarchy represents the general order in which resource objects and process objects are configured.

91. The enterprise planning tool as claimed in claim 79, in which the enterprise planning tool comprises a relationship validation module that checks the attribute and time domain common to both parties.

92. The enterprise planning tool as claimed in claim 79, in which each relationship is provided with a unique identifier code.

93. The enterprise planning tool as claimed in claim 79, in which the relationships are stored in an object relationship link table.

94. The enterprise planning tool as claimed in claim 93, in which the object relationship link table contains a code for a demand side and a supply side of the relationship.

95. The enterprise planning tool as claimed in claim 94, in which the object relationship link table comprises one or more of expense to object, object to object, and, object to Hub location relationships.

96. The enterprise planning tool as claimed in claim 79, in which relationships within the same value chain, share, in common, the same time dimension.

97. The enterprise planning tool as claimed in claim 79, in which a resource requirement for a relationship is represented by resource utilization and the basis by which the cost of such resources are passed from a supply side to a demand side of the relationship.

98. The enterprise planning tool as claimed in claim 93, in which the link table record is grouped into one of a resource object expense group, labour pool cost assignment group, cost object expense assignment group, work cell assignment group, cost driver assignment group, resource object business process assignment group, raw material object business process assignment group, raw material object conversion process assignment group, bill of materials assignment group, cost object business process group, passenger based business process object assignment group, cost object hub location assignment group.

99. The enterprise planning tool as claimed in claim 79, in which the time dimension comprises a start date and an end date.
